(19) United States
(12) Patent Application Publication
(10) Pub. No.: US 2024/0029313 A1
(43) Pub. Date: Jan. 25, 2024

(54) POINT CLOUD DATA TRANSMISSION DEVICE, POINT CLOUD DATA TRANSMISSION METHOD, POINT CLOUD DATA RECEPTION DEVICE, AND POINT CLOUD DATA RECEPTION METHOD

(71) Applicant: LG ELECTRONICS INC., Seoul (KR)

(72) Inventors: Hyejung HUR, Seoul (KR); Sejin OH, Seoul (KR); Donggyu SIM, Seoul (KR); Joohyung BYEON, Seoul (KR)

(21) Appl. No.: 18/039,915

(22) PCT Filed: Dec. 6, 2021
(86) PCT No.: PCT/KR2021/018362

§ 371 Date: Jun. 1, 2023

(30) Foreign Application Priority Data
Dec. 4, 2020 (KR) 10-2020-0167959

(51) Int. Cl. G06T 9/00; H04N 19/597; H04N 19/91; H04N 19/93; H04N 19/96

(52) U.S. Cl. CPC G06T 9/001; H04N 19/597; H04N 19/91; H04N 19/93; H04N 19/96

(57) ABSTRACT

A point cloud data transmission method according to embodiments comprises the steps of: encoding geometry data of point cloud data; encoding attribute data of the point cloud data on the basis of the geometry data; and transmitting the encoded geometry data, the encoded attribute data and signaling data.

### TECHNICAL FIELD

Embodiments relate to a method and apparatus for processing point cloud content.

### BACKGROUND ART

Point cloud content is content represented by a point cloud, which is a set of points belonging to a coordinate system representing a three-dimensional space (or volume). The point cloud content may express media configured in three dimensions, and is used to provide various services such as virtual reality (VR), augmented reality (AR), mixed reality (MR), extended reality (XR), and self-driving services. However, tens of thousands to hundreds of thousands of point data are required to represent point cloud content. Therefore, there is a need for a method for efficiently processing a large amount of point data.

In other words, a high throughput is required to transmit and receive data of the point cloud. Accordingly, in the process of transmitting and receiving the point cloud data, in which encoding for compression and decoding for decompression are performed, the computational operation is complicated and time-consuming due to the large volume of the point cloud data.

### DISCLOSURE

### Technical Problem

An object of the present disclosure devised to solve the above-described problems is to provide a point cloud data transmission device, a point cloud data transmission method, a point cloud data reception device, and a point cloud data reception method for efficiently transmitting and receiving a point cloud.

Another object of the present disclosure is to provide a point cloud data transmission device, a point cloud data transmission method, a point cloud data reception device, and a point cloud data reception method for addressing latency and encoding/decoding complexity.

Another object of the present disclosure is to provide a point cloud data transmission device, a point cloud data transmission method, a point cloud data reception device, and a point cloud data reception method for increasing the compression efficiency of zero run-length coding by changing the coding unit of entropy coding of attribute information.

Another object of the present disclosure is to provide a point cloud data transmission device, a point cloud data transmission method, a point cloud data reception device, and a point cloud data reception method for increasing the compression efficiency of attribute information by increasing the probability of matching the attribute channel value with a previous point by separating channels and applying zero run-length coding in the case of attributes with multiple channels.

Objects of the present disclosure are not limited to the aforementioned objects, and other objects of the present disclosure which are not mentioned above will become apparent to those having ordinary skill in the art upon examination of the following description.

### Technical Solution

The object of the present disclosure can be achieved by providing a method of transmitting point cloud data. The method may include encoding geometry data of point cloud data, encoding attribute data of the point cloud data based on the geometry data, and transmitting the encoded geometry data, the encoded attribute data, and signaling data.

In one embodiment, the attribute encoding step comprises: performing a prediction on the attribute data to generate predicted attribute data; generating residual attribute data based on the attribute data and the predicted attribute data; and performing entropy coding on the residual attribute data in entropy coding units.

In one embodiment, the entropy coding units are determined based on a tree structure generated based on the restored geometry data, based on a Molton code, or based on a level of detail (LoD).

In one embodiment, the entropy coding step comprises sequentially entropy coding the residual attribute data separately for each channel.

In one embodiment, the entropy coding step comprises performing zero-run-length coding and arithmetic coding on the residual attribute data.

In one embodiment, the signaling data comprises information relevant to the entropy coding.

A point cloud data transmitting device according to embodiments may include a geometry encoder for encoding geometry data of the point cloud data, an attribute encoder for encoding attribute data of the point cloud data based on the geometry data, and a transmission portion for transmitting the encoded geometry data, the encoded attribute data, and the signaling data.

In one embodiment, the attribute encoder performs a prediction on the attribute data to generate predicted attribute data, generates residual attribute data based on the attribute data and the predicted attribute data, and performs entropy coding on the residual attribute data with an entropy coding unit.

In one embodiment, the entropy coding unit is determined based on a tree structure, based on a Molton code, or based on a level of detail (LoD) generated based on the restored geometry data.

In one embodiment, the attribute encoder sequentially entropy codes the residual attribute data separately for each channel.

In one embodiment, the attribute encoder applies zero-run-length coding and arithmetic coding to the residual attribute data for entropy coding.

In one embodiment, the signaling data includes information related to the entropy coding.

A method of receiving point cloud data according to embodiments may include the steps of receiving geometry data, attribute data, and signaling data, decoding the geometry data based on the signaling data, decoding the attribute data based on the signaling data and the decoded geometry data, and rendering the decoded point cloud data based on the signaling data.

In one embodiment, the step of decoding the attribute data comprises performing entropy decoding on the attribute data in entropy coding units to restore residual attribute data.

In one embodiment, the signaling data includes information related to the entropy coding.

In one embodiment, the entropy coding units are obtained using the signaling data, wherein the obtained entropy coding units are tree structure based, morphological code based, or level of detail (LoD) based generated based on the restored geometry data.

In one embodiment, the entropy decoding step comprises sequential entropy decoding of the attribute data separately for each channel.

In one embodiment, the entropy decoding step comprises performing arithmetic decoding and zero-run-length decoding on the attribute data.

### Advantageous Effects

A point cloud data transmission method, a point cloud data transmission device, a point cloud data reception method, and a point cloud data reception device according to embodiments may provide a good-quality point cloud service.

A point cloud data transmission method, a point cloud data transmission device, a point cloud data reception method, and a point cloud data reception device according to embodiments may achieve various video codec methods.

A point cloud data transmission method, a point cloud data transmission device, a point cloud data reception method, and a point cloud data reception device according to embodiments may provide universal point cloud content such as a self-driving service (or an autonomous driving service).

A point cloud data transmission method, a point cloud data transmission device, a point cloud data reception method, and a point cloud data reception device according to embodiments may perform space-adaptive partition of point cloud data for independent encoding and decoding of the point cloud data, thereby improving parallel processing and providing scalability.

A point cloud data transmission method, a point cloud data transmission device, a point cloud data reception method, and a point cloud data reception device according to embodiments may perform encoding and decoding by partitioning the point cloud data in units of tiles and/or slices, and signal necessary data therefore, thereby improving encoding and decoding performance of the point cloud.

According to embodiments, a point cloud data transmission device, a point cloud data transmission method, a point cloud data reception device, and a point cloud data reception method may change the entropy coding unit of attribute information based on a tree structure, Morton code, or LoD to reduce the number of zeroruns repeatedly signaled due to run-length coding, thereby increasing the compression efficiency of zero run-length coding.

According to embodiments, a point cloud data transmission device, a point cloud data transmission method, a point cloud data reception device, and a point cloud data reception method may increase the compression efficiency of attribute information by increasing the probability of matching the attribute channel value with a previous point by separating channels and applying zero run-length coding in the case of attributes with multiple channels.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIG. 1 illustrates an exemplary point cloud content providing system according to embodiments.

FIG. 2 is a block diagram illustrating a point cloud content providing operation according to embodiments.

FIG. 3 illustrates an exemplary process of capturing a point cloud video according to embodiments.

FIG. 4 illustrates an exemplary block diagram of point cloud video encoder according to embodiments.

FIG. 5 illustrates an example of voxels in a 3D space according to embodiments.

FIG. 6 illustrates an example of octree and occupancy code according to embodiments.

FIG. 7 illustrates an example of a neighbor node pattern according to embodiments.

FIG. 8 illustrates an example of point configuration of a point cloud content for each LOD according to embodiments.

FIG. 9 illustrates an example of point configuration of a point cloud content for each LOD according to embodiments.

FIG. 10 illustrates an example of a block diagram of a point cloud video decoder according to embodiments.

FIG. 11 illustrates an example of a point cloud video decoder according to embodiments.

FIG. 12 illustrates a configuration for point cloud video encoding of a transmission device according to embodiments.

FIG. 13 illustrates a configuration for point cloud video decoding of a reception device according to embodiments.

FIG. 14 illustrates an exemplary structure operable in connection with point cloud data methods/devices according to embodiments.

FIG. 15 is a diagram illustrating an example of zero run-length coding according to embodiments.

FIG. 16 is a diagram illustrating an example of determining an entropy coding unit based on a tree structure of reconstructed geometry information according to embodiments.

FIG. 17 is a diagram illustrating an example of determining an entropy coding unit based on Morton code of reconstructed geometry information according to embodiments.

FIG. 18 is a diagram illustrating an example of determining an entropy coding unit based on a LoD level generated based on reconstructed geometry information according to embodiments.

FIG. 19 is a diagram illustrating another example of determining an entropy coding unit based on a LoD level generated based on reconstructed geometry information according to embodiments.

FIGS. 20-(a) to 20-(c) are diagrams illustrating examples of entropy coding of attribute information (e.g., quantized residual attribute information) according to embodiments.

FIGS. 21-(a) to 21-(c) are diagrams illustrating examples of entropy decoding of attribute information performed to output quantized residual attribute information according to embodiments.

FIG. 22 is a diagram illustrating another example of a point cloud transmission device according to embodiments.

FIG. 23 is a detailed block diagram of an attribute encoder according to embodiments.

FIG. 24 is a diagram illustrating another example of a point cloud reception device according to embodiments.

FIG. 25 is a detailed block diagram illustrating another example of an attribute decoder 65004 according to embodiments.

FIG. 26 is a flowchart illustrating an example of an attribute information entropy decoding method according to embodiments.

FIG. 27 is a flowchart illustrating an example of an entropy decoding process according to embodiments.

FIG. 28 illustrates an example of a bitstream structure of point cloud data for transmission/reception according to embodiments.

FIG. 29 is a diagram showing an example syntax structure of a sequence parameter set according to embodiments.

FIG. 30 is a diagram showing an example syntax structure of a geometry parameter set according to embodiments.

FIG. 31 is a diagram showing an example syntax structure of an attribute parameter set according to embodiments.

FIG. 32 is a diagram showing an example syntax structure of geometry_slice_bitstream( ) according to embodiments.

FIG. 33 is a diagram showing an example syntax structure of a geometry slice header according to embodiments.

FIG. 34 is a diagram showing an example syntax structure of geometry data unit data according to embodiments.

FIG. 35 is a diagram showing an example syntax structure of attribute_slice_bitstream( ) according to embodiments.

FIG. 36 is a diagram showing an example syntax structure of an attribute slice header according to embodiments.

FIG. 37 is a diagram showing another example syntax structure of an attribute data unit header according to embodiments.

FIG. 38 is a diagram showing an example syntax structure of attribute data unit data according to embodiments.

FIG. 39 is a diagram showing another example syntax structure of attribute data unit data according to embodiments.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. It should be noted that the following examples are only for embodying the present disclosure and do not limit the scope of the present disclosure. What can be easily inferred by an expert in the technical field to which the present disclosure belongs from the detailed description and examples of the present disclosure is to be interpreted as being within the scope of the present disclosure.

The detailed description in this present specification should be construed in all aspects as illustrative and not restrictive. The scope of the disclosure should be determined by the appended claims and their legal equivalents, and all changes coming within the meaning and equivalency range of the appended claims are intended to be embraced therein.

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that may be implemented according to the present disclosure. The following detailed description includes specific details in order to provide a thorough understanding of the present disclosure. However, it will be apparent to those skilled in the art that the present disclosure may be practiced without such specific details. Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings. In addition, the following drawings and detailed description should not be construed as being limited to the specifically described embodiments, but should be construed as including equivalents or substitutes of the embodiments described in the drawings and detailed description.

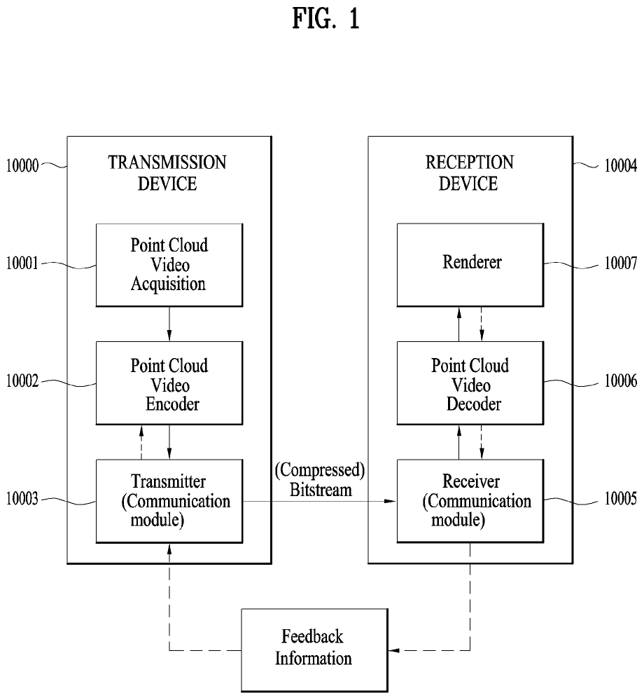

FIG. 1 shows an exemplary point cloud content providing system according to embodiments.

The point cloud content providing system illustrated in FIG. 1 may include a transmission device 10000 and a reception device 10004. The transmission device 10000 and the reception device 10004 are capable of wired or wireless communication to transmit and receive point cloud data.

The point cloud data transmission device 10000 according to the embodiments may secure and process point cloud video (or point cloud content) and transmit the same. According to embodiments, the transmission device 10000 may include a fixed station, a base transceiver system (BTS), a network, an artificial intelligence (AI) device and/or system, a robot, an AR/VR/XR device and/or server. According to embodiments, the transmission device 10000 may include a device, a robot, a vehicle, an AR/VR/XR device, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The transmission device 10000 according to the embodiments includes a point cloud video acquisition unit 10001, a point cloud video encoder 10002, and/or a transmitter (or communication module) 10003.

The point cloud video acquisition unit 10001 according to the embodiments acquires a point cloud video through a processing process such as capture, synthesis, or generation. The point cloud video is point cloud content represented by a point cloud, which is a set of points positioned in a 3D space, and may be referred to as point cloud video data. The point cloud video according to the embodiments may include one or more frames. One frame represents a still image/picture. Therefore, the point cloud video may include a point cloud image/frame/picture, and may be referred to as a point cloud image, frame, or picture.

The point cloud video encoder 10002 according to the embodiments encodes the acquired point cloud video data. The point cloud video encoder 10002 may encode the point cloud video data based on point cloud compression coding. The point cloud compression coding according to the embodiments may include geometry-based point cloud compression (G-PCC) coding and/or video-based point cloud compression (V-PCC) coding or next-generation coding. The point cloud compression coding according to the embodiments is not limited to the above-described embodiment. The point cloud video encoder 10002 may output a bitstream containing the encoded point cloud video data. The bitstream may contain not only the encoded point cloud video data, but also signaling information related to encoding of the point cloud video data.

The transmitter 10003 according to the embodiments transmits the bitstream containing the encoded point cloud video data. The bitstream according to the embodiments is encapsulated in a file or segment (e.g., a streaming segment), and is transmitted over various networks such as a broadcasting network and/or a broadband network. Although not shown in the figure, the transmission device 10000 may include an encapsulator (or an encapsulation module) configured to perform an encapsulation operation. According to embodiments, the encapsulator may be included in the transmitter 10003. According to embodiments, the file or segment may be transmitted to the reception device 10004 over a network, or stored in a digital storage medium (e.g., USB, SD, CD, DVD, Blu-ray, HDD, SSD, etc.). The transmitter 10003 according to the embodiments is capable of wired/wireless communication with the reception device 10004 (or the receiver 10005) over a network of 4G, 5G, 6G, etc. In addition, the transmitter may perform a necessary data processing operation according to the network system (e.g., a 4G, 5G or 6G communication network system). The transmission device 10000 may transmit the encapsulated data in an on-demand manner.

The reception device 10004 according to the embodiments includes a receiver 10005, a point cloud video decoder 10006, and/or a renderer 10007. According to embodiments, the reception device 10004 may include a device, a robot, a vehicle, an AR/VR/XR device, a portable device, a home appliance, an Internet of Things (IoT) device, and an AI device/server which are configured to perform communication with a base station and/or other wireless devices using a radio access technology (e.g., 5G New RAT (NR), Long Term Evolution (LTE)).

The receiver 10005 according to the embodiments receives the bitstream containing the point cloud video data or the file/segment in which the bitstream is encapsulated from the network or storage medium. The receiver 10005 may perform necessary data processing according to the network system (e.g., a communication network system of 4G, 5G, 6G, etc.). The receiver 10005 according to the embodiments may decapsulate the received file/segment and output a bitstream. According to embodiments, the receiver 10005 may include a decapsulator (or a decapsulation module) configured to perform a decapsulation operation. The decapsulator may be implemented as an element (or component or module) separate from the receiver 10005.

The point cloud video decoder 10006 decodes the bitstream containing the point cloud video data. The point cloud video decoder 10006 may decode the point cloud video data according to the method by which the point cloud video data is encoded (e.g., in a reverse process of the operation of the point cloud video encoder 10002). Accordingly, the point cloud video decoder 10006 may decode the point cloud video data by performing point cloud decompression coding, which is the inverse process of the point cloud compression. The point cloud decompression coding includes G-PCC coding.

The renderer 10007 renders the decoded point cloud video data. According to an embodiment, the renderer 10007 may render the decoded point cloud data according to a viewport. The renderer 10007 may output point cloud content by rendering not only the point cloud video data but also audio data. According to embodiments, the renderer 10007 may include a display configured to display the point cloud content. According to embodiments, the display may be implemented as a separate device or component rather than being included in the renderer 10007.

The arrows indicated by dotted lines in the drawing represent a transmission path of feedback information acquired by the reception device 10004. The feedback information is information for reflecting interactivity with a user who consumes the point cloud content, and includes information about the user (e.g., head orientation information, viewport information, and the like). In particular, when the point cloud content is content for a service (e.g., self-driving service, etc.) that requires interaction with the user, the feedback information may be provided to the content transmitting side (e.g., the transmission device 10000) and/or the service provider. According to embodiments, the feedback information may be used in the reception device 10004 as well as the transmission device 10000, or may not be provided.

The head orientation information according to the embodiments may represent information about a position, orientation, angle, and motion of a user's head. The reception device 10004 according to the embodiments may calculate viewport information based on the head orientation information. The viewport information is information about a region of a point cloud video that the user is viewing (that is, a region that the user is currently viewing). That is, the viewport information is information about a region that the user is currently viewing in the point cloud video. In other words, the viewport or viewport region may represent a region that the user is viewing in the point cloud video. A viewpoint is a point that the user is viewing in the point cloud video, and may represent a center point of the viewport region. That is, the viewport is a region centered on a viewpoint, and the size and shape of the region may be determined by a field of view (FOV). Accordingly, the reception device 10004 may extract the viewport information based on a vertical or horizontal FOV supported by the device as well as the head orientation information. In addition, the reception device 10004 may perform gaze analysis or the like based on the head orientation information and/or the viewport information to determine the way the user consumes a point cloud video, a region that the user gazes at in the point cloud video, and the gaze time. According to embodiments, the reception device 10004 may transmit feedback information including the result of the gaze analysis to the transmission device 10000. According to embodiments, a device such as a VR/XR/AR/MR display may extract a viewport region based on the position/orientation of a user's head and a vertical or horizontal FOV supported by the device. According to embodiments, the head orientation information and the viewport information may be referred to as feedback information, signaling information, or metadata.

The feedback information according to the embodiments may be acquired in the rendering and/or display process. The feedback information may be secured by one or more sensors included in the reception device 10004. According to embodiments, the feedback information may be secured by the renderer 10007 or a separate external element (or device, component, or the like). The dotted lines in FIG. 1 represent a process of transmitting the feedback information secured by the renderer 10007. The feedback information may not only be transmitted to the transmitting side, but also be consumed by the receiving side. That is, the point cloud content providing system may process (encode/decode/render) point cloud data based on the feedback information. For example, the point cloud video decoder 10006 and the renderer 10007 may preferentially decode and render only the point cloud video for a region currently viewed by the user, based on the feedback information, that is, the head orientation information and/or the viewport information.

The reception device 10004 may transmit the feedback information to the transmission device 10000. The transmission device 10000 (or the point cloud video encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) the entire point cloud data, and provide point cloud content to the user.

According to embodiments, the transmission device 10000 may be called an encoder, a transmitting device, a transmitter, a transmission system, or the like, and the reception device 10004 may be called a decoder, a receiving device, a receiver, a reception system, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to the point cloud data.

The elements of the point cloud content providing system illustrated in FIG. 1 may be implemented by hardware, software, a processor, and/or a combination thereof.

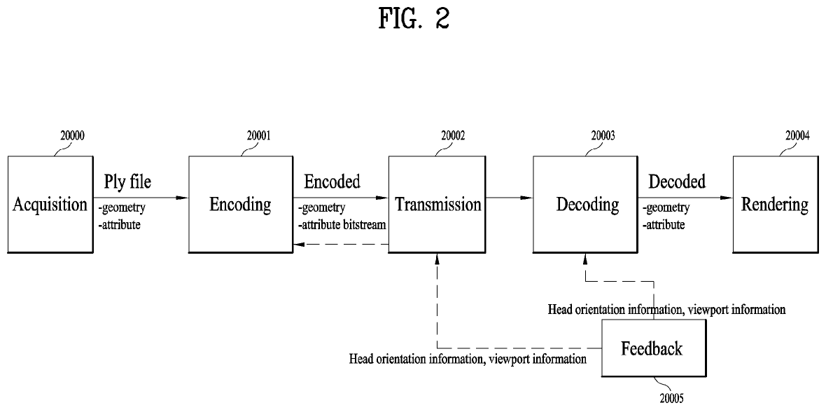

FIG. 2 is a block diagram illustrating a point cloud content providing operation according to embodiments.

The block diagram of FIG. 2 shows the operation of the point cloud content providing system described in FIG. 1. As described above, the point cloud content providing system may process point cloud data based on point cloud compression coding (e.g., G-PCC). The point cloud content providing system according to the embodiments (e.g., the point cloud transmission device 10000 or the point cloud video acquisition unit 10001) may acquire a point cloud video (20000). The point cloud video is represented by a point cloud belonging to a coordinate system for expressing a 3D space. The point cloud video according to the embodiments may include a Ply (Polygon File format or the Stanford Triangle format) file. When the point cloud video has one or more frames, the acquired point cloud video may include one or more Ply files. The Ply files contain point cloud data, such as point geometry and/or attributes. The geometry includes positions of points. The position of each point may be represented by parameters (e.g., values of the X, Y, and Z axes) representing a three-dimensional coordinate system (e.g., a coordinate system composed of X, Y and Z axes). The attributes include attributes of points (e.g., information about texture, color (in YCbCr or RGB), reflectance r, transparency, etc. of each point). A point has one or more attributes. For example, a point may have an attribute that is a color, or two attributes that are color and reflectance. According to embodiments, the geometry may be called positions, geometry information, geometry data, or the like, and the attribute may be called attributes, attribute information, attribute data, or the like.

The point cloud content providing system (e.g., the point cloud transmission device 10000 or the point cloud video acquisition unit 10001) may secure point cloud data from information (e.g., depth information, color information, etc.) related to the acquisition process of the point cloud video.

The point cloud content providing system (e.g., the transmission device 10000 or the point cloud video encoder 10002) according to the embodiments may encode the point cloud data (20001). The point cloud content providing system may encode the point cloud data based on point cloud compression coding. As described above, the point cloud data may include the geometry and attributes of a point. Accordingly, the point cloud content providing system may perform geometry encoding of encoding the geometry and output a geometry bitstream. The point cloud content providing system may perform attribute encoding of encoding attributes and output an attribute bitstream. According to embodiments, the point cloud content providing system may perform the attribute encoding based on the geometry encoding. The geometry bitstream and the attribute bitstream according to the embodiments may be multiplexed and output as one bitstream. The bitstream according to the embodiments may further contain signaling information related to the geometry encoding and attribute encoding.

The point cloud content providing system (e.g., the transmission device 10000 or the transmitter 10003) according to the embodiments may transmit the encoded point cloud data (20002). As illustrated in FIG. 1, the encoded point cloud data may be represented by a geometry bitstream and an attribute bitstream. In addition, the encoded point cloud data may be transmitted in the form of a bitstream together with signaling information related to encoding of the point cloud data (e.g., signaling information related to the geometry encoding and the attribute encoding). The point cloud content providing system may encapsulate a bitstream that carries the encoded point cloud data and transmit the same in the form of a file or segment.

The point cloud content providing system (e.g., the reception device 10004 or the receiver 10005) according to the embodiments may receive the bitstream containing the encoded point cloud data. In addition, the point cloud content providing system (e.g., the reception device 10004 or the receiver 10005) may demultiplex the bitstream.

The point cloud content providing system (e.g., the reception device 10004 or the point cloud video decoder 10005) may decode the encoded point cloud data (e.g., the geometry bitstream, the attribute bitstream) transmitted in the bitstream. The point cloud content providing system (e.g., the reception device 10004 or the point cloud video decoder 10005) may decode the point cloud video data based on the signaling information related to encoding of the point cloud video data contained in the bitstream. The point cloud content providing system (e.g., the reception device 10004 or the point cloud video decoder 10005) may decode the geometry bitstream to reconstruct the positions (geometry) of points. The point cloud content providing system may reconstruct the attributes of the points by decoding the attribute bitstream based on the reconstructed geometry. The point cloud content providing system (e.g., the reception device 10004 or the point cloud video decoder 10005) may reconstruct the point cloud video based on the positions according to the reconstructed geometry and the decoded attributes.

The point cloud content providing system according to the embodiments (e.g., the reception device 10004 or the renderer 10007) may render the decoded point cloud data (20004). The point cloud content providing system (e.g., the reception device 10004 or the renderer 10007) may render the geometry and attributes decoded through the decoding process, using various rendering methods. Points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

The point cloud content providing system (e.g., the reception device 10004) according to the embodiments may secure feedback information (20005). The point cloud content providing system may encode and/or decode point cloud data based on the feedback information. The feedback information and the operation of the point cloud content providing system according to the embodiments are the same as the feedback information and the operation described with reference to FIG. 1, and thus detailed description thereof is omitted.

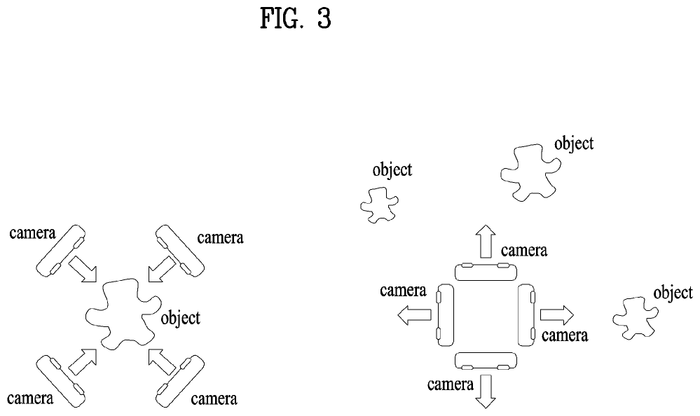

FIG. 3 illustrates an exemplary process of capturing a point cloud video according to embodiments.

FIG. 3 illustrates an exemplary point cloud video capture process of the point cloud content providing system described with reference to FIGS. 1 to 2.

Point cloud content includes a point cloud video (images and/or videos) representing an object and/or environment located in various 3D spaces (e.g., a 3D space representing a real environment, a 3D space representing a virtual environment, etc.). Accordingly, the point cloud content providing system according to the embodiments may capture a point cloud video using one or more cameras (e.g., an infrared camera capable of securing depth information, an RGB camera capable of extracting color information corresponding to the depth information, etc.), a projector (e.g., an infrared pattern projector to secure depth information), a LiDAR, or the like. The point cloud content providing system according to the embodiments may extract the shape of geometry composed of points in a 3D space from the depth information and extract the attributes of each point from the color information to secure point cloud data. An image and/or video according to the embodiments may be captured based on at least one of the inward-facing technique and the outward-facing technique.

The left part of FIG. 3 illustrates the inward-facing technique. The inward-facing technique refers to a technique of capturing images a central object with one or more cameras (or camera sensors) positioned around the central object. The inward-facing technique may be used to generate point cloud content providing a 360-degree image of a key object to the user (e.g., VR/AR content providing a 360-degree image of an object (e.g., a key object such as a character, player, object, or actor) to the user).

The right part of FIG. 3 illustrates the outward-facing technique. The outward-facing technique refers to a technique of capturing images an environment of a central object rather than the central object with one or more cameras (or camera sensors) positioned around the central object. The outward-facing technique may be used to generate point cloud content for providing a surrounding environment that appears from the user's point of view (e.g., content representing an external environment that may be provided to a user of a self-driving vehicle).

As shown in FIG. 3, the point cloud content may be generated based on the capturing operation of one or more cameras. In this case, the coordinate system may differ among the cameras, and accordingly the point cloud content providing system may calibrate one or more cameras to set a global coordinate system before the capturing operation. In addition, the point cloud content providing system may generate point cloud content by synthesizing an arbitrary image and/or video with an image and/or video captured by the above-described capture technique. The point cloud content providing system may not perform the capturing operation described in FIG. 3 when it generates point cloud content representing a virtual space. The point cloud content providing system according to the embodiments may perform post-processing on the captured image and/or video. In other words, the point cloud content providing system may remove an unwanted area (e.g., a background), recognize a space to which the captured images and/or videos are connected, and, when there is a spatial hole, perform an operation of filling the spatial hole.

The point cloud content providing system may generate one piece of point cloud content by performing coordinate transformation on points of the point cloud video secured from each camera. The point cloud content providing system may perform coordinate transformation on the points based on the coordinates of the position of each camera. Accordingly, the point cloud content providing system may generate content representing one wide range, or may generate point cloud content having a high density of points.

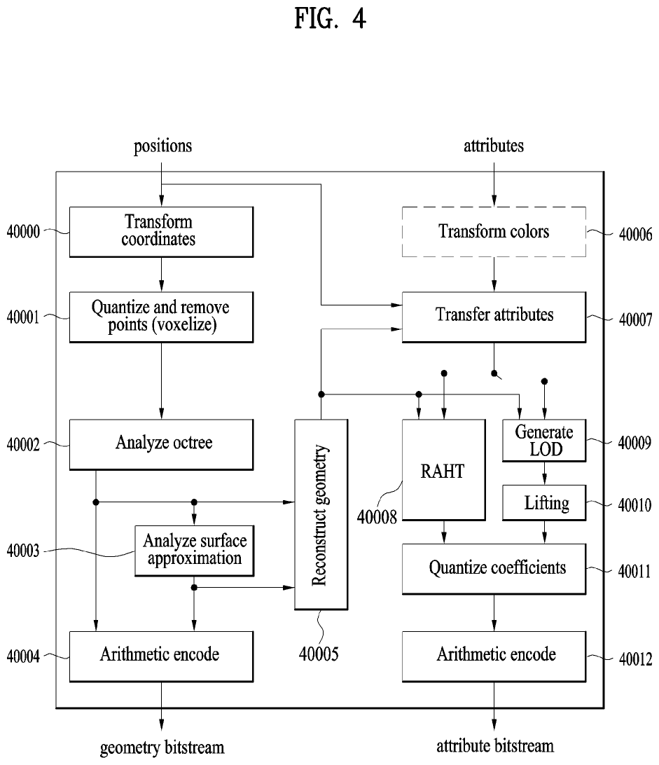

FIG. 4 illustrates an exemplary point cloud video encoder according to embodiments.

FIG. 4 shows an example of the point cloud video encoder 10002 of FIG. 1. The point cloud video encoder reconstructs and encodes point cloud data (e.g., positions and/or attributes of the points) to adjust the quality of the point cloud content (to, for example, lossless, lossy, or near-lossless) according to the network condition or applications. When the overall size of the point cloud content is large (e.g., point cloud content of 60 Gbps is given for 30 fps), the point cloud content providing system may fail to stream the content in real time. Accordingly, the point cloud content providing system may reconstruct the point cloud content based on the maximum target bitrate to provide the same in accordance with the network environment or the like.

As described with reference to FIGS. 1 and 2, the point cloud video encoder may perform geometry encoding and attribute encoding. The geometry encoding is performed before the attribute encoding.

The point cloud video encoder according to the embodiments includes a coordinate transformer (Transform coordinates) 40000, a quantizer (Quantize and remove points (voxelize)) 40001, an octree analyzer (Analyze octree) 40002, and a surface approximation analyzer (Analyze surface approximation) 40003, an arithmetic encoder (Arithmetic encode) 40004, a geometry reconstructor (Reconstruct geometry) 40005, a color transformer (Transform colors) 40006, an attribute transformer (Transform attributes) 40007, a RAHT transformer (RAHT) 40008, an LOD generator (Generate LOD) 40009, a lifting transformer (Lifting) 40010, a coefficient quantizer (Quantize coefficients) 40011, and/or an arithmetic encoder (Arithmetic encode) 40012.

The coordinate transformer 40000, the quantizer 40001, the octree analyzer 40002, the surface approximation analyzer 40003, the arithmetic encoder 40004, and the geometry reconstructor 40005 may perform geometry encoding. The geometry encoding according to the embodiments may include octree geometry coding, direct coding, trisoup geometry encoding, and entropy encoding. The direct coding and trisoup geometry encoding are applied selectively or in combination. The geometry encoding is not limited to the above-described example.

As shown in the figure, the coordinate transformer 40000 according to the embodiments receives positions and transforms the same into coordinates. For example, the positions may be transformed into position information in a three-dimensional space (e.g., a three-dimensional space represented by an XYZ coordinate system). The position information in the three-dimensional space according to the embodiments may be referred to as geometry information.

The quantizer 40001 according to the embodiments quantizes the geometry information. For example, the quantizer 40001 may quantize the points based on a minimum position value of all points (e.g., a minimum value on each of the X, Y, and Z axes). The quantizer 40001 performs a quantization operation of multiplying the difference between the minimum position value and the position value of each point by a preset quantization scale value and then finding the nearest integer value by rounding the value obtained through the multiplication. Thus, one or more points may have the same quantized position (or position value). The quantizer 40001 according to the embodiments performs voxelization based on the quantized positions to reconstruct quantized points. The voxelization means a minimum unit representing position information in 3D space. Points of point cloud content (or 3D point cloud video) according to the embodiments may be included in one or more voxels. The term voxel, which is a compound of volume and pixel, refers to a 3D cubic space generated when a 3D space is divided into units (unit=1.0) based on the axes representing the 3D space (e.g., X-axis, Y-axis, and Z-axis). The quantizer 40001 may match groups of points in the 3D space with voxels. According to embodiments, one voxel may include only one point. According to embodiments, one voxel may include one or more points. In order to express one voxel as one point, the position of the center point of a voxel may be set based on the positions of one or more points included in the voxel. In this case, attributes of all positions included in one voxel may be combined and assigned to the voxel.

The octree analyzer 40002 according to the embodiments performs octree geometry coding (or octree coding) to present voxels in an octree structure. The octree structure represents points matched with voxels, based on the octal tree structure.

The surface approximation analyzer 40003 according to the embodiments may analyze and approximate the octree. The octree analysis and approximation according to the embodiments is a process of analyzing a region containing a plurality of points to efficiently provide octree and voxelization.

The arithmetic encoder 40004 according to the embodiments performs entropy encoding on the octree and/or the approximated octree. For example, the encoding scheme includes arithmetic encoding. As a result of the encoding, a geometry bitstream is generated.

The color transformer 40006, the attribute transformer 40007, the RAHT transformer 40008, the LOD generator 40009, the lifting transformer 40010, the coefficient quantizer 40011, and/or the arithmetic encoder 40012 perform attribute encoding. As described above, one point may have one or more attributes. The attribute encoding according to the embodiments is equally applied to the attributes that one point has. However, when an attribute (e.g., color) includes one or more elements, attribute encoding is independently applied to each element. The attribute encoding according to the embodiments includes color transform coding, attribute transform coding, region adaptive hierarchical transform (RAHT) coding, interpolation-based hierarchical nearest-neighbor prediction (prediction transform) coding, and interpolation-based hierarchical nearest-neighbor prediction with an update/lifting step (lifting transform) coding. Depending on the point cloud content, the RAHT coding, the prediction transform coding and the lifting transform coding described above may be selectively used, or a combination of one or more of the coding schemes may be used. The attribute encoding according to the embodiments is not limited to the above-described example.

The color transformer 40006 according to the embodiments performs color transform coding of transforming color values (or textures) included in the attributes. For example, the color transformer 40006 may transform the format of color information (e.g., from RGB to YCbCr). The operation of the color transformer 40006 according to embodiments may be optionally applied according to the color values included in the attributes.

The geometry reconstructor 40005 according to the embodiments reconstructs (decompresses) the octree and/or the approximated octree. The geometry reconstructor 40005 reconstructs the octree/voxels based on the result of analyzing the distribution of points. The reconstructed octree/voxels may be referred to as reconstructed geometry (restored geometry).

The attribute transformer 40007 according to the embodiments performs attribute transformation to transform the attributes based on the reconstructed geometry and/or the positions on which geometry encoding is not performed. As described above, since the attributes are dependent on the geometry, the attribute transformer 40007 may transform the attributes based on the reconstructed geometry information. For example, based on the position value of a point included in a voxel, the attribute transformer 40007 may transform the attribute of the point at the position. As described above, when the position of the center of a voxel is set based on the positions of one or more points included in the voxel, the attribute transformer 40007 transforms the attributes of the one or more points. When the trisoup geometry encoding is performed, the attribute transformer 40007 may transform the attributes based on the trisoup geometry encoding.

The attribute transformer 40007 may perform the attribute transformation by calculating the average of attributes or attribute values of neighboring points (e.g., color or reflectance of each point) within a specific position/radius from the position (or position value) of the center of each voxel. The attribute transformer 40007 may apply a weight according to the distance from the center to each point in calculating the average. Accordingly, each voxel has a position and a calculated attribute (or attribute value).

The attribute transformer 40007 may search for neighboring points existing within a specific position/radius from the position of the center of each voxel based on the K-D tree or the Morton code. The K-D tree is a binary search tree and supports a data structure capable of managing points based on the positions such that nearest neighbor search (NNS) can be performed quickly. The Morton code is generated by presenting coordinates (e.g., (x, y, z)) representing 3D positions of all points as bit values and mixing the bits. For example, when the coordinates representing the position of a point are (5, 9, 1), the bit values for the coordinates are (0101, 1001, 0001). Mixing the bit values according to the bit index in order of z, y, and x yields 010001000111. This value is expressed as a decimal number of 1095. That is, the Morton code value of the point having coordinates (5, 9, 1) is 1095. The attribute transformer 40007 may order the points based on the Morton code values and perform NNS through a depth-first traversal process. After the attribute transformation operation, the K-D tree or the Morton code is used when the NNS is needed in another transformation process for attribute coding.

As shown in the figure, the transformed attributes are input to the RAHT transformer 40008 and/or the LOD generator 40009.

The RAHT transformer 40008 according to the embodiments performs RAHT coding for predicting attribute information based on the reconstructed geometry information. For example, the RAHT transformer 40008 may predict attribute information of a node at a higher level in the octree based on the attribute information associated with a node at a lower level in the octree.

The LOD generator 40009 according to the embodiments generates a level of detail (LOD). The LOD according to the embodiments is a degree of detail of point cloud content. As the LOD value decrease, it indicates that the detail of the point cloud content is degraded. As the LOD value increases, it indicates that the detail of the point cloud content is enhanced. Points may be classified by the LOD.

The lifting transformer 40010 according to the embodiments performs lifting transform coding of transforming the attributes a point cloud based on weights. As described above, lifting transform coding may be optionally applied.

The coefficient quantizer 40011 according to the embodiments quantizes the attribute-coded attributes based on coefficients.

The arithmetic encoder 40012 according to the embodiments encodes the quantized attributes based on arithmetic coding.

Although not shown in the figure, the elements of the point cloud video encoder of FIG. 4 may be implemented by hardware including one or more processors or integrated circuits configured to communicate with one or more memories included in the point cloud content providing apparatus, software, firmware, or a combination thereof. The one or more processors may perform at least one of the operations and/or functions of the elements of the point cloud video encoder of FIG. 4 described above. Additionally, the one or more processors may operate or execute a set of software programs and/or instructions for performing the operations and/or functions of the elements of the point cloud video encoder of FIG. 4. The one or more memories according to the embodiments may include a high speed random access memory, or include a non-volatile memory (e.g., one or more magnetic disk storage devices, flash memory devices, or other non-volatile solid-state memory devices).

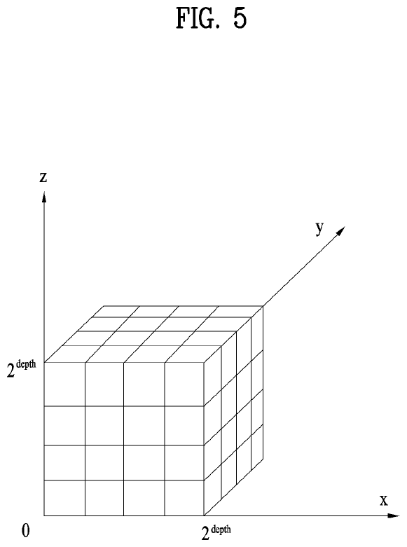

FIG. 5 shows an example of voxels according to embodiments.

FIG. 5 shows voxels positioned in a 3D space represented by a coordinate system composed of three axes, which are the X-axis, the Y-axis, and the Z-axis. As described with reference to FIG. 4, the point cloud video encoder (e.g., the quantizer 40001) may perform voxelization. Voxel refers to a 3D cubic space generated when a 3D space is divided into units (unit=1.0) based on the axes representing the 3D space (e.g., X-axis, Y-axis, and Z-axis). FIG. 5 shows an example of voxels generated through an octree structure in which a cubical axis-aligned bounding box defined by two poles (0, 0, 0) and (2^{d}, 2^{d}, 2^{d}) is recursively subdivided. One voxel includes at least one point. The spatial coordinates of a voxel may be estimated from the positional relationship with a voxel group. As described above, a voxel has an attribute (such as color or reflectance) like pixels of a 2D image/video. The details of the voxel are the same as those described with reference to FIG. 4, and therefore a description thereof is omitted.

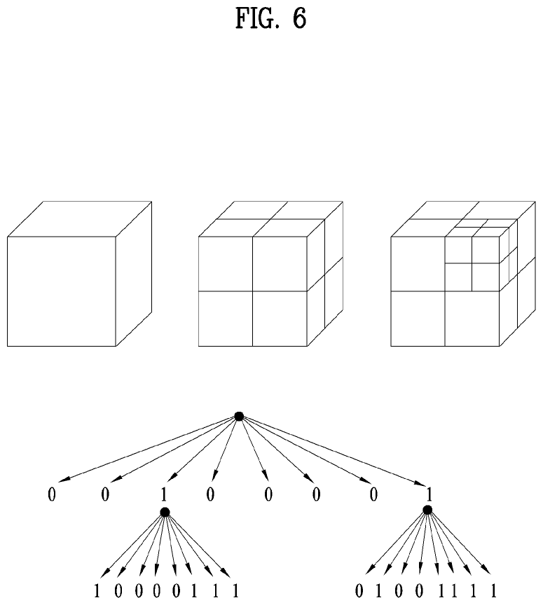

FIG. 6 shows an example of an octree and occupancy code according to embodiments.

As described with reference to FIGS. 1 to 4, the point cloud content providing system (point cloud video encoder 10002) or the octree analyzer 40002 of the point cloud video encoder performs octree geometry coding (or octree coding) based on an octree structure to efficiently manage the region and/or position of the voxel.

The upper part of FIG. 6 shows an octree structure. The 3D space of the point cloud content according to the embodiments is represented by axes (e.g., X-axis, Y-axis, and Z-axis) of the coordinate system. The octree structure is created by recursive subdividing of a cubical axis-aligned bounding box defined by two poles (0, 0, 0) and (2^{d}, 2^{d}, 2^{d}) Here, 2^{d} may be set to a value constituting the smallest bounding box surrounding all points of the point cloud content (or point cloud video). Here, d denotes the depth of the octree. The value of d is determined in Equation 1. In Equation 1, (x^{int}ₙ, y^{int}ₙ, z^{int}ₙ) denotes the positions (or position values) of quantized points.

d=Ceil(Log 2(Max(xₙ^{int},yₙ^{int},zₙ^{int},n=1, . . . ,N)+1)) Equation 1

As shown in the middle of the upper part of FIG. 6, the entire 3D space may be divided into eight spaces according to partition. Each divided space is represented by a cube with six faces. As shown in the upper right of FIG. 6, each of the eight spaces is divided again based on the axes of the coordinate system (e.g., X-axis, Y-axis, and Z-axis). Accordingly, each space is divided into eight smaller spaces. The divided smaller space is also represented by a cube with six faces. This partitioning scheme is applied until the leaf node of the octree becomes a voxel.

The lower part of FIG. 6 shows an octree occupancy code. The occupancy code of the octree is generated to indicate whether each of the eight divided spaces generated by dividing one space contains at least one point. Accordingly, a single occupancy code is represented by eight child nodes. Each child node represents the occupancy of a divided space, and the child node has a value in 1 bit. Accordingly, the occupancy code is represented as an 8-bit code. That is, when at least one point is contained in the space corresponding to a child node, the node is assigned a value of 1. When no point is contained in the space corresponding to the child node (the space is empty), the node is assigned a value of 0. Since the occupancy code shown in FIG. 6 is 00100001, it indicates that the spaces corresponding to the third child node and the eighth child node among the eight child nodes each contain at least one point. As shown in the figure, each of the third child node and the eighth child node has eight child nodes, and the child nodes are represented by an 8-bit occupancy code. The figure shows that the occupancy code of the third child node is 10000111, and the occupancy code of the eighth child node is 01001111. The point cloud video encoder (e.g., the arithmetic encoder 40004) according to the embodiments may perform entropy encoding on the occupancy codes. In order to increase the compression efficiency, the point cloud video encoder may perform intra/inter-coding on the occupancy codes. The reception device (e.g., the reception device 10004 or the point cloud video decoder 10006) according to the embodiments reconstructs the octree based on the occupancy codes.

The point cloud video encoder (e.g., the octree analyzer 40002) according to the embodiments may perform voxelization and octree coding to store the positions of points. However, points are not always evenly distributed in the 3D space, and accordingly there may be a specific region in which fewer points are present. Accordingly, it is inefficient to perform voxelization for the entire 3D space. For example, when a specific region contains few points, voxelization does not need to be performed in the specific region.

Accordingly, for the above-described specific region (or a node other than the leaf node of the octree), the point cloud video encoder according to the embodiments may skip voxelization and perform direct coding to directly code the positions of points included in the specific region. The coordinates of a direct coding point according to the embodiments are referred to as direct coding mode (DCM). The point cloud video encoder according to the embodiments may also perform trisoup geometry encoding, which is to reconstruct the positions of the points in the specific region (or node) based on voxels, based on a surface model. The trisoup geometry encoding is geometry encoding that represents an object as a series of triangular meshes. Accordingly, the point cloud video decoder may generate a point cloud from the mesh surface. The direct coding and trisoup geometry encoding according to the embodiments may be selectively performed. In addition, the direct coding and trisoup geometry encoding according to the embodiments may be performed in combination with octree geometry coding (or octree coding).

To perform direct coding, the option to use the direct mode for applying direct coding should be activated. A node to which direct coding is to be applied is not a leaf node, and points less than a threshold should be present within a specific node. In addition, the total number of points to which direct coding is to be applied should not exceed a preset threshold. When the conditions above are satisfied, the point cloud video encoder (or the arithmetic encoder 40004) according to the embodiments may perform entropy coding on the positions (or position values) of the points.

The point cloud video encoder (e.g., the surface approximation analyzer 40003) according to the embodiments may determine a specific level of the octree (a level less than the depth d of the octree), and the surface model may be used staring with that level to perform trisoup geometry encoding to reconstruct the positions of points in the region of the node based on voxels (Trisoup mode). The point cloud video encoder according to the embodiments may specify a level at which trisoup geometry encoding is to be applied. For example, when the specific level is equal to the depth of the octree, the point cloud video encoder does not operate in the trisoup mode. In other words, the point cloud video encoder according to the embodiments may operate in the trisoup mode only when the specified level is less than the value of depth of the octree. The 3D cube region of the nodes at the specified level according to the embodiments is called a block. One block may include one or more voxels. The block or voxel may correspond to a brick. Geometry is represented as a surface within each block. The surface according to embodiments may intersect with each edge of a block at most once.

One block has 12 edges, and accordingly there are at least 12 intersections in one block. Each intersection is called a vertex (or apex). A vertex present along an edge is detected when there is at least one occupied voxel adjacent to the edge among all blocks sharing the edge. The occupied voxel according to the embodiments refers to a voxel containing a point. The position of the vertex detected along the edge is the average position along the edge of all voxels adjacent to the edge among all blocks sharing the edge.

Once the vertex is detected, the point cloud video encoder according to the embodiments may perform entropy encoding on the starting point (x, y, z) of the edge, the direction vector (Δx, Δy, Δz) of the edge, and the vertex position value (relative position value within the edge). When the trisoup geometry encoding is applied, the point cloud video encoder according to the embodiments (e.g., the geometry reconstructor 40005) may generate restored geometry (reconstructed geometry) by performing the triangle reconstruction, up-sampling, and voxelization processes.

The vertices positioned at the edge of the block determine a surface that passes through the block. The surface according to the embodiments is a non-planar polygon. In the triangle reconstruction process, a surface represented by a triangle is reconstructed based on the starting point of the edge, the direction vector of the edge, and the position values of the vertices. The triangle reconstruction process is performed according to Equation 2 by: i) calculating the centroid value of each vertex, ii) subtracting the center value from each vertex value, and iii) estimating the sum of the squares of the values obtained by the subtraction.

$$\begin{matrix}Equation 2 & \\ [ \begin{matrix}{μ}_{x} \\ {μ}_{y} \\ {μ}_{z}\end{matrix} ] = \frac{1}{n} {\sum }_{i = 1}^{n} [ \begin{matrix}{x}_{i} \\ {y}_{i} \\ {z}_{i}\end{matrix} ] & \end{matrix}$$

$$[ \begin{matrix}{\overline{x}}_{i} \\ {\overline{y}}_{i} \\ {\overline{z}}_{i}\end{matrix} ] = [ \begin{matrix}{x}_{i} \\ {y}_{i} \\ {z}_{i}\end{matrix} ] - [ \begin{matrix}{μ}_{x} \\ {μ}_{y} \\ {μ}_{z}\end{matrix} ]$$

$$[ \begin{matrix}{σ}_{x}^{2} \\ {σ}_{y}^{2} \\ {σ}_{z}^{2}\end{matrix} ] = {\sum }_{i = 1}^{n} [ \begin{matrix}\begin{matrix}{\overline{x}}_{i}^{2} \\ {\overline{y}}_{i}^{2}\end{matrix} \\ {\overline{z}}_{i}^{2}\end{matrix} ]$$

Then, the minimum value of the sum is estimated, and the projection process is performed according to the axis with the minimum value. For example, when the element x is the minimum, each vertex is projected on the x-axis with respect to the center of the block, and projected on the (y, z) plane. When the values obtained through projection on the (y, z) plane are (ai, bi), the value of θ is estimated through a tan 2(bi, ai), and the vertices are ordered based on the value of θ. Table 1 below shows a combination of vertices for creating a triangle according to the number of the vertices. The vertices are ordered from 1 to n. Table 1 below shows that for four vertices, two triangles may be constructed according to combinations of vertices. The first triangle may consist of vertices 1, 2, and 3 among the ordered vertices, and the second triangle may consist of vertices 3, 4, and 1 among the ordered vertices.

[Table 1] Triangles formed from vertices ordered 1, . . . , n

TABLE 1

| n | Triangles |
|---|---|
| 3 | (1, 2, 3) |
| 4 | (1, 2, 3), (3, 4, 1) |
| 5 | (1, 2, 3), (3, 4, 5), (5, 1, 3) |
| 6 | (1, 2, 3), (3, 4, 5), (5, 6, 1), (1, 3, 5) |
| 7 | (1, 2, 3), (3, 4, 5), (5, 6, 7), (7, 1, 3), (3, 5, 7) |
| 8 | (1, 2, 3), (3, 4, 5), (5, 6, 7), (7, 8, 1), (1, 3, 5), (5, 7, 1) |
| 9 | (1, 2, 3), (3, 4, 5), (5, 6, 7), (7, 8, 9), (9, 1, 3), (3, 5, 7), |
| | (7, 9, 3) |
| 10 | (1, 2, 3), (3, 4, 5), (5, 6, 7), (7, 8, 9), (9, 10, 1), (1, 3, 5), |
| | (5, 7, 9), (9, 1, 5) |
| 11 | (1, 2, 3), (3, 4, 5), (5, 6, 7), (7, 8, 9), (9, 10, 11), (11, 1, 3), |
| | (3, 5, 7), (7, 9, 11), (11, 3, 7) |
| 12 | (1, 2, 3), (3, 4, 5), (5, 6, 7), (7, 8, 9), (9, 10, 11), (11, 12, 1), |
| | (1, 3, 5), (5, 7, 9), (9, 11, 1), (1, 5, 9) |

The upsampling process is performed to add points in the middle along the edge of the triangle and perform voxelization. The added points are generated based on the upsampling factor and the width of the block. The added points are called refined vertices. The point cloud video encoder according to the embodiments may voxelize the refined vertices. In addition, the point cloud video encoder may perform attribute encoding based on the voxelized positions (or position values).

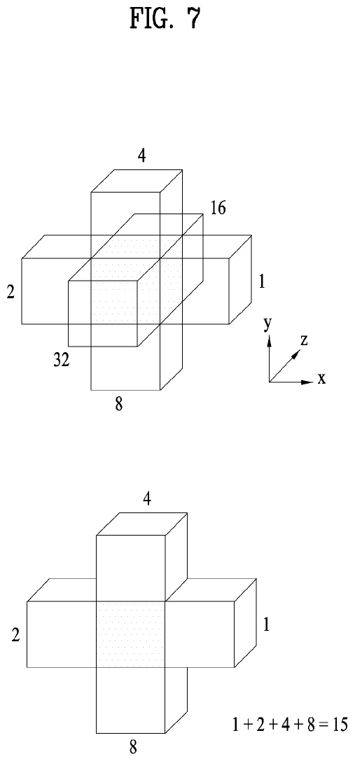

FIG. 7 shows an example of a neighbor node pattern according to embodiments.

In order to increase the compression efficiency of the point cloud video, the point cloud video encoder according to the embodiments may perform entropy coding based on context adaptive arithmetic coding. The point cloud video encoder may entropy encode based on a context adaptive arithmetic coding to enhance compression efficiency of the point cloud video.

As described with reference to FIGS. 1 to 6, the point cloud content providing system or the point cloud video encoder 10002 of FIG. 1, or the point cloud video encoder or arithmetic encoder 40004 of FIG. 4 may perform entropy coding on the occupancy code immediately. In addition, the point cloud content providing system or the point cloud video encoder may perform entropy encoding (intra encoding) based on the occupancy code of the current node and the occupancy of neighboring nodes, or perform entropy encoding (inter encoding) based on the occupancy code of the previous frame. A frame according to embodiments represents a set of point cloud videos generated at the same time. The compression efficiency of intra encoding/inter encoding according to the embodiments may depend on the number of neighboring nodes that are referenced. When the bits increase, the operation becomes complicated, but the encoding may be biased to one side, which may increase the compression efficiency. For example, when a 3-bit context is given, coding needs to be performed using 2³=8 methods. The part divided for coding affects the complexity of implementation. Accordingly, it is necessary to meet an appropriate level of compression efficiency and complexity.

FIG. 7 illustrates a process of obtaining an occupancy pattern based on the occupancy of neighbor nodes. The point cloud video encoder according to the embodiments determines occupancy of neighbor nodes of each node of the octree and obtains a value of a neighbor pattern. The neighbor node pattern is used to infer the occupancy pattern of the node. The upper part of FIG. 7 shows a cube corresponding to a node (a cube positioned in the middle) and six cubes (neighbor nodes) sharing at least one face with the cube. The nodes shown in the figure are nodes of the same depth. The numbers shown in the figure represent weights (1, 2, 4, 8, 16, and 32) associated with the six nodes, respectively. The weights are assigned sequentially according to the positions of neighboring nodes.

The lower part of FIG. 7 shows neighbor node pattern values. A neighbor node pattern value is the sum of values multiplied by the weight of an occupied neighbor node (a neighbor node having a point). Accordingly, the neighbor node pattern values are 0 to 63. When the neighbor node pattern value is 0, it indicates that there is no node having a point (no occupied node) among the neighbor nodes of the node. When the neighbor node pattern value is 63, it indicates that all neighbor nodes are occupied nodes. As shown in the figure, since neighbor nodes to which weights 1, 2, 4, and 8 are assigned are occupied nodes, the neighbor node pattern value is 15, the sum of 1, 2, 4, and 8. The point cloud video encoder may perform coding according to the neighbor node pattern value (for example, when the neighbor node pattern value is 63, 64 kinds of coding may be performed). According to embodiments, the point cloud video encoder may reduce coding complexity by changing a neighbor node pattern value (based on, for example, a table by which 64 is changed to 10 or 6).

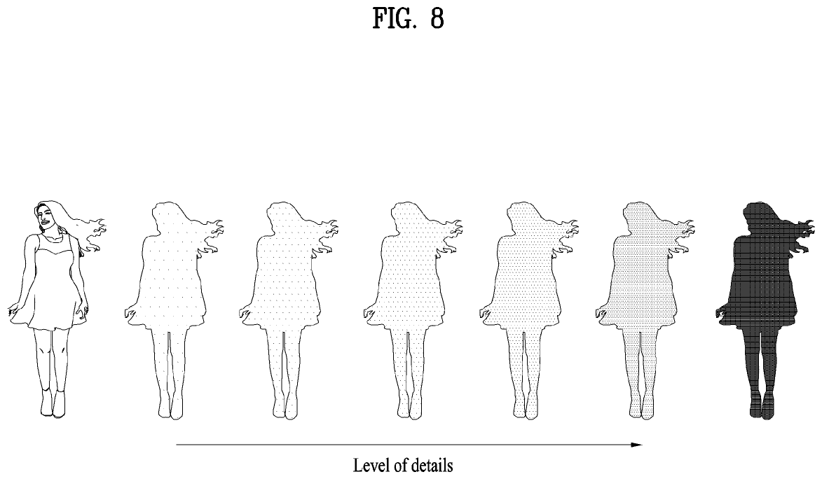

FIG. 8 illustrates an example of point configuration in each LOD according to embodiments.

As described with reference to FIGS. 1 to 7, encoded geometry is reconstructed (decompressed) before attribute encoding is performed. When direct coding is applied, the geometry reconstruction operation may include changing the placement of direct coded points (e.g., placing the direct coded points in front of the point cloud data). When trisoup geometry encoding is applied, the geometry reconstruction process is performed through triangle reconstruction, up-sampling, and voxelization. Since the attribute depends on the geometry, attribute encoding is performed based on the reconstructed geometry.

The point cloud video encoder (e.g., the LOD generator 40009) may classify (or reorganize) points by LOD. FIG. 8 shows the point cloud content corresponding to LODs. The leftmost picture in FIG. 8 represents original point cloud content. The second picture from the left of FIG. 8 represents distribution of the points in the lowest LOD, and the rightmost picture in FIG. 8 represents distribution of the points in the highest LOD. That is, the points in the lowest LOD are sparsely distributed, and the points in the highest LOD are densely distributed. That is, as the LOD rises in the direction pointed by the arrow indicated at the bottom of FIG. 8, the space (or distance) between points is narrowed.

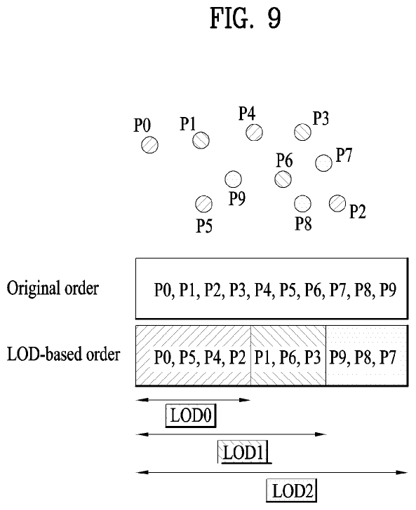

FIG. 9 illustrates an example of point configuration for each LOD according to embodiments.

As described with reference to FIGS. 1 to 8, the point cloud content providing system, or the point cloud video encoder (e.g., the point cloud video encoder 10002 of FIG. 1, the point cloud video encoder of FIG. 4, or the LOD generator 40009) may generates an LOD. The LOD is generated by reorganizing the points into a set of refinement levels according to a set LOD distance value (or a set of Euclidean distances). The LOD generation process is performed not only by the point cloud video encoder, but also by the point cloud video decoder.

The upper part of FIG. 9 shows examples (P0 to P9) of points of the point cloud content distributed in a 3D space. In FIG. 9, the original order represents the order of points P0 to P9 before LOD generation. In FIG. 9, the LOD based order represents the order of points according to the LOD generation. Points are reorganized by LOD. Also, a high LOD contains the points belonging to lower LODs. As shown in FIG. 9, LOD0 contains P0, P5, P4 and P2. LOD1 contains the points of LOD0, P1, P6 and P3. LOD2 contains the points of LOD0, the points of LOD1, P9, P8 and P7.

As described with reference to FIG. 4, the point cloud video encoder according to the embodiments may perform prediction transform coding based on LOD, lifting transform coding based on LOD, and RAHT transform coding selectively or in combination.

The point cloud video encoder according to the embodiments may generate a predictor for points to perform prediction transform coding based on LOD for setting a predicted attribute (or predicted attribute value) of each point. That is, N predictors may be generated for N points. The predictor according to the embodiments may calculate a weight (=1/distance) based on the LOD value of each point, indexing information about neighboring points present within a set distance for each LOD, and a distance to the neighboring points.

The predicted attribute (or attribute value) according to the embodiments is set to the average of values obtained by multiplying the attributes (or attribute values) (e.g., color, reflectance, etc.) of neighbor points set in the predictor of each point by a weight (or weight value) calculated based on the distance to each neighbor point. The point cloud video encoder according to the embodiments (e.g., the coefficient quantizer 40011) may quantize and inversely quantize the residual of each point (which may be called residual attribute, residual attribute value, attribute prediction residual value or prediction error attribute value and so on) obtained by subtracting a predicted attribute (or attribute value) each point from the attribute (i.e., original attribute value) of each point. The quantization process performed for a residual attribute value in a transmission device is configured as shown in table 2. The inverse quantization process performed for a residual attribute value in a reception device is configured as shown in Table 3.

TABLE 2

int PCCQuantization(int value, int quantStep) {
if( value >=0) {
return floor(value / quantStep + 1.0 / 3.0);
} else {
return −floor(−value / quantStep + 1.0 / 3.0);
}
}

TABLE 3

int PCCInverseQuantization(int value, int quantStep) {
if( quantStep ==0) {
return value;
} else {
return value * quantStep;
}
}

When the predictor of each point has neighbor points, the point cloud video encoder (e.g., the arithmetic encoder 40012) according to the embodiments may perform entropy coding on the quantized and inversely quantized residual attribute values as described above. 1) Create an array Quantization Weight (QW) for storing the weight value of each point. The initial value of all elements of QW is 1.0. Multiply the QW values of the predictor indexes of the neighbor nodes registered in the predictor by the weight of the predictor of the current point, and add the values obtained by the multiplication.

2) Lift prediction process: Subtract the value obtained by multiplying the attribute value of the point by the weight from the existing attribute value to calculate a predicted attribute value.

3) Create temporary arrays called updateweight and update and initialize the temporary arrays to zero.

4) Cumulatively add the weights calculated by multiplying the weights calculated for all predictors by a weight stored in the QW corresponding to a predictor index to the updateweight array as indexes of neighbor nodes. Cumulatively add, to the update array, a value obtained by multiplying the attribute value of the index of a neighbor node by the calculated weight.

5) Lift update process: Divide the attribute values of the update array for all predictors by the weight value of the updateweight array of the predictor index, and add the existing attribute value to the values obtained by the division.

6) Calculate predicted attributes by multiplying the attribute values updated through the lift update process by the weight updated through the lift prediction process (stored in the QW) for all predictors. The point cloud video encoder (e.g., coefficient quantizer 40011) according to the embodiments quantizes the predicted attribute values. In addition, the point cloud video encoder (e.g., the arithmetic encoder 40012) performs entropy coding on the quantized attribute values.

The point cloud video encoder (e.g., the RAHT transformer 40008) according to the embodiments may perform RAHT transform coding in which attributes of nodes of a higher level are predicted using the attributes associated with nodes of a lower level in the octree. RAHT transform coding is an example of attribute intra coding through an octree backward scan. The point cloud video encoder according to the embodiments scans the entire region from the voxel and repeats the merging process of merging the voxels into a larger block at each step until the root node is reached. The merging process according to the embodiments is performed only on the occupied nodes. The merging process is not performed on the empty node. The merging process is performed on an upper node immediately above the empty node.

Equation 3 below represents a RAHT transformation matrix. In Equation 3, gₗ_{_{x,y,z}} denotes the average attribute value of voxels at level l. gₗ_{_{x,y,z}} may be calculated based on gₗ₊₁_{_{2x,y,z}} and gₗ₊₁_{_{2x+1,y,z}}. The weights for gₗ_{_{2x,y,z}} and gₗ_{_{2x+1,y,z}} are w1=wₗ_{_{2x,y,z}} and w2=wₗ_{_{2x+1,y,z}}.

$$⌈ \begin{matrix}{g}_{l - {1}_{x , y , z}} \\ {h}_{l - {1}_{x , y , z}}\end{matrix} ⌉ = {T}_{w 1 w 2} = ⌈ \begin{matrix}{g}_{{l}_{2 x , y , z}} \\ {g}_{{l}_{2 x + 1 , y , z}}\end{matrix} ⌉ \qquad Equation 3$$

$${T}_{w 1 w 2} = \frac{1}{\sqrt{w 1 + w 2}} [ \begin{matrix}\sqrt{w 1} & \sqrt{w 2} \\ - \sqrt{w 2} & \sqrt{w 1}\end{matrix} ]$$

Here, gₗ₋₁_{_{x,y,z}} is a low-pass value and is used in the merging process at the next higher level. hₗ₋₁_{_{x,y,z}} denotes high-pass coefficients. The high-pass coefficients at each step are quantized and subjected to entropy coding (e.g., encoding by the arithmetic encoder 40012). The weights are calculated as wₗ_{_{−1 x,y,z}}=wₗ_{_{2x,y,z}}+wₗ_{_{2x+1,y,z}}. The root node is created through the g₁_{_{0,0,0}} and g₁_{_{0,0,1}} as Equation 4.

$$⌈ \begin{matrix}gDC \\ {h}_{{0}_{0 , 0 , 0}}\end{matrix} ⌉ = {T}_{w 1000 w 1001} ⌈ \begin{matrix}{g}_{{1}_{0 , 0 , 0 z}} \\ {g}_{{1}_{0 , 0 , 1}}\end{matrix} ⌉ \qquad Equation 4$$

The value of gDC is also quantized and subjected to entropy coding like the high-pass coefficients.

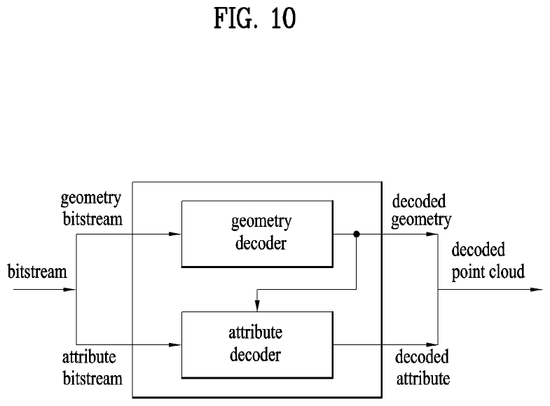

FIG. 10 illustrates a point cloud video decoder according to embodiments.

The point cloud video decoder illustrated in FIG. 10 is an example of the point cloud video decoder 10006 described in FIG. 1, and may perform the same or similar operations as the operations of the point cloud video decoder 10006 illustrated in FIG. 1. As shown in the figure, the point cloud video decoder may receive a geometry bitstream and an attribute bitstream contained in one or more bitstreams. The point cloud video decoder includes a geometry decoder and an attribute decoder. The geometry decoder performs geometry decoding on the geometry bitstream and outputs decoded geometry. The attribute decoder performs attribute decoding on the attribute bitstream based on the decoded geometry, and outputs decoded attributes. The decoded geometry and decoded attributes are used to reconstruct point cloud content (a decoded point cloud).

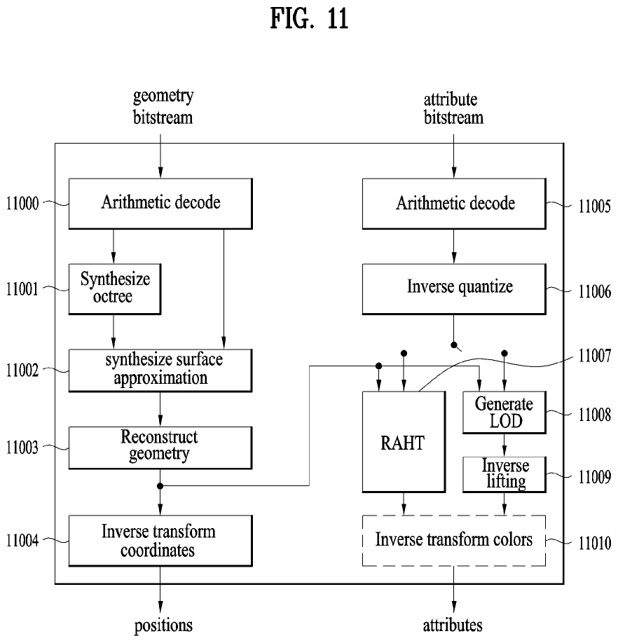

FIG. 11 illustrates a point cloud video decoder according to embodiments.

The point cloud video decoder illustrated in FIG. 11 is an example of the point cloud video decoder illustrated in FIG. 10, and may perform a decoding operation, which is a reverse process of the encoding operation of the point cloud video encoder illustrated in FIGS. 1 to 9.

As described with reference to FIGS. 1 and 10, the point cloud video decoder may perform geometry decoding and attribute decoding. The geometry decoding is performed before the attribute decoding.

The point cloud video decoder according to the embodiments includes an arithmetic decoder (Arithmetic decode) 11000, an octree synthesizer (Synthesize octree) 11001, a surface approximation synthesizer (Synthesize surface approximation) 11002, and a geometry reconstructor (Reconstruct geometry) 11003, a coordinate inverse transformer (Inverse transform coordinates) 11004, an arithmetic decoder (Arithmetic decode) 11005, an inverse quantizer (Inverse quantize) 11006, a RAHT transformer 11007, an LOD generator (Generate LOD) 11008, an inverse lifter (inverse lifting) 11009, and/or a color inverse transformer (Inverse transform colors) 11010.

The arithmetic decoder 11000, the octree synthesizer 11001, the surface approximation synthesizer 11002, and the geometry reconstructor 11003, and the coordinate inverse transformer 11004 may perform geometry decoding. The geometry decoding according to the embodiments may include direct decoding and trisoup geometry decoding. The direct decoding and trisoup geometry decoding are selectively applied. The geometry decoding is not limited to the above-described example, and is performed as an inverse process of the geometry encoding described with reference to FIGS. 1 to 9.

The arithmetic decoder 11000 according to the embodiments decodes the received geometry bitstream based on the arithmetic coding. The operation of the arithmetic decoder 11000 corresponds to the inverse process of the arithmetic encoder 40004.

The octree synthesizer 11001 according to the embodiments may generate an octree by acquiring an occupancy code from the decoded geometry bitstream (or information on the geometry secured as a result of decoding). The occupancy code is configured as described in detail with reference to FIGS. 1 to 9.

When the trisoup geometry encoding is applied, the surface approximation synthesizer 11002 according to the embodiments may synthesize a surface based on the decoded geometry and/or the generated octree.

The geometry reconstructor 11003 according to the embodiments may regenerate geometry based on the surface and/or the decoded geometry. As described with reference to FIGS. 1 to 9, direct coding and trisoup geometry encoding are selectively applied. Accordingly, the geometry reconstructor 11003 directly imports and adds position information about the points to which direct coding is applied. When the trisoup geometry encoding is applied, the geometry reconstructor 11003 may reconstruct the geometry by performing the reconstruction operations of the geometry reconstructor 40005, for example, triangle reconstruction, up-sampling, and voxelization. Details are the same as those described with reference to FIG. 6, and thus description thereof is omitted. The reconstructed geometry may include a point cloud picture or frame that does not contain attributes.

The coordinate inverse transformer 11004 according to the embodiments may acquire positions of the points by transforming the coordinates based on the reconstructed geometry.

The arithmetic decoder 11005, the inverse quantizer 11006, the RAHT transformer 11007, the LOD generator 11008, the inverse lifter 11009, and/or the color inverse transformer 11010 may perform the attribute decoding described with reference to FIG. 10. The attribute decoding according to the embodiments includes region adaptive hierarchical transform (RAHT) decoding, interpolation-based hierarchical nearest-neighbor prediction (prediction transform) decoding, and interpolation-based hierarchical nearest-neighbor prediction with an update/lifting step (lifting transform) decoding. The three decoding schemes described above may be used selectively, or a combination of one or more decoding schemes may be used. The attribute decoding according to the embodiments is not limited to the above-described example.

The arithmetic decoder 11005 according to the embodiments decodes the attribute bitstream by arithmetic coding.

The inverse quantizer 11006 according to the embodiments inversely quantizes the information about the decoded attribute bitstream or attributes secured as a result of the decoding, and outputs the inversely quantized attributes (or attribute values). The inverse quantization may be selectively applied based on the attribute encoding of the point cloud video encoder.

According to embodiments, the RAHT transformer 11007, the LOD generator 11008, and/or the inverse lifter 11009 may process the reconstructed geometry and the inversely quantized attributes. As described above, the RAHT transformer 11007, the LOD generator 11008, and/or the inverse lifter 11009 may selectively perform a decoding operation corresponding to the encoding of the point cloud video encoder.

The color inverse transformer 11010 according to the embodiments performs inverse transform coding to inversely transform a color value (or texture) included in the decoded attributes. The operation of the color inverse transformer 11010 may be selectively performed based on the operation of the color transformer 40006 of the point cloud video encoder.

Although not shown in the figure, the elements of the point cloud video decoder of FIG. 11 may be implemented by hardware including one or more processors or integrated circuits configured to communicate with one or more memories included in the point cloud content providing apparatus, software, firmware, or a combination thereof. The one or more processors may perform at least one or more of the operations and/or functions of the elements of the point cloud video decoder of FIG. 11 described above. Additionally, the one or more processors may operate or execute a set of software programs and/or instructions for performing the operations and/or functions of the elements of the point cloud video decoder of FIG. 11.

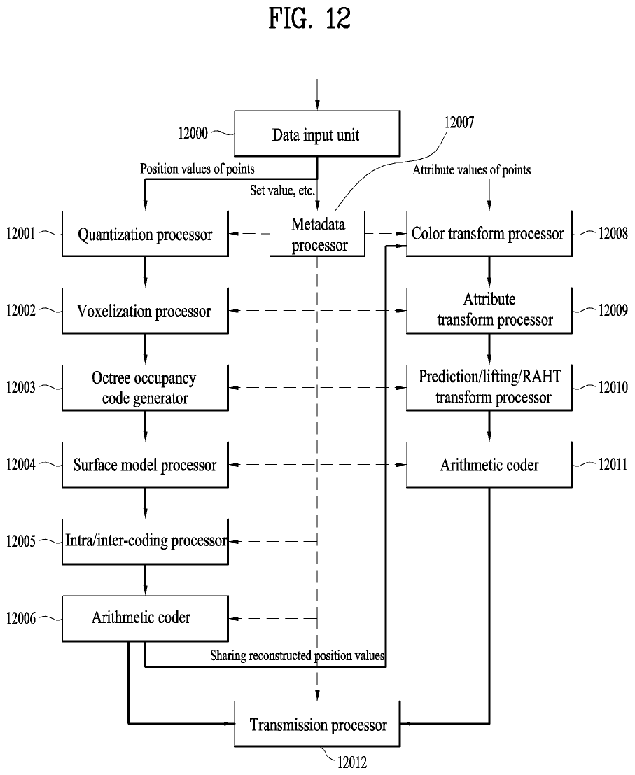

FIG. 12 illustrates a transmission device according to embodiments.

The transmission device shown in FIG. 12 is an example of the transmission device 10000 of FIG. 1 (or the point cloud video encoder of FIG. 4). The transmission device illustrated in FIG. 12 may perform one or more of the operations and methods the same as or similar to those of the point cloud video encoder described with reference to FIGS. 1 to 9. The transmission device according to the embodiments may include a data input unit 12000, a quantization processor 12001, a voxelization processor 12002, an octree occupancy code generator 12003, a surface model processor 12004, an intra/inter-coding processor 12005, an arithmetic coder 12006, a metadata processor 12007, a color transform processor 12008, an attribute transform processor 12009, a prediction/lifting/RAHT transform processor 12010, an arithmetic coder 12011 and/or a transmission processor 12012.

The data input unit 12000 according to the embodiments receives or acquires point cloud data. The data input unit 12000 may perform an operation and/or acquisition method the same as or similar to the operation and/or acquisition method of the point cloud video acquisition unit 10001 (or the acquisition process 20000 described with reference to FIG. 2).

The data input unit 12000, the quantization processor 12001, the voxelization processor 12002, the octree occupancy code generator 12003, the surface model processor 12004, the intra/inter-coding processor 12005, and the arithmetic coder 12006 perform geometry encoding. The geometry encoding according to the embodiments is the same as or similar to the geometry encoding described with reference to FIGS. 1 to 9, and thus a detailed description thereof is omitted.

The quantization processor 12001 according to the embodiments quantizes geometry (e.g., position values of points). The operation and/or quantization of the quantization processor 12001 is the same as or similar to the operation and/or quantization of the quantizer 40001 described with reference to FIG. 4. Details are the same as those described with reference to FIGS. 1 to 9.

The voxelization processor 12002 according to embodiments voxelizes the quantized position values of the points. The voxelization processor 12002 may perform an operation and/or process the same or similar to the operation and/or the voxelization process of the quantizer 40001 described with reference to FIG. 4. Details are the same as those described with reference to FIGS. 1 to 9.

The octree occupancy code generator 12003 according to the embodiments performs octree coding on the voxelized positions of the points based on an octree structure. The octree occupancy code generator 12003 may generate an occupancy code. The octree occupancy code generator 12003 may perform an operation and/or method the same as or similar to the operation and/or method of the point cloud video encoder (or the octree analyzer 40002) described with reference to FIGS. 4 and 6. Details are the same as those described with reference to FIGS. 1 to 9.

The surface model processor 12004 according to the embodiments may perform trisoup geometry encoding based on a surface model to reconstruct the positions of points in a specific region (or node) on a voxel basis. The surface model processor 12004 may perform an operation and/or method the same as or similar to the operation and/or method of the point cloud video encoder (e.g., the surface approximation analyzer 40003) described with reference to FIG. 4. Details are the same as those described with reference to FIGS. 1 to 9.

The intra/inter-coding processor 12005 according to the embodiments may perform intra/inter-coding on point cloud data. The intra/inter-coding processor 12005 may perform coding the same as or similar to the intra/inter-coding described with reference to FIG. 7. Details are the same as those described with reference to FIG. 7. According to embodiments, the intra/inter-coding processor 12005 may be included in the arithmetic coder 12006.

The arithmetic coder 12006 according to the embodiments performs entropy encoding on an octree of the point cloud data and/or an approximated octree. For example, the encoding scheme includes arithmetic encoding. The arithmetic coder 12006 performs an operation and/or method the same as or similar to the operation and/or method of the arithmetic encoder 40004.

The metadata processor 12007 according to the embodiments processes metadata about the point cloud data, for example, a set value, and provides the same to a necessary processing process such as geometry encoding and/or attribute encoding. Also, the metadata processor 12007 according to the embodiments may generate and/or process signaling information related to the geometry encoding and/or the attribute encoding. The signaling information according to the embodiments may be encoded separately from the geometry encoding and/or the attribute encoding. The signaling information according to the embodiments may be interleaved.

The color transform processor 12008, the attribute transform processor 12009, the prediction/lifting/RAHT transform processor 12010, and the arithmetic coder 12011 perform the attribute encoding. The attribute encoding according to the embodiments is the same as or similar to the attribute encoding described with reference to FIGS. 1 to 9, and thus a detailed description thereof is omitted.

The color transform processor 12008 according to the embodiments performs color transform coding to transform color values included in attributes. The color transform processor 12008 may perform color transform coding based on the reconstructed geometry. The reconstructed geometry is the same as described with reference to FIGS. 1 to 9. Also, it performs an operation and/or method the same as or similar to the operation and/or method of the color transformer 40006 described with reference to FIG. 4 is performed. A detailed description thereof is omitted.

The attribute transform processor 12009 according to the embodiments performs attribute transformation to transform the attributes based on the reconstructed geometry and/or the positions on which geometry encoding is not performed. The attribute transform processor 12009 performs an operation and/or method the same as or similar to the operation and/or method of the attribute transformer 40007 described with reference to FIG. 4. A detailed description thereof is omitted. The prediction/lifting/RAHT transform processor 12010 according to the embodiments may code the transformed attributes by any one or more combinations of RAHT coding, prediction transform coding, and lifting transform coding. The prediction/lifting/RAHT transform processor 12010 performs at least one of the operations the same as or similar to the operations of the RAHT transformer 40008, the LOD generator 40009, and the lifting transformer 40010 described with reference to FIG. 4. In addition, the prediction transform coding, the lifting transform coding, and the RAHT transform coding are the same as those described with reference to FIGS. 1 to 9, and thus a detailed description thereof is omitted.

The arithmetic coder 12011 according to the embodiments may encode the coded attributes based on the arithmetic coding. The arithmetic coder 12011 performs an operation and/or method the same as or similar to the operation and/or method of the arithmetic encoder 40012.

The transmission processor 12012 according to the embodiments may transmit each bitstream containing encoded geometry and/or encoded attributes and metadata, or transmit one bitstream configured with the encoded geometry and/or the encoded attributes and the metadata. When the encoded geometry and/or the encoded attributes and the metadata according to the embodiments are configured into one bitstream, the bitstream may include one or more sub-bitstreams. The bitstream according to the embodiments may contain signaling information including a sequence parameter set (SPS) for signaling of a sequence level, a geometry parameter set (GPS) for signaling of geometry information coding, an attribute parameter set (APS) for signaling of attribute information coding, and a tile parameter set (TPS or tile inventory) for signaling of a tile level, and slice data. The slice data may include information about one or more slices. One slice according to embodiments may include one geometry bitstream Geom0⁰ and one or more attribute bitstreams Attr0⁰ and Attr1⁰. The TPS (or tile inventory) according to the embodiments may include information about each tile (e.g., coordinate information and height/size information about a bounding box) for one or more tiles. The geometry bitstream may contain a header and a payload. The header of the geometry bitstream according to the embodiments may contain a parameter set identifier (geom_parameter_set_id), a tile identifier (geom_tile_id) and a slice identifier (geom_slice_id) included in the GPS, and information about the data contained in the payload. As described above, the metadata processor 12007 according to the embodiments may generate and/or process the signaling information and transmit the same to the transmission processor 12012. According to embodiments, the elements to perform geometry encoding and the elements to perform attribute encoding may share data/information with each other as indicated by dotted lines. The transmission processor 12012 according to the embodiments may perform an operation and/or transmission method the same as or similar to the operation and/or transmission method of the transmitter 10003. Details are the same as those described with reference to FIGS. 1 and 2, and thus a description thereof is omitted.

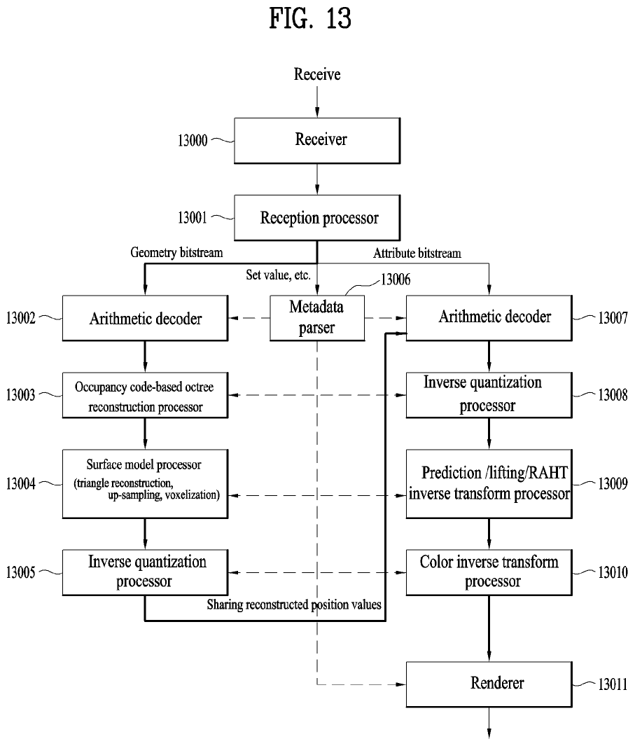

FIG. 13 illustrates a reception device according to embodiments.

The reception device illustrated in FIG. 13 is an example of the reception device 10004 of FIG. 1 (or the point cloud video decoder of FIGS. 10 and 11). The reception device illustrated in FIG. 13 may perform one or more of the operations and methods the same as or similar to those of the point cloud video decoder described with reference to FIGS. 1 to 11.

The reception device according to the embodiment may include a receiver 13000, a reception processor 13001, an arithmetic decoder 13002, an occupancy code-based octree reconstruction processor 13003, a surface model processor (triangle reconstruction, up-sampling, voxelization) 13004, an inverse quantization processor 13005, a metadata parser 13006, an arithmetic decoder 13007, an inverse quantization processor 13008, a prediction/lifting/RAHT inverse transform processor 13009, a color inverse transform processor 13010, and/or a renderer 13011. Each element for decoding according to the embodiments may perform a reverse process of the operation of a corresponding element for encoding according to the embodiments.

The receiver 13000 according to the embodiments receives point cloud data. The receiver 13000 may perform an operation and/or reception method the same as or similar to the operation and/or reception method of the receiver 10005 of FIG. 1. A detailed description thereof is omitted.

The reception processor 13001 according to the embodiments may acquire a geometry bitstream and/or an attribute bitstream from the received data. The reception processor 13001 may be included in the receiver 13000.

The arithmetic decoder 13002, the occupancy code-based octree reconstruction processor 13003, the surface model processor 13004, and the inverse quantization processor 1305 may perform geometry decoding. The geometry decoding according to embodiments is the same as or similar to the geometry decoding described with reference to FIGS. 1 to 10, and thus a detailed description thereof is omitted.

The arithmetic decoder 13002 according to the embodiments may decode the geometry bitstream based on arithmetic coding. The arithmetic decoder 13002 performs an operation and/or coding the same as or similar to the operation and/or coding of the arithmetic decoder 11000.

The occupancy code-based octree reconstruction processor 13003 according to the embodiments may reconstruct an octree by acquiring an occupancy code from the decoded geometry bitstream (or information about the geometry secured as a result of decoding). The occupancy code-based octree reconstruction processor 13003 performs an operation and/or method the same as or similar to the operation and/or octree generation method of the octree synthesizer 11001. When the trisoup geometry encoding is applied, the surface model processor 13004 according to the embodiments may perform trisoup geometry decoding and related geometry reconstruction (e.g., triangle reconstruction, up-sampling, voxelization) based on the surface model method. The surface model processor 13004 performs an operation the same as or similar to that of the surface approximation synthesizer 11002 and/or the geometry reconstructor 11003.

The inverse quantization processor 13005 according to the embodiments may inversely quantize the decoded geometry.

The metadata parser 13006 according to the embodiments may parse metadata contained in the received point cloud data, for example, a set value. The metadata parser 13006 may pass the metadata to geometry decoding and/or attribute decoding. The metadata is the same as that described with reference to FIG. 12, and thus a detailed description thereof is omitted.

The arithmetic decoder 13007, the inverse quantization processor 13008, the prediction/lifting/RAHT inverse transform processor 13009 and the color inverse transform processor 13010 perform attribute decoding. The attribute decoding is the same as or similar to the attribute decoding described with reference to FIGS. 1 to 10, and thus a detailed description thereof is omitted.

The arithmetic decoder 13007 according to the embodiments may decode the attribute bitstream by arithmetic coding. The arithmetic decoder 13007 may decode the attribute bitstream based on the reconstructed geometry. The arithmetic decoder 13007 performs an operation and/or coding the same as or similar to the operation and/or coding of the arithmetic decoder 11005.

The inverse quantization processor 13008 according to the embodiments may inversely quantize the decoded attribute bitstream. The inverse quantization processor 13008 performs an operation and/or method the same as or similar to the operation and/or inverse quantization method of the inverse quantizer 11006.

The prediction/lifting/RAHT inverse transform processor 13009 according to the embodiments may process the reconstructed geometry and the inversely quantized attributes. The prediction/lifting/RAHT inverse transform processor 13009 performs one or more of operations and/or decoding which are the same as or similar to the operations and/or decoding of the RAHT transformer 11007, the LOD generator 11008, and/or the inverse lifter 11009. The color inverse transform processor 13010 according to the embodiments performs inverse transform coding to inversely transform color values (or textures) included in the decoded attributes. The color inverse transform processor 13010 performs an operation and/or inverse transform coding the same as or similar to the operation and/or inverse transform coding of the color inverse transformer 11010. The renderer 13011 according to the embodiments may render the point cloud data.

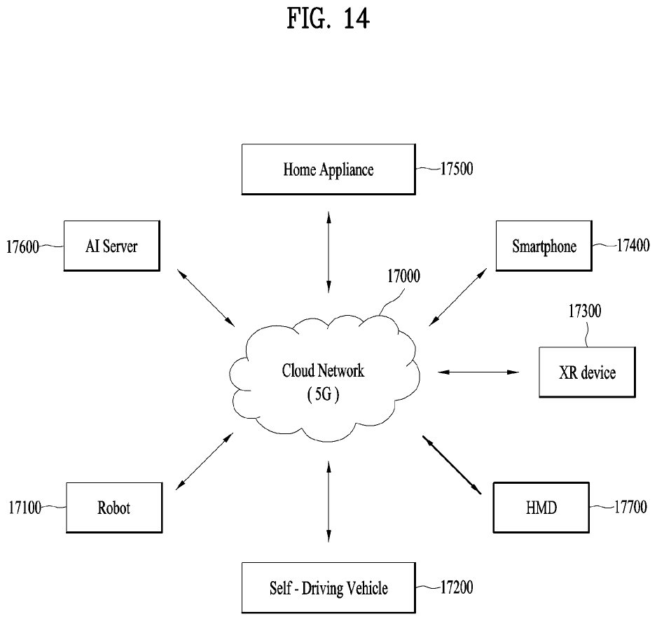

FIG. 14 shows an exemplary structure operatively connectable with a method/device for transmitting and receiving point cloud data according to embodiments.

The structure of FIG. 14 represents a configuration in which at least one of a server 17600, a robot 17100, a self-driving vehicle 17200, an XR device 17300, a smartphone 17400, a home appliance 17500, and/or a head-mount display (HMD) 17700 is connected to a cloud network 17000. The robot 17100, the self-driving vehicle 17200, the XR device 17300, the smartphone 17400, or the home appliance 17500 is referred to as a device. In addition, the XR device 17300 may correspond to a point cloud compressed data (PCC) device according to embodiments or may be operatively connected to the PCC device.

The cloud network 17000 may represent a network that constitutes part of the cloud computing infrastructure or is present in the cloud computing infrastructure. Here, the cloud network 17000 may be configured using a 3G network, 4G or Long Term Evolution (LTE) network, or a 5G network.

The server 17600 may be connected to at least one of the robot 17100, the self-driving vehicle 17200, the XR device 17300, the smartphone 17400, the home appliance 17500, and/or the HMD 17700 over the cloud network 17000 and may assist in at least a part of the processing of the connected devices 17100 to 17700.

The HMD 17700 represents one of the implementation types of the XR device and/or the PCC device according to the embodiments. The HMD type device according to the embodiments includes a communication unit, a control unit, a memory, an I/O unit, a sensor unit, and a power supply unit.

Hereinafter, various embodiments of the devices 17100 to 17500 to which the above-described technology is applied will be described. The devices 17100 to 17500 illustrated in FIG. 14 may be operatively connected/coupled to a point cloud data transmission device and reception according to the above-described embodiments.

<PCC+XR>

The XR/PCC device 17300 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 17300 may analyze 3D point cloud data or image data acquired through various sensors or from an external device and generate position data and attribute data about 3D points. Thereby, the XR/PCC device 17300 may acquire information about the surrounding space or a real object, and render and output an XR object. For example, the XR/PCC device 17300 may match an XR object including auxiliary information about a recognized object with the recognized object and output the matched XR object.

<PCC+Self-Driving+XR>

The self-driving vehicle 17200 may be implemented as a mobile robot, a vehicle, an unmanned aerial vehicle, or the like by applying the PCC technology and the XR technology.

The self-driving vehicle 17200 to which the XR/PCC technology is applied may represent a self-driving vehicle provided with means for providing an XR image, or a self-driving vehicle that is a target of control/interaction in the XR image. In particular, the self-driving vehicle 17200 which is a target of control/interaction in the XR image may be distinguished from the XR device 17300 and may be operatively connected thereto.

The self-driving vehicle 17200 having means for providing an XR/PCC image may acquire sensor information from sensors including a camera, and output the generated XR/PCC image based on the acquired sensor information. For example, the self-driving vehicle 17200 may have an HUD and output an XR/PCC image thereto, thereby providing an occupant with an XR/PCC object corresponding to a real object or an object present on the screen.

When the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap an object on the screen. For example, the self-driving vehicle 17200 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only CG images of real-world objects, backgrounds, and the like. On the other hand, the AR technology refers to a technology that shows a virtually created CG image on the image of a real object. The MR technology is similar to the AR technology described above in that virtual objects to be shown are mixed and combined with the real world. However, the MR technology differs from the AR technology in that the AR technology makes a clear distinction between a real object and a virtual object created as a CG image and uses virtual objects as complementary objects for real objects, whereas the MR technology treats virtual objects as objects having equivalent characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to any of the VR, AR, MR, and XR technologies. The encoding/decoding based on PCC, V-PCC, and G-PCC techniques is applicable to such technologies.

The PCC method/device according to the embodiments may be applied to a vehicle that provides a self-driving service.

A vehicle that provides the self-driving service is connected to a PCC device for wired/wireless communication.

When the point cloud compression data (PCC) transmission/reception device according to the embodiments is connected to a vehicle for wired/wireless communication, the device may receive/process content data related to an AR/VR/PCC service, which may be provided together with the self-driving service, and transmit the same to the vehicle. In the case where the PCC transmission/reception device is mounted on a vehicle, the PCC transmission/reception device may receive/process content data related to the AR/VR/PCC service according to a user input signal input through a user interface device and provide the same to the user. The vehicle or the user interface device according to the embodiments may receive a user input signal. The user input signal according to the embodiments may include a signal indicating the self-driving service.

As described above, once the transformation and quantization is performed on a residual three-dimensional block including a residual attribute value (also referred to as residual or residual attribute information) by the coefficient quantizer 40011 of FIG. 4 and/or the prediction/lifting/RAHT transform processor 12010 of FIG. 12, the quantized transformation coefficients are output to an arithmetic coder (e.g., the arithmetic coder 40012 of FIG. 4 and/or the arithmetic coder 12011 of FIG. 12) as a result.

Here, the residual attribute value is a value obtained by subtracting the predicted attribute (i.e., the predicted attribute value) of a point from the attribute (i.e., the original attribute value) of the point. The transformation may be of the following types: Discrete Cosine Transform (DCT), Discrete Sine Transform (DST), Shape Adaptive Discrete Cosine Transform (SADCT), RAHT, etc.

The quantized transformation coefficients are entropy-coded using zero run-length coding and an arithmetic coder.

According to embodiments, when the predictive transformation technique and the lifting transformation technique are used, the residual value (i.e., the residual attribute value) between the attribute value (i.e., the original attribute value) of a point and the predicted attribute value of the point predicted by the predictor may be transmitted to the receiver by applying entropy coding, for example, zero-run-length coding and arithmetic coding thereto.

According to embodiments, the quantized conversion coefficients are composed of coefficients equal to zero or a non-zero value. In the present disclosure, coefficients equal to a non-zero value are referred to as non-zero coefficients.

According to embodiments, the zero run-length coding may count the number of zeros between non-zeros. The count value may be inserted in place of the zeros between non-zero coefficients. According to embodiments, the count value representing the number of consecutive zeros between non-zero coefficients is referred to as a zero run, and the value of the non-zero coefficient is referred to as a level.

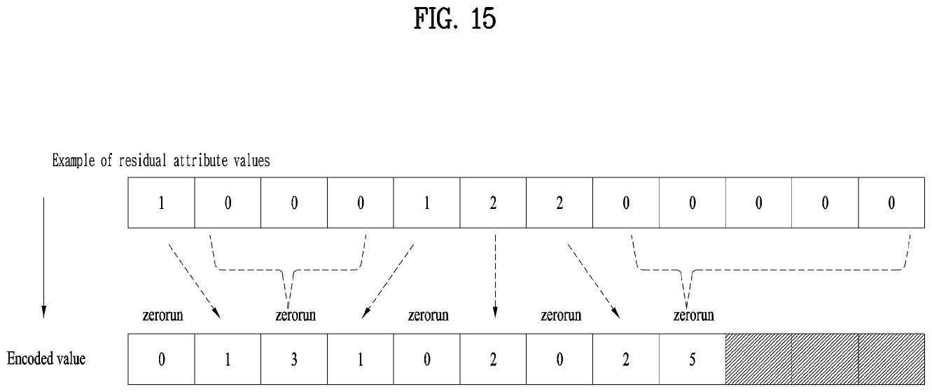

FIG. 15 is a diagram illustrating an example of zero run-length coding according to embodiments. According to embodiments, the number of zeros between non-zero coefficients in a bitstream consisting of quantized transformation coefficients corresponding to residual attribute values may be counted via zerorun. The count value may be 0 when there are no zeros between non-zero coefficients. As shown in FIG. 15, when a non-zero coefficient equal to 1 is followed by three consecutive zeros and then the next non-zero coefficient equal to 1, 3 counted through the zerorun is placed between the non-zero coefficient equal to 1 and the next non-zero coefficient equal to 1, that is, in place of the three zeros. Since there are no zeros between the non-zero coefficient equal to 1 and the next non-zero coefficient equal to 2, a count value of 0 is placed between the non-zero coefficient equal to 1 and the non-zero coefficient equal to 2. When this process is applied in FIG. 15, the bitstream consisting of quantized transformation coefficients is composed of one or more runs (i.e., count values) and one or more levels (i.e., values of non-zero coefficients), and the size of the bitstream is reduced from ‘100012200000’ to ‘13102025’.

That is, by encoding the residual attribute values using zero-run-length coding, the size of the bitstream containing the residual attribute values (i.e., the quantized transformation coefficients) may be reduced. Furthermore, since the attribute bitstream is reduced in size with no change in the peak signal-to-noise ratio (PSNR), attribute compression efficiency may increase.

In another embodiment, zero run-length coding may also be applied to prediction mode information including a prediction mode of points. According to embodiments, quantization is not applied to the prediction mode of the points.

According to embodiments, the arithmetic coder performs entropy coding (zero-run-length coding and arithmetic coding) on a slice-by-slice basis.

An arithmetic coding technique is a lossless compression technique that does not allocate bits of the same length for one or more runs and one or more levels to be encoded, but instead allocates bits of variable length based on their probability of occurrence. For example, shorter bits may be allocated for levels with a higher probability of occurrence and longer bits to levels with a lower probability of occurrence to reduce the average amount of information that needs to be sent as an output.

However, the above-mentioned entropy coding method has a low compression efficiency because the number of zeros (i.e., count value) is transmitted to the receiving side.

The present disclosure proposes a method for changing the coding unit of entropy coding to increase the compression efficiency of zero run-length coding.

In particular, by changing the coding unit of entropy, the zero count number of zerorun repeatedly signaled by the zero run-length coding may be reduced, which may increase the compression efficiency. In other words, by reducing unnecessary zero bits in the zero run-length coding by changing the coding unit of entropy coding, the present disclosure may increase the compression efficiency.

In addition, for attributes with multiple channels, the probability of matching the attribute channel value with the previous point may be increased by separating the attribute channel (or channel) and applying zero run-length coding. Thereby, compression efficiency may be increased.

In the present disclosure, an attribute refers to a color, reflectance, normal vectors, transparency, or the like of a point.

In addition, a color may have three channels (or components or dimensions). For example, when a color is composed of RGB, attribute channel X may be R, G, or B. Alternatively, it may be referred to as the R channel, G channel, or B channel.

For example, when a color is composed of YCbCr, attribute channel X may be Y, Cb, or Cr. In this case, it is referred to as the Y channel, the Cb channel, or the Cr channel. As another example, channel X may be Y or CbCr. In this case, it is referred to as the Y channel (or luminance component channel) and the CbCr channel (or color component channel). Here, Y is a brightness component and CbCr is a chrominance component.

For example, when a color is composed of YCoCg, attribute channel X may be Y, Co, or Cg. In this case, it is referred to as the R channel, Co channel, or Cg channel. As another example, attribute channel X may be Y or CoCg. In this case, it is referred to as the Y channel (or luminance component channel) or the CoCg channel (or color component channel). Here, Y is the brightness component and CoCg is the chrominance component.

The colors described above are embodiments for the understanding of those skilled in the art, and may be equally applicable to other colors not disclosed above.

In another example, each of the color, reflectance, normals, transparency, or the like constituting an attribute may be a channel.

According to embodiments, the point cloud data transmission method/device may determine the entropy coding unit of the attribute information as a tree structure-based entropy coding unit, a Morton code-based entropy coding unit, or a level of detail (LOD)-based entropy coding unit.

According to embodiments, the point cloud data transmission method/device may perform entropy coding (e.g., zero run-length coding and arithmetic coding) of the attribute information in a determined entropy coding unit. In one embodiment, the attribute information includes residual attribute information. In another example, the attribute information may include a prediction mode.

According to embodiments, the attribute information entropy encoder of the point cloud data transmission method/device may perform entropy encoding upon receiving the transformed quantized residual attribute information as input. In this case, the attribute information entropy encoder may determine an entropy coding unit for coding the attribute information based on the reconstructed geometry information. That is, by performing entropy coding by dividing the attribute bitstream in a slice into units having similar attributes (i.e., entropy coding units) based on the geometry information, the number of zeros (zerorun) repeatedly signaled due to zero run-length coding may be reduced, thereby increasing the compression efficiency.

According to embodiments, the entropy coding unit determined based on the reconstructed geometry information may be a tree structure-based entropy coding unit, a Morton code-based entropy coding unit, or a LOD-based entropy coding unit.

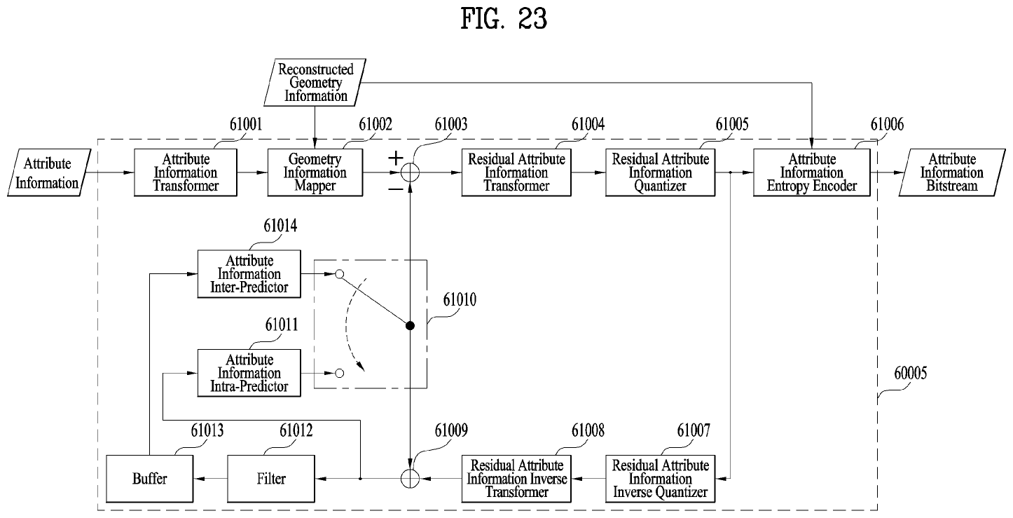

The attribute information entropy encoder (also referred to as an encoder) may be the arithmetic coder 40012 of FIG. 4, the arithmetic coder 12011 of FIG. 12, or the attribute information entropy encoder 61006 of FIG. 23.

According to embodiments, the attribute information entropy decoder of the point cloud data reception method/device may determine an entropy coding unit for attribute decoding based on the reconstructed geometry information, and may entropy decode the input attribute information bitstream in the determined entropy coding unit to generate transformed quantized attribute information.

According to embodiments, the determined entropy coding unit may be a tree structure-based entropy coding unit, a Morton code-based entropy coding unit, or a LOD-based entropy coding unit.

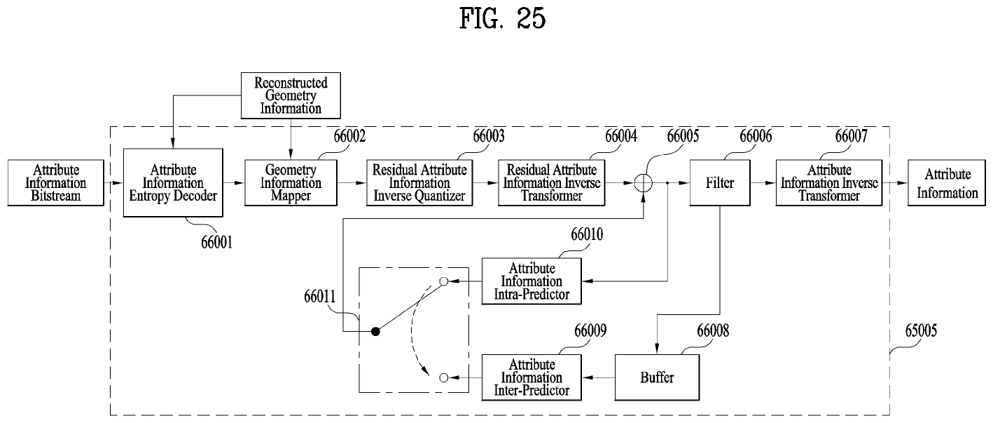

The attribute information entropy decoder (or referred to as a decoder) may be the arithmetic decoder 11005 of FIG. 11, the arithmetic decoder 13007 of FIG. 13, or the attribute information entropy decoder 66001 of FIG. 25.

Next, a process of determining an entropy coding unit based on the reconstructed geometry information will be described.

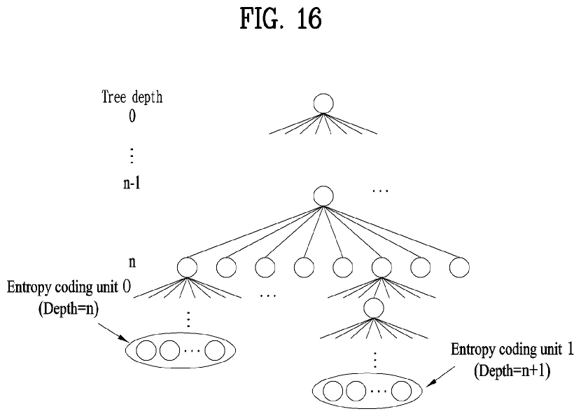

FIG. 16 is a diagram illustrating an example of determining an entropy coding unit based on a tree structure of reconstructed geometry information according to embodiments.

As shown in FIG. 16, the encoder may determine points in a region to be one entropy coding unit based on one specific depth in the tree in which the geometry information is partitioned, and may perform entropy coding on the attribute information in the determined entropy coding units. Accordingly, the attribute bitstream in the slice may be divided into units with similar attributes (i.e., entropy coding units), thereby reducing the count number of zeros (zerorun) repeatedly signaled due to zero run-length coding, which may increase compression efficiency.

In this case, all entropy coding units may be determined at the same depth. Alternatively, partitioning information may be signaled by the encoder of the point cloud data transmission device based on depth n, and may be parsed by the decoder of the point cloud data reception device to determine the entropy coding unit.

According to embodiments, the signaling of the partitioning information by the encoder may be omitted in the case where the entropy coding unit is the same as the prediction and transformation unit. In this case, the decoder may implicitly derive the entropy coding unit (i.e., the partitioning information) from the partitioning information about the prediction and transformation unit.

According to embodiments, a tree structure for partitioning the geometry information may be a binary tree, and/or a quadtree, and/or an octree

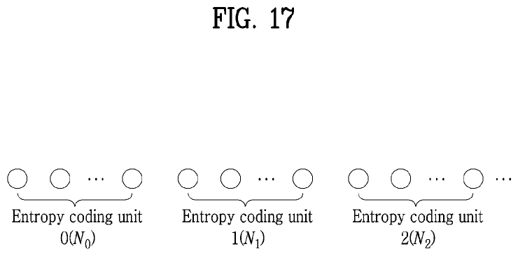

FIG. 17 is a diagram illustrating an example of determining an entropy coding unit based on Morton code of reconstructed geometry information according to embodiments.

As shown in FIG. 17, the encoder may determine an entropy coding unit based on the 3D Morton code calculated based on the reconstructed geometry information and perform entropy coding on the attribute information in the determined entropy coding unit.

Accordingly, the attribute bitstream in the slice may be divided into units with similar attributes (i.e., entropy coding units), thereby reducing the count number of zeros (zerorun) repeatedly signaled due to zero run-length coding, which may increase compression efficiency.

Determining the Molton code-based entropy coding unit according to the embodiments may be performed by the encoder of the point cloud data transmission device and/or the decoder of the point cloud data reception device.

In this case, the entropy coding unit may be determined by dividing the Morton code into N intervals of equal size (see FIG. 17). Alternatively, the entropy coding unit may be determined implicitly by the encoder and/or decoder based on the difference between the Molton codes. Alternatively, the size of each entropy coding unit may be signaled by the encoder and parsed by the decoder to determine the entropy coding unit.

According to embodiments, the Morton code is generated by representing the coordinate values (e.g., (x, y, z)) representing the three-dimensional positions of all points as bit values, and mixing the bits. For example, when the coordinate values representing the position of a point are (5, 9, 1), the bit values of the coordinate values are (0101, 1001, 0001). When the bit values are mixed to match the bit indexes in the order z, y, and x, the result is 010001000111. This value, when expressed in decimal, is 1095, which means that the Morton code value of the point with coordinates (5, 9, 1) is 1095.

According to embodiments, the signaling of the partitioning information by the encoder may be omitted in the case where the entropy coding unit is the same as the prediction and transformation unit. In this case, the decoder may implicitly derive the entropy coding unit (i.e., the partitioning information) from the partitioning information about the prediction and transformation unit.

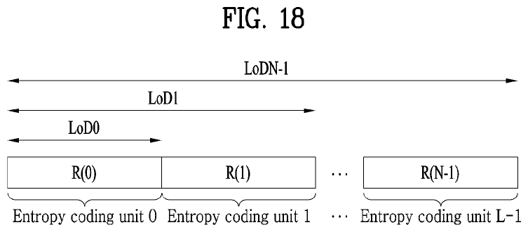

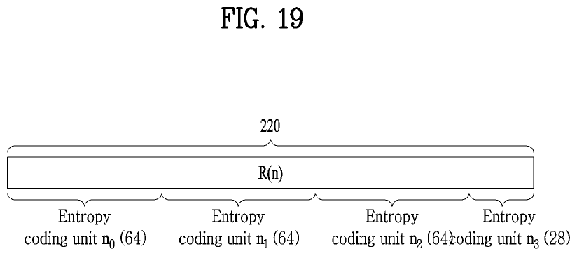

FIGS. 18 and 19 are diagrams illustrating examples of determining an entropy coding unit based on a LoD level generated based on reconstructed geometry information according to embodiments.

As shown in FIGS. 18 and 19, the encoder may determine an entropy coding unit based on the LoD level generated based on the reconstructed geometry information and perform entropy coding on attribute information in the determined entropy coding unit.

Accordingly, the attribute bitstream in the slice may be divided into units with similar attributes (i.e., entropy coding units), thereby reducing the count number of zeros (zerorun) repeatedly signaled due to zero run-length coding, which may increase compression efficiency.

According to embodiments, when a LOD the LOD may be defined to increase in a direction in which the detail increases, that is, in a direction in which the octree depth level increases. In the present disclosure, layer can be used interchangeably with level, depth, and depth level.

For example, in the case of a LoD-based PCC technique, a lower LoD is included in a higher LoD. That is, the higher LoD includes all points of the lower LoD. In addition, information on points included in the current LoD but not included in the previous LoD, that is, newly added points for each LoD may be defined as R (rest or retained).

For example, in FIG. 18, LoD1 contains LoD0 (i.e., R(0)) and information R1, and LoDN−1 contains LoD1 and information R(N−1), where R(N) denotes the set of points in LoD(N) excluding the points in LoD(N−1).

According to embodiments, the entropy coding unit may be determined based on the LoD level. According to embodiments, entropy encoding and decoding may be performed, taking R(N) as one entropy coding unit.

Referring to FIG. 18, R(0), (R1), and R(N) represent entropy coding units, respectively.

In another embodiment, R(N) may be divided into a plurality of equal intervals and each of the intervals may be determined as an entropy coding unit.

FIG. 19 illustrates an example in which R(N) is divided into a plurality of equal intervals and each interval is determined as an entropy coding unit according to embodiments

If n>m (n, m is an integer), the points in R(N) may be partitioned into equally spaced or unequally spaced regions, and the points in a partitioned region may be determined to be one entropy coding unit. The size of the entropy coding unit may be implicitly or explicitly determined according to n. Here, n and m represent R(n) and R(m), and R(n)=LoD(n)−LoD(n−1).

FIG. 19 shows an example in which the first to third entropy coding units n0 to n2 contain the same number of points (i.e., 64), and the last entropy coding unit n3 contains a different number of points (i.e., 28) than the first to third entropy coding units.

Once the entropy coding units are determined as in FIGS. 16 to 19, entropy coding is performed by the encoder of the transmission device in the entropy coding units, and entropy decoding is performed by the decoder of the reception device in the entropy coding units.

In this case, the entropy coding of the attribute information may be performed on a per-channel basis or on a multi-channel basis. That is, the attribute information may be separated into channels and the entropy coding may be performed on a per-channel basis.

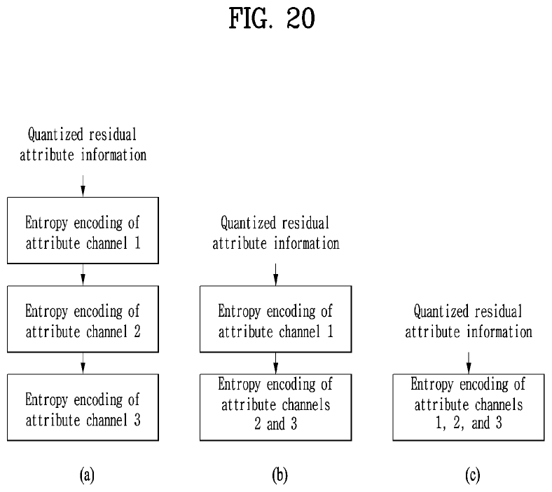

FIGS. 20-(a) to 20-(c) are diagrams illustrating examples of entropy coding of attribute information (e.g., quantized residual attribute information) according to embodiments.

In some embodiments, when the attribute is a color, the color consists of three channels. For example, when the color attribute is in the RGB color space, the color consists of an R channel, a G channel, and a B channel. When the color attribute is in the YCbCr color space, the color consists of a Y channel, a Cb channel, and a Cr channel. When the color attribute is in the YCoCg color space, the color consists of a Y channel, a Co channel, and a Cg channel. Here, Y is referred to as a brightness or luminance component, and CbCr or CoCg is referred to as a chrominance component. For simplicity, the R channel or Y channel is referred to as a first channel, the G channel, Cb channel, or Co channel is referred to as a second channel, and the B channel, Cr channel, or Co channel is referred to as a third channel.

FIG. 20-(a) illustrates an example in which color attribute information such as (R, G, B) or (Y, Cb, Cr) or (Y, Co, Cg) is sequentially entropy coded for each point by the encoder for each channel per entropy coding unit. For example, when the color attribute is in the YCbCr color space, the attribute of the Y channel (i.e., luminance component), the attribute of the Cb channel (i.e., chrominance component), and the attribute of the Cr channel (i.e., chrominance component) are sequentially entropy coded per entropy coding unit. In this case, the decoder also entropy decodes the color attribute information such as (R, G, B) or (Y, Cb, Cr) or (Y, Co, Cg) sequentially for each channel per entropy coding unit.

FIG. 20-(b) illustrates an example in which color attribute information such as (R, G, B) or (Y, Cb, Cr) or (Y, Co, Cg) is sequentially entropy coded for each point for every one or more channels per entropy coding unit by the encoder. For example, when the color attribute is in the YCbCr color space, the entropy coding of the attributes of the Y channel (i.e., the luminance component) is performed in entropy coding units, followed by the entropy coding of the attribute of the CbCr channel (i.e., the chrominance component). In this case, the decoder also performs entropy decoding on the attribute of the Y channel (i.e., luminance component) in entropy coding units, and then performs entropy decoding on the attribute of the CbCr channel (i.e., chrominance component).

FIG. 20-(c) illustrates an example in which all channels of color attribute information such as (R, G, B) or (Y, Cb, Cr) or (Y, Co, Cg) are entropy coded by the encoder at once per entropy coding unit for each point. For example, when the color attribute is in the YCbCr color space, the entropy coding of the attributes of the YCbCr channels (i.e., the luminance component and the chrominance component) is performed in entropy encoding units. In this case, entropy decoding of the attributes of the YCbCr channels (i.e., luminance and chrominance components) is also performed by the decoder in entropy coding units. That is, the attribute information of all channels may be entropy encoded/decoded point by point.

According to embodiments, in the present disclosure, for entropy encoding of residual attribute information, one or more of FIGS. 16 to 19 may be combined to determine an entropy coding unit, and a difference signal omit flag may be signaled in the entropy coding unit. In the case where the difference signal omit flag is not signaled in the entropy coding unit, entropy coding (e.g., zero run-length coding) may be performed by separating the residual attribute information by channel as shown in FIG. 20-(a) or FIG. 20-(b).

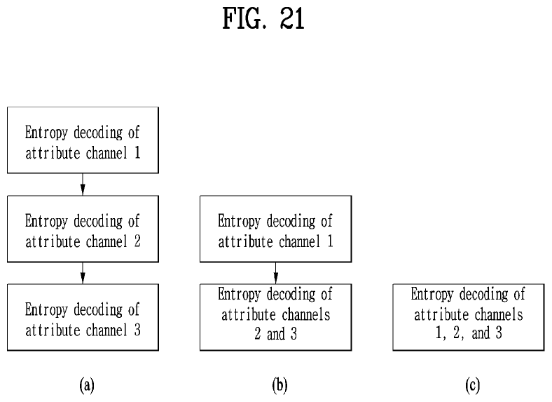

FIGS. 21-(a) to 21-(c) are diagrams illustrating examples of entropy decoding of attribute information (e.g., received attribute bitstream) to output quantized residual attribute information according to embodiments. In this case, the entropy coding unit may be determined based on the reconstructed geometry information for entropy decoding. The determination of the entropy coding unit may be omitted.

FIG. 21-(a) illustrates an example in which color attribute information such as (R, G, B) or (Y, Cb, Cr) or (Y, Co, Cg) is sequentially entropy decoded for each point by the decoder for each channel per entropy coding unit. For example, when the color attribute is in the YCbCr color space, the attribute of the Y channel (i.e., luminance component), the attribute of the Cb channel (i.e., chrominance component), and the attribute of the Cr channel (i.e., chrominance component) are sequentially entropy decoded per entropy coding unit. In the case of FIG. 21-(a), the difference signal omit flag (e.g., ash_attr_sign_omit_flag) is parsed for each channel of attribute information per entropy coding unit to determine whether to entropy-decode the difference signal (e.g., residual attribute information).

FIG. 21-(b) illustrates an example in which color attribute information such as (R, G, B) or (Y, Cb, Cr) or (Y, Co, Cg) is sequentially entropy decoded for each point for every one or more channels per entropy coding unit by the decoder. For example, when the color attribute is in the YCbCr color space, the entropy decoding of the attributes of the Y channel (i.e., the luminance component) is performed in entropy coding units, followed by the entropy decoding of the attribute of the CbCr channel (i.e., chrominance component). In the case of FIG. 21-(b), the difference signal omit flag of the luminance component and the difference signal omit flag of the color difference component are parsed per entropy coding unit to determine whether to decode the difference signal entropy.

FIG. 21-(c) illustrates an example in which all channels of color attribute information such as (R, G, B) or (Y, Cb, Cr) or (Y, Co, Cg) are entropy decoded by the decoder at once per entropy coding unit for each point. For example, when the color attribute is in the YCbCr color space, the entropy decoding of the attributes of the YCbCr channels (i.e., the luminance component and the chrominance component) is performed in entropy encoding units. That is, the attribute information of all channels may be entropy decoded point by point. In the case of FIG. 21-(c), one difference signal omit flag is parsed per entropy coding unit to determine whether to entropy-decode the difference signal.

When entropy coding/decoding of attribute information is performed for each channel as shown in FIGS. 20-(a) and 21-(a), the signaling/parsing structure of the YCbCr format is given as follows.

(Y₀, Y₁, . . . , Y₍ₙ₋₁₎, Cb₀, Cb₁, . . . , Cb₍ₙ₋₁₎, Cr₀, Cr₁, . . . , Cr₍ₙ₋₁₎)

When entropy coding/decoding of attribute information is performed for every one or more channels as shown in FIGS. 20-(b) and 21(b), the signaling/parsing structure of the YCbCr format is given as follows.

(Y₀, Y₁, . . . , Y₍ₙ₋₁₎, Cb₀, Cr₀, Cb₁, Cr₁, . . . , Cb₍ₙ₋₁₎, Cr₍ₙ₋₁₎)

When entropy coding/decoding is performed on attribute information of all channels as shown in FIGS. 20-(c) and 21-(c), the signaling/parsing structure of the YCbCr format is given as follows.

(Y₀, Cb₀, Cr₀, Y₁, Cb₁, Cr₁, . . . , Y₍ₙ₋₁₎, Cb₍ₙ₋₁₎, Cr₍ₙ₋₁₎)

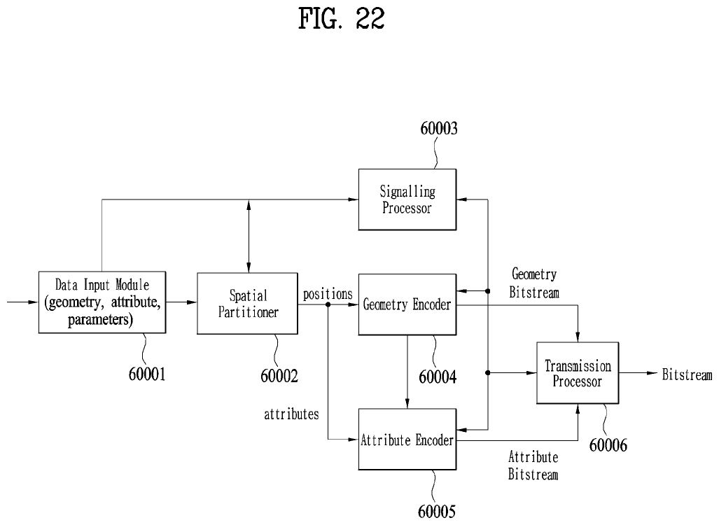

FIG. 22 is a diagram illustrating another example of a point cloud transmission device according to embodiments.

A point cloud transmission device according to the embodiments may include a data input module 60001, a spatial partitioner 60002, a signaling processor 60003, a geometry encoder 60004, an attribute encoder 60005, and a transmission processor 60006. In some embodiments, the spatial partitioner 60002, geometry encoder 60004, and attribute encoder 60005 may be referred to as a point cloud video encoder.

The data input module 60001 may perform some or all of the operations of the point cloud video acquisition unit 10001 of FIG. 1, or may perform some or all of the operations of the data input unit 12000 of FIG. 12.

Point cloud data input to the data input module 60001 may include geometry information and/or attribute information about each point.

The geometry information may be a coordinate vector of (x, y) in a 2-dimensional Cartesian coordinate system, (γ, θ) in a cylindrical coordinate system, (x, y, z) in a 3-dimensional Cartesian coordinate system, (γ, θ, z) in a cylindrical coordinate system, or (γ, θ, ϕ) in a spherical coordinate system.

The attribute information may be texture information, color (RGB or YCbCr or YCoCg), reflectance (r), transparency, or the like for each point. A point may have one or more attributes. In other words, the attribute information may be a vector of values acquired from one or more sensors, such as a vector representing the color of a point, and/or a brightness value, and/or a reflection coefficient of LiDAR, and/or a temperature obtained from a thermal imaging camera. The spatial partitioner 60002 may spatially partition the point cloud data input through the data input module 60001 into one or more 3D blocks based on a bounding box and/or a sub-bounding box. In this case, the 3D block may represent a tile group, a tile, a slice, a coding unit (CU), a prediction unit (PU), or a transformation unit (TU). The partitioning may be performed based on at least one of an octree, a quadtree, a binary tree, a triple tree, or a k-d tree. Alternatively, the data may be partitioned into blocks of predetermined width and height. Alternatively, the partitioning may be performed by selectively determining various positions and sizes of blocks. That is, input point cloud data may be partitioned into voxel groups such as slices, tiles, bricks, or subframes. In addition, the input point cloud data may be equally or unequally partitioned by one or more axes in a Cartesian coordinate system (x, y, z), a cylindrical coordinate system (γ, θ, z), or a spherical coordinate system (γ, θ, ϕ). In addition, signaling information for the partitioning is entropy-encoded by the signaling processor 60003 and then transmitted in the form of a bitstream via the transmission processor 60006.

In one embodiment, the point cloud content may be one person such as an actor, or several people, one object or several objects. On a larger scale, it may be a map for self-driving or a map for indoor navigation of a robot. In such cases, the point cloud content may be a vast amount of locally linked data. In this case, the point cloud content cannot be encoded/decoded all at once, and therefore tile partitioning may be performed before compressing the point cloud content. For example, in a building, room #101 may be partitioned into one tile and room #102 may be partitioned into another tile. In order to support fast encoding/decoding by applying parallelization to the partitioned tiles, the tiles may be partitioned into slices again. This operation may be referred to as slice partitioning (or splitting).

That is, a tile may represent a partial region (e.g., a rectangular cuboid) of a 3D space occupied by point cloud data according to embodiments. According to embodiments, a tile may include one or more slices. The tile may be partitioned into one or more slices, and thus the point cloud video encoder may encode point cloud data in parallel.

A slice may represent a unit of data (or bitstream) that may be independently encoded by the point cloud video encoder according to the embodiments and/or a unit of data (or bitstream) that may be independently decoded by the point cloud video decoder. A slice may be a set of data in a 3D space occupied by point cloud data, or a set of some data among the point cloud data. A slice may represent a region or set of points included in a tile according to embodiments. According to embodiments, a tile may be partitioned into one or more slices based on the number of points included in the tile. For example, one tile may be a set of points partitioned by the number of points. According to embodiments, a tile may be partitioned into one or more slices based on the number of points, and some data may be split or merged in the partitioning process. That is, a slice may be a unit that may be independently coded in a corresponding tile. A tile obtained by spatial partitioning as described above may be partitioned into one or more slices for fast and efficient processing.

Positions of one or more 3D blocks (e.g., slices) spatially partitioned by the spatial partitioner 60002 are output to a geometry encoder 60004, and attribute information (or referred to as attributes) is output to the attribute encoder 60005. The positions may be position information about points included in a partitioned unit (a box, block, coding unit, prediction unit, transformation unit, tile, tile group, or slice), and is referred to as geometry information.

The geometry encoder 60004 may perform some or all of the operations of the point cloud video encoder 10002 of FIG. 1, the encoding 20001 of FIG. 2, the point cloud video encoder of FIG. 4, and the point cloud video encoder of FIG. 12.

The geometry encoder 60004 compresses the positions (i.e., geometry information) output from the spatial partitioner 60002 by intra-prediction or inter-prediction, performs entropy coding, and outputs a geometry bitstream. According to embodiments, THE encoding by the geometry encoder 60004 may be performed on the entire point cloud or in sub-point cloud units or coding units (CUs), and inter-prediction (i.e., inter-frame prediction) or intra-prediction (i.e., intra-frame prediction) may be selected for each CU. Also, an inter-prediction mode or an intra-prediction mode may be selected for each prediction unit. The geometry bitstream generated by the geometry encoder 60004 may be transmitted to the reception device via the transmission processor 60006. Also, the geometry information compressed by inter-prediction or intra-prediction is reconstructed for attribute compression. The reconstructed geometry information (or referred to as restored geometry information) is output to the attribute encoder 60005.

The attribute encoder 60005 compresses the attribute information output from the spatial partitioner 60002 using intra-prediction or inter-prediction based on the reconstructed geometry information, and performs entropy coding to output an attribute bitstream. The attribute bitstream generated by the attribute encoder 60005 may be transmitted to the reception device via the transmission processor 60006.

According to embodiments, the attribute encoder 6005 may determine an entropy coding unit based on a tree structure, a Morton code, or a LOD, and perform entropy coding (e.g., zero run-length coding and arithmetic coding) on attribute information (e.g., residual attribute information). For attributes with multiple channels, channels may be separated to perform entropy coding (e.g., zero run-length coding and arithmetic coding).

The transmission processor 60006 may perform an operation and/or transmission method identical or similar to the operation and/or transmission method of the transmission processor 12012 of FIG. 12, and perform an operation and/or transmission method identical or similar to the operation and/or transmission method of the transmitter 10003 of FIG. 1. For details, refer to the description of FIG. 1 or 12.

The transmission processor 60006 may transmit the geometry bitstream output from the geometry encoder 60004, the attribute bitstream output from the attribute encoder 60005, and the signaling bitstream output from the signaling processor 60003, respectively, or may transmit one bitstream into which the bitstreams are multiplexed.

The transmission processor 60006 may encapsulate the bitstream into a file or segment (e.g., a streaming segment) and then transmit the encapsulated bitstream over various networks such as a broadcasting network and/or a broadband network.

The signaling processor 60003 may generate and/or process signaling information and output the same to the transmission processor 60006 in the form of a bitstream. The signaling information generated and/or processed by the signaling processor 60003 may be provided to the geometry encoder 60004, the attribute encoder 60005, and/or the transmission processor 60006 for geometry encoding, attribute encoding, and transmission processing. Alternatively, the signaling processor 60003 may receive signaling information generated by the geometry encoder 60004, the attribute encoder 60005, and/or the transmission processor 60006.

In the present disclosure, the signaling information may be signaled and transmitted on a per parameter set (sequence parameter set (SPS), geometry parameter set (GPS), attribute parameter set (APS), tile parameter set (TPS), or the like) basis. Alternatively, it may be signaled and transmitted on the basis of a coding unit of each image, such as slice or tile. In the present disclosure, the signaling information may include metadata (e.g., set values) related to point cloud data, and may be provided to the geometry encoder 60004, the attribute encoder 60005, and/or the transmission processor 60006 for geometry encoding, attribute encoding, and transmission processing. Depending on the application, the signaling information may also be defined at the system side, such as a file format, dynamic adaptive streaming over HTTP (DASH), or MPEG media transport (MMT), or at the wired interface side, such as high definition multimedia interface (HDMI), Display Port, Video Electronics Standards Association (VESA), or CTA.

Although not shown in the figure, elements of the point cloud transmission device of FIG. 15 may be implemented as hardware including one or more processors or integrated circuits configured to communicate with one or more memories, software, firmware, or combinations thereof. The one or more processors may perform at least one of the operations and/or functions of the elements of the point cloud transmission device of FIG. 15 described above. Additionally, the one or more processors may operate or execute a set of software programs and/or instructions for execution of the operations and/or functions of the elements of the point cloud transmission device of FIG. 15. The one or more memories may include a high speed random access memory, or include a non-volatile memory (e.g., one or more magnetic disk storage devices, flash memory devices, or other non-volatile solid-state memory devices).

FIG. 23 is a detailed block diagram of an attribute encoder according to embodiments. The attribute encoder of FIG. 23 may include one or more processors and one or more memories electrically or communicatively coupled with the one or more processors for compression of attribute information. In addition, the one or more processors may be configured as one or more physically separated hardware processors, a combination of software/hardware, or a single hardware processor. The one or more processors may be electrically and communicatively coupled with each other. Also, the one or more memories may be configured as one or more physically separated memories or a single memory. The one or more memories may store one or more programs for compression of the attribute information.

The elements of the attribute encoder illustrated in FIG. 23 may be implemented as hardware, software, processors, and/or combinations thereof.

In FIG. 23, the attribute encoder 60005 may include an attribute information transformer 61001, a geometry information mapper 61002, a subtractor 61003, a residual attribute information transformer 61004, a residual attribute information quantizer 61005, an attribute information entropy encoder 61006, a residual attribute information inverse quantizer 61007, a residual attribute information inverse transformer 61008, an adder 61009, a switching part 61010, an attribute information intra-frame (i.e., intra) predictor 61011, a filter 61012, a buffer 61013, and an attribute information inter-frame (i.e., inter) predictor 61014. The buffer 61013 may be referred to as a memory or a reconstructed point cloud buffer.

The geometry information reconstructed by the above geometry encoder 60004 is output to the geometry information mapper 61002 and the attribute information entropy encoder 61006 of the attribute encoder 60005.

When the input attribute information represents a color space, the attribute information transformer 61001 may transform the color space of the attribute information. The attribute information whose color space is transformed or not transformed by the attribute information transformer 61001 is output to the geometry information mapper 61002.

The geometry information mapper 61002 maps the attribute information received from the attribute information transformer 61001 and the reconstructed geometry information received from the geometry encoder 60004 to reconstruct attribute information. According to embodiments, in the attribute information reconstruction, an attribute value may be derived based on the attribute information about one or more points according to the reconstructed geometry information. The reconstructed attribute information is output to the adder 61003.

The subtractor 61003 outputs a difference between the attribute information partitioned into the nodes and the intra-predicted or inter-predicted attribute information (which is referred to as residual attribute information) to the residual attribute information transformer 61004.

The residual attribute information transformer 61004 may or may not transform a residual 3D block including the received residual attribute information using a transform type such as discrete cosine transform (DCT), discrete sine transform (DST), shape adaptive discrete cosine transform (SADCT), or RAHT. The transform type applied by the residual attribute information transformer 61004 to transform the residual 3D block may be entropy-encoded by the attribute information entropy encoder 61006 and then transmitted to the reception device via the transmission processor 60006.

The residual attribute information quantizer 61005 may quantize the transformed or untransformed residual attribute information with a quantization value (or referred to as a quantization parameter), and output the quantized residual attribute information to the attribute information entropy encoder 61006 and the residual attribute information inverse quantizer 61007.

The attribute information entropy encoder 61006 entropy-encodes the quantized residual attribute information (i.e., quantized transformation coefficients) using zero run-length coding and an arithmetic coder.

According to embodiments, the attribute information entropy encoder 61006 may determine an entropy coding unit based on the reconstructed geometry information as described with reference to FIGS. 15 to 21, and perform entropy coding (e.g., zero run-length coding and arithmetic coding) on the attribute information (e.g., residual attribute information) in the determined entropy coding unit. The entropy coding unit determined based on the geometry information may be a tree structure-based entropy coding unit, a Morton code-based entropy coding unit based on geometry information, or an LOD-based entropy coding unit. In this case, for an attribute having multiple channels, entropy coding (eg, zero run-length coding and arithmetic coding) may be performed by separating the channels. The above process of determining the entropy coding unit and separating the channels has been described in detail with reference to FIGS. 15 to 21, and thus a detailed description thereof is omitted.

The attribute information entropy encoder 61006 also performs entropy encoding on prediction information (also referred to as attribute prediction information or prediction mode information). The prediction information may be predicted attribute information output from the attribute information intra-predictor 61014 or the attribute information inter-predictor 61011, or may be prediction mode information corresponding to the predicted attribute information.

The attribute information entropy encoder 61006 may use various encoding methods such as, for example, exponential Golomb, context-adaptive variable length coding (CAVLC), and context-adaptive binary arithmetic coding (CABAC).

As a result of entropy encoding by the attribute information entropy encoder 61006, an attribute bitstream is generated. The attribute bitstream is transmitted to the reception device via the transmission processor 60006.

The residual attribute inverse quantizer 61007 performs inverse quantization based on whether the residual attribute information has been quantized by the residual attribute information quantizer 61005, and outputs the processed information to the residual attribute information inverse transformer 61008. For example, the residual attribute inverse quantizer 61007 may restore the residual attribute information by scaling the quantized residual attribute information by a quantization value (also referred to as a quantization parameter).

The residual attribute inverse transformer 61008 performs an inverse transform based on whether transformation has been performed by the residual attribute information inverse transformer 61004. For example, the residual attribute inverse transformer 61008 may inversely transform a residual 3D block including the restored residual attribute information using a transform type such as DCT, DST, SADCT, or RAHT. Residual attribute information that has been inversely transformed or not inversely transformed by the residual attribute inverse transformer 61008 is provided to the adder 61009.

The adder 61009 reconstructs attribute information by adding the residual attribute information and inter-predicted or intra-predicted attribute information. The reconstructed attribute information is output to the filter 61012 and the attribute information intra-predictor 61011.

The filter 61012 performs filtering on the reconstructed attribute information. The filter 61012 may include a deblocking filter, an offset corrector, and an adaptive loop filter (ALF) for filtering the reconstructed attribute information.

Attribute information calculated by the filter 61012 or attribute information prior to the filtering may be stored in the buffer 61013 so as to be used as reference information. The attribute information stored in the buffer 61013 is provided to the attribute information inter-predictor 61014 when prediction is performed.

The attribute information intra-frame (i.e., intra) predictor 61011 predicts attribute information based on the attribute information and/or geometry information about points in the same frame that has been previously reconstructed, and outputs the predicted attribute information to the subtractor 61003 and the adder 61009 via the switching part 61010. The prediction information used for the intra-frame (i.e., intra) prediction of the attribute information is entropy-encoded by the entropy encoder 61006.

The attribute information inter-frame (i.e., inter) predictor 61014 predicts current attribute information based on the attribute information and/or geometry information about points of another previously reconstructed frame stored in the buffer 61013, and outputs the predicted attribute information to the subtractor 61003 and the adder 61009 via the switching part 61010. The predicted information used for inter-frame (i.e., inter) prediction of the attribute information is entropy-encoded by the entropy encoder 61006.

The switching part 61010 may provide the attribute information intra-predicted by the attribute information intra-frame predictor 61011 or the attribute information inter-predicted by the attribute information inter-frame predictor 61014 to the subtractor 61003 and the adder 61009 according to a signal (e.g., provided by a controller (not shown)) indicating whether the prediction is inter-frame prediction or intra (i.e., intra-frame) prediction.

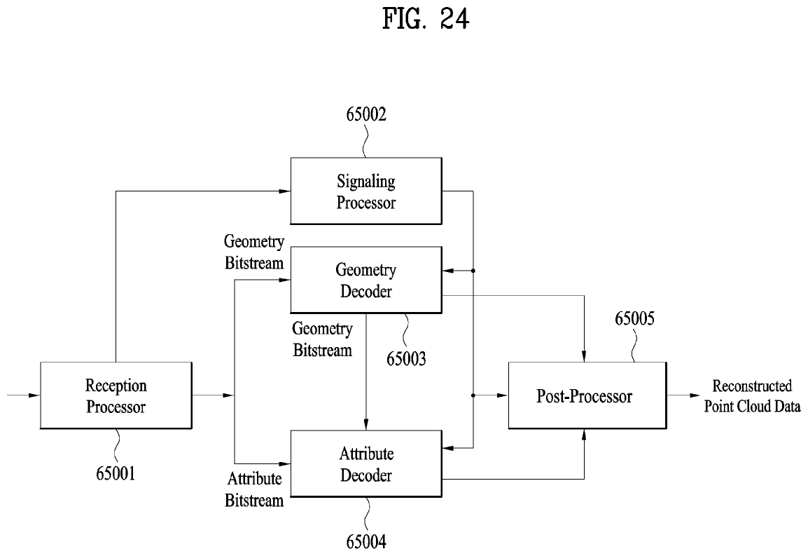

FIG. 24 is a diagram illustrating another example of a point cloud reception device according to embodiments. The elements of the point cloud reception device shown in FIG. 24 may be implemented as hardware, software, processors, and/or combinations thereof.

According to embodiments, the point cloud reception device may include a reception processor 65001, a signaling processor 65002, a geometry decoder 65003, an attribute decoder 65004, and a post-processor 65005. According to embodiments, the geometry decoder 65003 and the attribute decoder 65004 may be referred to as a point cloud video decoder. According to embodiments, the point cloud video decoder may be referred to as a PCC decoder, a PCC decoding unit, a point cloud decoder, a point cloud decoding unit, or the like.

According to embodiments, the point cloud video decoder may perform the reverse processes of the operations of the geometry encoder and attribute encoder of the transmission device based on signaling information for a compressed geometry bitstream and attribute bitstream to reconstruct geometry information and attribute information. The point cloud video decoder may perform some or all of the operations described in relation to the point cloud video decoder of FIG. 1, the decoding of FIG. 2, the point cloud video decoder of FIG. 11, and the point cloud video decoder of FIG. 13.

The reception processor 65001 may receive one bitstream or receive a geometry bitstream, an attribute bitstream, and a signaling bitstream, respectively. When a file and/or segment are received, the reception processor 65001 may decapsulate the received file and/or segment and output a bitstream for the same.

When one bitstream is received (or decapsulated), the reception processor 65001 may demultiplex a geometry bitstream, an attribute bitstream, and a signaling bitstream from the bitstream, and output the demultiplexed signaling bitstream to the signaling processor 65003, the demultiplexed geometry bitstream to the geometry decoder 65003, and the demultiplexed attribute bitstream to the attribute decoder 65004.

When a geometry bitstream, an attribute bitstream, and a signaling bitstream are received (or decapsulated), respectively, the reception processor 65001 may deliver the signaling bitstream to the signaling processor 65003, and the geometry bitstream and the attribute bitstream to the point cloud video decoder 65005.

The signaling processor 65002 may parse and process information included in the signaling information, for example, information included in the SPS, GPS, APS, TPS, or metadata, from the input signaling bitstream, and provide the same to the geometry decoder 65003, the attribute decoder 65004, and the post-processor 65005. In another embodiment, the signaling information included in the geometry slice header and/or the attribute slice header may also be parsed by the signaling processor 65002 before decoding of the corresponding slice data.

According to embodiments, the signaling processor 65002 may parse and process geometry-related prediction information, attribute-related prediction information, and entropy coding-related information signaled in at least one of the SPS, GPS, APS, TPS, geometry slice header, geometry slice data, attribute slice header, or attribute slice data, and provide the processed information to the geometry decoder 65003, the attribute decoder 65004, and the post-processor 65005.

The geometry-related prediction information, which is used for inter-prediction and/or intra-prediction of geometry information, and the attribute-related prediction information, which is used for inter-prediction and/or intra-prediction of the attribute information, may be collectively referred to as information related to point cloud data prediction. According to embodiments, information for determining an entropy coding unit, information for determining whether to perform entropy coding/decoding, and the like may be referred to as entropy coding-related information.

When the point cloud data is partitioned into tiles and/or slices at the transmitting side according to the embodiments, the TPS may include the number of slices included in each tile. Accordingly, the point cloud video decoder according to the embodiments may check the number of slices, and quickly parse information for parallel decoding.

Accordingly, the point cloud video decoder according to the present disclosure may receive an SPS having a reduced amount of data, and may thus quickly parse a bitstream containing point cloud data. Upon receiving tiles, the reception device may perform decoding slice by slice based on the GPS and APS included in each tile. Thereby, decoding efficiency may be maximized.

That is, the geometry decoder 65003 may reconstruct the compressed geometry information by performing a reverse process of the operations of the geometry encoder 60004 of FIG. 22 for the geometry bitstream based on the signaling information (e.g., geometry-related parameters including geometry-related prediction information, or information related to point cloud data prediction). According to embodiments, the geometry decoder 65003 may reconstruct the geometry information based on the signaling information during inter-prediction or intra-prediction. The geometry decoder 65003 may perform geometry decoding per sub-point cloud or encoding/decoding unit (CU), and may reconstruct geometry information by performing intra-frame prediction (i.e., intra-prediction) or inter-frame prediction (i.e., inter-prediction) for each encoding/decoding unit (CU) based on information (e.g., a flag) indicating whether the prediction is intra-prediction or inter-prediction.

The geometry information restored (or reconstructed) by the geometry decoder 65003 is provided to the attribute decoder 65004.

The attribute decoder 65004 may reconstruct the attribute information by performing the reverse process of the operations of the attribute encoder 60005 of FIG. 22 for the compressed attribute bitstream based on the signaling information (e.g., attribute-related parameters including attribute-related prediction information, or information related to point cloud data prediction, and/or entropy coding-related information) and the reconstructed geometry information. According to embodiments, the attribute decoder 65004 may reconstruct the attribute information based on the signaling information during inter-prediction or intra-prediction. The attribute decoder 65004 may perform attribute decoding on the entire point cloud or per sub-point cloud or encoding/decoding unit (CU), and reconstruct the attribute information by performing intra-frame prediction (i.e., intra-prediction) or inter-frame prediction (i.e., inter-prediction) for each encoding/decoding unit (CU) based on information (e.g., a flag) indicating whether the prediction is intra-prediction or inter-prediction. According to embodiments, the attribute decoder 65004 may be omitted.

According to embodiments, the attribute decoder 65004 may determine an entropy coding unit for attribute decoding based on the reconstructed geometry information and/or signaling information, and perform entropy (i.e, arithmetic decoding and zero run-length decoding) on decoding on the input attribute bitstream in the determined entropy coding unit. In this case, for attributes with multiple channels, the channels may be separated to perform entropy decoding (e.g., arithmetic decoding and zero run-length decoding).

According to embodiments, the determined entropy coding unit may be a tree structure-based entropy coding unit, a Morton code-based entropy coding unit, or a LOD-based entropy coding unit.

According to embodiments, once the point cloud data has been partitioned into tiles and/or slices on the transmitting side, the geometry decoder 65003 and attribute decoder 65004 may perform geometry decoding and attribute decoding on a per tile and/or slice basis.

The post-processor 65005 may match the geometry information (i.e., positions) reconstructed and output by the geometry decoder 65003 to the reconstructed attribute information (i.e., one or more reconstructed attributes) reconstructed and output by the attribute decoder 65004 to reconstruct and display/render the point cloud data.

According to embodiments, the reception device of FIG. 24 may further include a spatial reconstructor, which may be disposed before the geometry decoder 65003. For example, when the received point cloud data is configured in units of tiles and/or slices, a reverse process of spatial partitioning performed at the transmitting side may be performed based on signaling information. For example, when a bounding box is partitioned into tiles and slices, the bounding box may be reconstructed by combining the tiles and/or slices based on the signaling information. In another embodiment, the spatial reconstructor may spatially partition received point cloud data. For example, the received point cloud data may be partitioned according to parsed partition information such as a sub-point cloud, and/or an encoding/decoding unit (CU), a prediction unit (PU), or a transformation unit (TU) determined by the point cloud video encoder of the transmission device. The CU, the PU, and the TU may have the same partition structure or different partition structures according to embodiments.

FIG. 25 is a detailed block diagram illustrating another example of the attribute decoder 65004 according to embodiments.

According to embodiments, in the attribute decoding process in FIG. 25, some or all of the operations of the point cloud video decoder of FIG. 1, 2, 11, or 13 may be performed.

The attribute decoder of FIG. 25 may include one or more processors and one or more memories electrically and communicatively coupled with the one or more processors to decompress attribute information. Also, the one or more processors may be composed of one or more physically separated hardware processes, or may be composed of a software/hardware combination or a single hardware processor. The one or more processors according to the embodiments may be electrically and communicatively coupled with each other. Also, the one or more memories may be composed of one or more physically separate memories or a single memory. The one or more memories according to the embodiments may store one or more programs for decompression of the attribute information.

The elements of the attribute decoder illustrated in FIG. 25 may be implemented as hardware, software, processors, and/or combinations thereof. In FIG. 25, the attribute decoder 65004 may include an attribute information entropy decoder 66001, a geometry information mapper 66002, a residual attribute information inverse quantizer 66003, a residual attribute information inverse transformer 66004, an adder 66005, a filter 66006, an attribute information inverse transformer 66007, a buffer 66008, an attribute information inter-frame (i.e., inter) predictor 66009, an attribute information intra-frame (i.e., intra) predictor 66010, and a switching part 66011. The buffer 66008 may be referred to as a memory or a reconstructed point cloud buffer.

The geometry information reconstructed by the geometry encoder 65003 is provided to the attribute information entropy decoder 66001 and the geometry information mapper 66002.

The attribute information entropy decoder 66001 may perform entropy decoding (i.e., arithmetic decoding and zero run-length decoding) on the input attribute bitstream to output transformed and/or quantized residual attribute information.

According to embodiments, the attribute information entropy decoder 66001 may determine an entropy coding unit for attribute decoding based on the reconstructed geometry information and/or signaling information, and may perform entropy decoding (i.e., arithmetic decoding and zero run-length decoding) on the input attribute bitstream in the determined entropy coding unit. For attributes having multiple channels, the channels may be separated to perform entropy decoding (e.g., arithmetic decoding and zero run-length decoding).

According to embodiments, the determined entropy coding unit may be a tree structure-based entropy coding unit, a Morton code-based entropy coding unit, or an LOD-based entropy coding unit.

Also, for entropy decoding, various methods such as exponential Golomb, CAVLC, and CABAC may be applied.

According to embodiments, the attribute information entropy decoder 66001 may entropy-decode attribute-related prediction information (or information related to attribute information prediction) provided from the transmission device. Then, the transformed and/or quantized residual attribute information is output to the geometry information mapper 66002.

The geometry information mapper 66002 maps the transformed and/or quantized residual attribute information output from the attribute information entropy decoder 66001 and the reconstructed geometry information output from the geometry decoder 65003. The residual attribute information mapped to the geometry information may be output to the residual attribute information inverse quantizer 66004.

The residual attribute information inverse quantizer 66003 scales the input transformed and/or quantized residual attribute information with a quantization value (or quantization parameter). The scaled residual attribute information is output to the adder portion 66005 after being inversely transformed by the residual attribute information inverse transformer 66004. For example, the residual attribute information inverse transformer 66004 may inversely transform the residual three-dimensional block containing the input residual attribute information using a transform type such as DCT, DST, SADCT, or RAHT.

The adder 66005 reconstructs attribute information by adding the inversely quantized and/or inversely transformed residual attribute information to the predicted attribute information. The reconstructed attribute information is output to the attribute information intra-frame (i.e., intra) predictor 66010 and/or the filter 66006.

The predicted attribute information is attribute information intra-predicted by the attribute information intra-predictor 66010 or attribute information inter-predicted by the attribute information inter-predictor 66009.

The filter 66006 may filter the reconstructed attribute information using neighbor attribute information based on the reconstructed geometry information. The filter 66006 may include a deblocking filter, an offset corrector, and an ALF.

The attribute information filtered by the filter 66006 is output to the attribute information inverse transformer 66007 and the buffer 66008.

The attribute information inverse transformer 66007 may receive the type of the attribute information and transformation information in the attribute-related prediction information (or information related to point cloud data prediction) provided by the attribute information entropy decoder 66001 and perform the color space inverse transformation in the reverse process of the operation on the transmitting side.

According to embodiments, the attribute information inter-predictor 66009 and the attribute information intra-predictor 66010 may be collectively referred to as an attribute information predictor.

The attribute information inter-predictor 66009 and the attribute information inter-predictor 66010 included in the attribute information predictor may generate predicted attribute information based on the information related to generation of predicted attribute information in the attribute-related prediction information (or information related to point cloud data prediction) provided by the attribute information entropy decoder 66001, and attribute information about previously decoded points provided from the buffer 66008. That is, the attribute information inter-predictor 66009 and the attribute information inter-predictor 66010 may use attribute information or geometry information about points in the same frame or different frames stored in the buffer 66008 in predicting attribute information.

For example, the attribute information inter-predictor 66009 may use information necessary for inter-prediction of the current prediction unit in the attribute-related prediction information (or information related to point cloud data prediction) provided from the attribute information entropy decoder 66001 in inter-predicting the current prediction unit based on the information included in at least one of frames before or after the current frame including the current prediction unit.

As another example, the attribute information intra-predictor 66010 may generate predicted attribute information based on the reconstructed attribute information about a point in the current frame. According to embodiments, when a prediction unit is subjected to intra-prediction, intra-prediction is performed on the current prediction unit based on information (e.g., mode information) necessary for intra-prediction of the prediction unit in the attribute-related prediction information (or information related to the point cloud data prediction) provided from the attribute information entropy decoder 66001.

The attribute information intra-predicted by the attribute information intra-predictor 66010 or the attribute information inter-predicted by the attribute information inter-predictor 66009 is output to the adder 66005 via the switching part 66011.

The adder 66005 generates reconstructed attribute information by adding the intra-predicted or inter-predicted attribute information to the reconstructed residual attribute information output from the residual attribute inverse transformer 66004.

Although not shown in the figure, the elements of the attribute decoder of FIG. 25 may be implemented as hardware including one or more processors or integrated circuits configured to communicate with one or more memories, software, firmware, or combinations thereof. The one or more processors may perform at least one of the operations and/or functions of the elements of the attribute decoder of FIG. 25 described above. Additionally, the one or more processors may operate or execute a set of software programs and/or instructions for execution of the operations and/or functions of the elements of the attribute decoder of FIG. 25. The one or more memories may include a high speed random access memory, or include a non-volatile memory (e.g., one or more magnetic disk storage devices, flash memory devices, or other non-volatile solid-state memory devices).

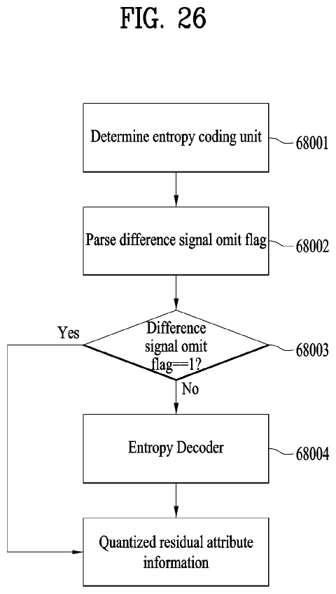

FIG. 26 is a flow diagram illustrating an example of an attribute information entropy decoding method according to embodiments, that is, an example in which the attribute information entropy decoder 66001 determines an entropy coding unit, and performs entropy decoding in the determined entropy coding unit.

Specifically, in operation 68001, an entropy coding unit is determined based on reconstructed geometry information. In some embodiments, operation 68001 may be omitted.

Once the entropy coding unit is determined in operation 68001, a difference signal omit flag (e.g., ash_attr_sign_omit_flag) is parsed in the determined entropy coding unit (68002). In one embodiment, the difference signal omit flag (e.g., ash_attr_sign_omit_flag) is signaled in an attribute slice header. The attribute slice header is used interchangeably with the attribute data unit header.

In operation 68001, it is checked whether the value of the parsed difference signal omit flag is 1 (68003). When the value of the difference signal omit flag is 1, the operation of entropy decoding (i.e., entropy decoding of the residual attribute information for the entropy coding unit) is omitted and the residual attribute information for the entropy coding unit is derived to be 0.

When the value of the omit difference signal flag is not 1 (i.e., 0), the attribute information entropy decoder 66001 performs entropy decoding (e.g., arithmetic decoding and zero run-length decoding) on the attribute bitstream in the entropy coding unit determined in operation 68001 (68004).

In other words, the reason for determining the entropy coding in entropy coding units used herein (see FIGS. 16 to 19) rather than in slices is to ensure that all possible residual attribute values are adjusted to 0. Therefore, after grouping together points that do not need to be transmitted, the residual attribute values are not sent (i.e., entropy coding is not performed), and only the remaining transmitted residual attribute values may be restored by entropy decoding in the entropy coding units.

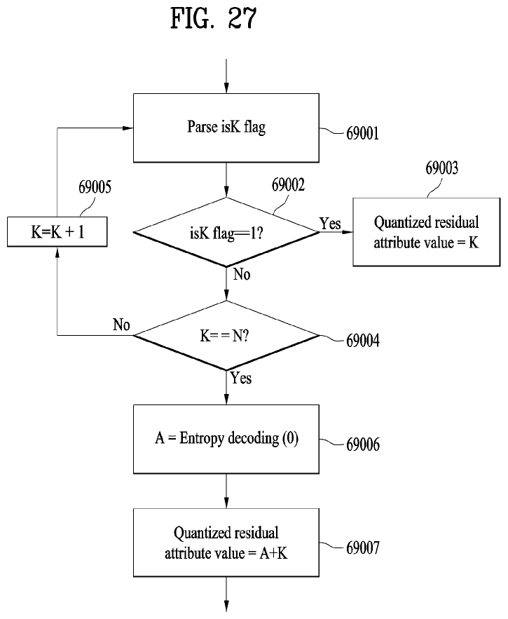

FIG. 27 is a flowchart illustrating an example of an entropy decoding process according to embodiments. That is, the figure illustrates the detailed operation of operation 68004 of performing entropy decoding when the value of the difference signal omit flag is not 1 (i.e., 0) in operation 68003 of FIG. 26.

First, an isK flag (e.g., isK_flag) is parsed from the signaling information (69001). In one embodiment, the isK flag (e.g., isK_flag) is signaled in attribute slice data. The attribute slice data is used interchangeably with the attribute data unit data.

Then, in operation 69001, it is checked (69002) whether the value of the parsed isK flag (e.g., isK_flag) is 1.

When the value of the isK flag is 1, the value of the quantized residual attribute is derived to be K (69003).

When the value of the isK flag is 0, a comparison is made to determine if the values of K and N are equal (69004). That is, since there may be N isK flags according to embodiments, K is compared with N. Here, N denotes the number of points in the entropy coding unit.

When the value of K is not equal to the value of N, i.e., the value of K is less than the value of N in operation 69004, then the process proceeds to operation 69005 to increment the value of K by 1, and then proceeds to operation 69001 of parsing the isK flag. This process is repeated until the value of K equals the value of N.

When it is determined in operation 69004 that K and N are equal, i.e., all isK flags are equal to 0, A from the attribute bitstream is entropy-decoded using entropy decoding(69006). Here, A is a residual attribute value to be entropy-coded. According to embodiments, the entropy decoding includes arithmetic decoding and zero run-length decoding. Then, K is added to the entropy-decoded value of A to derive the final quantized residual attribute value (69007). That is, depending on the value of the isK flag, the residual attribute value output to the transmission processor 60006 may be K or A+K.

According to embodiments, entropy decoding may use various decoding methods, such as exponential Golomb, CAVLC, CABAC, and truncated rice coding.

According to embodiments, entropy decoding may be performed by dividing the sign and absolute value of the residual attribute information, and the sign and absolute value may be decoded using different entropy decoding methods.

The difference signal omit flag (e.g., ash_attr_sign_omit_flag) and the isK flag are referred to herein as entropy coding related information.

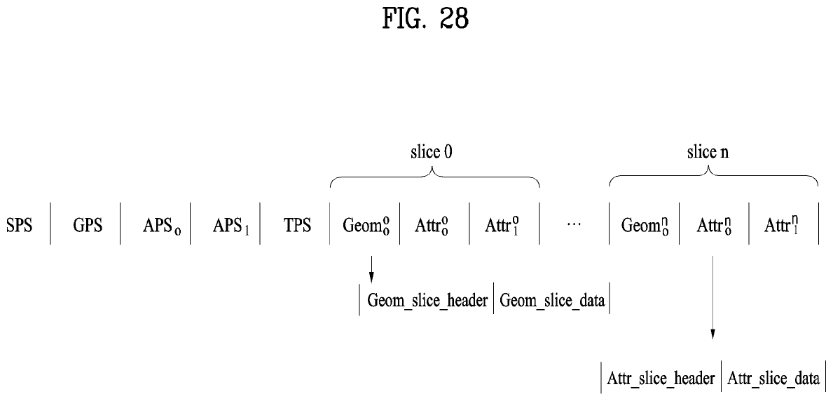

FIG. 28 illustrates an example of a bitstream structure of point cloud data for transmission/reception according to embodiments. According to embodiments, the bitstream output from the point cloud video encoder in one of FIGS. 1, 2, 4, 12, and 22 may be in the form shown in FIG. 28.

According to embodiments, the bitstream of point cloud data provides tiles or slices such that the point cloud data may be divided and processed region by region. Each region of the bitstream according to the embodiments may have different importance. Accordingly, when the point cloud data is divided into tiles, a different filter (encoding method) and a different filter unit may be applied to each tile. In addition, when the point cloud data is divided into slices, a different filter and a different filter unit may be applied to each slice.

When compressing point cloud data by partitioning the data into regions, the transmission device and the reception device according to the embodiments may transmit and receive the bitstream in a high-level syntax structure to selectively transmit attribute information in the partitioned regions.

The transmission device according to embodiments transmits the point cloud data according to the structure of the bitstream as illustrated in FIG. 28, such that different encoding operations may be applied according to importance and an encoding method with good quality may be used in an important region. In addition, efficient encoding and transmission according to the characteristics of the point cloud data may be supported and attribute values according to the demand of a user may be provided.

The reception device according to the embodiments receives the point cloud data according to the structure of the bitstream as illustrated in FIG. 28, such that a different filtering (decoding method) may be applied to each region (region divided into tiles or slices) according to the processing capability of the reception device, instead of using a complicated decoding (filtering) method for the entire point cloud data. Accordingly, better picture quality in a region important to the user may be provided and appropriate system latency may be ensured.

When a geometry bitstream, an attribute bitstream, and/or a signaling bitstream (or signaling information) according to the embodiments are composed of one bitstream (or G-PCC bitstream) as illustrated in FIG. 28, the bitstream may include one or more sub-bitstreams. The bitstream according to the embodiments includes an SPS for sequence level signaling, a GPS for signaling of geometry information coding, one or more APSs (APS₀ and APS₁) for signaling of attribute information coding, a tile inventory (also referred to as a TPS) for tile level signaling, and one or more slices (slice 0 to slice n). That is, the bitstream of the point cloud data according to the embodiments may include one or more tiles, and each tile may be a slice group including one or more slices (slice 0 to slice n). The tile inventory (i.e., TPS) according to the embodiments may include information about each tile of one or more tiles (e.g., coordinate value information and height/size information of a tile bounding box). Each slice may include one geometry bitstream Geom0 and/or one or more attribute bitstreams Attr0 and Attrn. For example, slice 0 may include one geometry bitstream Geom0⁰ and one or more attribute bitstreams Attr0⁰ and Attr1⁰.

The geometry bitstream within each slice may include a geometry slice header (geom_slice_header) and geometry slice data (geom_slice_data). According to embodiments, the geometry bitstream within each slice may be referred to as a geometry data unit, the geometry slice header may be referred to as a geometry data unit header, and the geometry slice data may be referred to as geometry data unit data.

Each attribute bitstream in each slice may include an attribute slice header (attr_slice_header) and attribute slice data (attr_slice_data). According to embodiments, the attribute slice header in each slice may be referred to as an attribute data unit, the attribute slice header may be referred to as an attribute data unit header, and the attribute slice data may be referred to as attribute data unit data.

According to embodiments, parameters required for encoding and/or decoding of the point cloud data may be newly defined in parameter sets of the point cloud data (e.g., an SPS, a GPS, an APS, and a TPS (also referred to as a tile inventory) and/or in a header of a corresponding slice. For example, when encoding and/or decoding of geometry information is performed, the parameters may be added to the GPS and, when tile-based encoding and/or decoding is performed, the parameters may be added to a tile (TPS) and/or a slice header.

According to embodiments, information related to entropy coding (or referred to as entropy coding-related information) may be signaled in at least one of a sequence parameter set, a geometry parameter set, an attribute parameter set, a tile parameter set, or an SEI message. Further, information related to entropy coding (or referred to as entropy coding-related information) may be signaled in at least one of an attribute slice header (or referred to as an attribute data unit header) or attribute slice data (or referred to as attribute data unit data).

According to embodiments, entropy coding-related information may be defined in a corresponding position or a separate position depending on an application or system such that the range and method to be applied may be used differently. A field, which is a term used in syntaxes that will be described later in the present disclosure, may have the same meaning as a parameter or a syntax element.

That is, a signal (e.g., entropy coding-related information) may have different meanings depending on the position where the signal is transmitted. If the signal is defined in the SPS, it may be equally applied to the entire sequence. If the signal is defined in the GPS, this may indicate that the signal is used for position reconstruction. If the signal is defined in the APS, this may indicate that the signal is applied to attribute reconstruction. If the signal is defined in the TPS, this may indicate that the signaling is applied to only points within a tile. If the signal is delivered in a slice, this may indicate that the signaling is applied only to the slice. In addition, when the fields (or referred to as syntax elements) are applicable to multiple point cloud data streams as well as the current point cloud data stream, they may be carried in a higher-level parameter set or the like.

According to embodiments, parameters (which may be referred to as metadata, signaling information, or the like) may be generated by the metadata processor (or metadata generator), signaling processor, or processor of the transmission device, and transmitted to the reception device so as to be used in the decoding/reconstruction process. For example, the parameters generated and transmitted by the transmission device may be acquired by the metadata parser of the reception device.

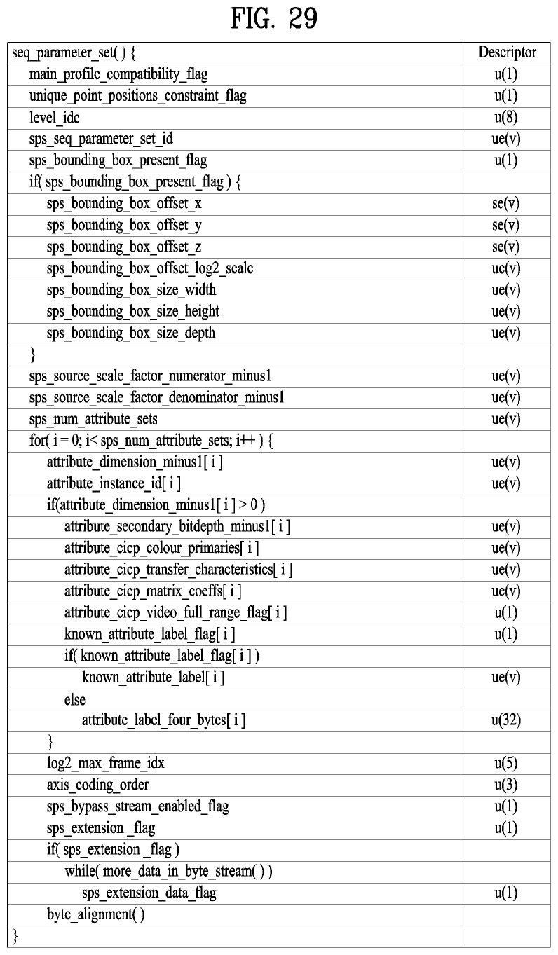

FIG. 29 shows an embodiment of a syntax structure of a sequence parameter set (SPS) (seq_parameter_set( )) according to the present disclosure. The SPS may contain sequence information about a point cloud data bitstream.

The SPS according to the embodiments may include a main_profile_compatibility_flag field, a unique_point_positions_constraint_flag field, a level_idc field, an sps_seq_parameter_set_id field, an sps_bounding_box_present_flag field, an sps_source_scale_factor_numerator_minus1 field, an sps_source_scale_factor_denominator_minus1 field, an sps_num_attribute_sets field, log2_max_frame_idx field, an axis_coding_order field, an sps_bypass_stream_enabled_flag field, and an sps_extension_flag field.

The main_profile_compatibility_flag field may indicate whether the bitstream conforms to the main profile. For example, main_profile_compatibility_flag equal to 1 may indicate that the bitstream conforms to the main profile. For example, main_profile_compatibility_flag equal to 0 may indicate that the bitstream conforms to a profile other than the main profile.

When unique_point_positions_constraint_flag is equal to 1, in each point cloud frame that is referred to by the current SPS, all output points may have unique positions. When unique_point_positions_constraint_flag is equal to 0, in any point cloud frame that is referred to by the current SPS, two or more output points may have the same position. For example, even when all points are unique in the respective slices, slices in a frame and other points may overlap. In this case, unique_point_positions_constraint_flag is set to 0.

level_idc indicates a level to which the bitstream conforms.

sps_seq_parameter_set_id provides an identifier for the SPS for reference by other syntax elements.

The sps_bounding_box_present_flag field indicates whether a bounding box is present in the SPS. For example, sps_bounding_box_present_flag equal to 1 indicates that the bounding box is present in the SPS, and sps_bounding_box_present_flag equal to 0 indicates that the size of the bounding box is undefined.

According to embodiments, when sps_bounding_box_present_flag is equal to 1, the SPS may further include an sps_bounding_box_offset_x field, an sps_bounding_box_offset_y field, an sps_bounding_box_offset_z field, an sps_bounding_box_offset_log2_scale field, an sps_bounding_box_size_width field, an sps_bounding_box_size_height field, and an sps_bounding_box_size_depth field.

sps_bounding_box_offset_x indicates the x offset of the source bounding box in Cartesian coordinates. When the x offset of the source bounding box is not present, the value of sps_bounding_box_offset_x is 0.

sps_bounding_box_offset_y indicates the y offset of the source bounding box in Cartesian coordinates. When the y offset of the source bounding box is not present, the value of sps_bounding_box_offset_y is 0.

sps_bounding_box_offset_z indicates the z offset of the source bounding box in Cartesian coordinates. When the z offset of the source bounding box is not present, the value of sps_bounding_box_offset_z is 0.

sps_bounding_box_offset_log2_scale indicates a scale factor for scaling quantized x, y, and z source bounding box offsets.

sps_bounding_box_size_width indicates the width of the source bounding box in Cartesian coordinates. When the width of the source bounding box is not present, the value of sps_bounding_box_size_width may be 1.

sps_bounding_box_size_height indicates the height of the source bounding box in Cartesian coordinates. When the height of the source bounding box is not present, the value of sps_bounding_box_size_height may be 1.

sps_bounding_box_size_depth indicates the depth of the source bounding box in Cartesian coordinates. When the depth of the source bounding box is not present, the value of sps_bounding_box_size_depth may be 1.

sps_source_scale_factor_numerator_minus1 plus 1 indicates the scale factor numerator of the source point cloud.

sps_source_scale_factor_denominator_minus1 plus 1 indicates the scale factor denominator of the source point cloud.

sps_num_attribute_sets indicates the number of coded attributes in the bitstream.

The SPS according to the embodiments includes an iteration statement repeated as many times as the value of the sps_num_attribute_sets field. In an embodiment, i is initialized to 0, and is incremented by 1 each time the iteration statement is executed. The iteration statement is repeated until the value of i becomes equal to the value of the sps_num_attribute_sets field. The iteration statement may include an attribute_dimension_minus1[i] field and an attribute_instance_id[i] field. attribute_dimension_minus1[i] plus 1 indicates the number of components of the i-th attribute.

The attribute_instance_id[i] field specifies the instance ID of the i-th attribute.

According to embodiments, when the value of the attribute_dimension_minus1[i] field is greater than 1, the iteration statement may further include an attribute_secondary_bitdepth_minus1[i] field, an attribute_cicp_colour_primaries[i] field, an attribute_cicp_transfer_characteristics[i] field, an attribute_cicp_matrix_coeffs[i] field, and an attribute_cicp_video_full_range_flag[i] field.

attribute_secondary_bitdepth_minus1 [i] plus 1 specifies the bitdepth for the secondary component of the i-th attribute signal(s).

attribute_cicp_colour_primaries[i] indicates the chromaticity coordinates of the color attribute source primaries of the i-th attribute.

attribute_cicp_transfer_characteristics[i] either indicates the reference opto-electronic transfer characteristic function of the color attribute as a function of a source input linear optical intensity with a nominal real-valued range of 0 to 1 or indicates the inverse of the reference electro-optical transfer characteristic function as a function of an output linear optical intensity

attribute_cicp_matrix_coeffs[i] describes the matrix coefficients used in deriving luma and chroma signals from the green, blue, and red, or Y, Z, and X primaries of the i-th attribute.

attribute_cicp_video_full_range_flag[i] specifies the black level and range of the luma and chroma signals as derived from E′Y, E′PB, and E′PR or E′R, E′G, and E′B real-valued component signals of the i-th attribute.

The known_attribute_label_flag[i] field indicates whether a know_attribute_label[i] field or an attribute_label_four_bytes[i] field is signaled for the i-th attribute. For example, when known_attribute_label_flag[i] equal to 0 indicates the known_attribute_label[i] field is signaled for the i-th attribute. known_attribute_label_flag[i] equal to 1 indicates that the attribute_label_four_bytes[i] field is signaled for the i-th attribute.

known_attribute_label[i] specifies the type of the i-th attribute. For example, known_attribute_label[i] equal to 0 may specify that the i-th attribute is color. known_attribute_label[i] equal to 1 may specify that the i-th attribute is reflectance. known_attribute_label[i] equal to 2 may specify that the i-th attribute is frame index. Also, known_attribute_label[i] equal to 4 specifies that the i-th attribute is transparency. known_attribute_label[i] equal to 5 specifies that the i-th attribute is normals.

attribute_label_four_bytes[i] indicates the known attribute type with a 4-byte code.

According to embodiments, attribute_label_four_bytes[i] equal to 0 may indicate that the i-th attribute is color. attribute_label_four_bytes[i] equal to 1 may indicate that the i-th attribute is reflectance. attribute_label_four_bytes[i] equal to 2 may indicate that the i-th attribute is a frame index. attribute_label_four_bytes[i] equal to 4 may indicate that the i-th attribute is transparency. attribute_label_four_bytes[i] equal to 5 may indicate that the i-th attribute is normals.

log2_max_frame_idx indicates the number of bits used to signal a syntax variable frame_idx.

axis_coding_order specifies the correspondence between the X, Y, and Z output axis labels and the three position components in the reconstructed point cloud RecPic [pointidx] [axis] with and axis=0 . . . 2.

sps_bypass_stream_enabled_flag equal to 1 specifies that the bypass coding mode may be used in reading the bitstream. As another example, sps_bypass_stream_enabled_flag equal to 0 specifies that the bypass coding mode is not used in reading the bitstream.

sps_extension_flag indicates whether the sps_extension_data syntax structure is present in the SPS syntax structure. For example, sps_extension_present_flag equal to 1 indicates that the sps_extension_data syntax structure is present in the SPS syntax structure. sps_extension_present_flag equal to 0 indicates that this syntax structure is not present.

When the value of the sps_extension_flag field is 1, the SPS according to the embodiments may further include an sps_extension_data_flag field.

sps_extension_data_flag may have any value.

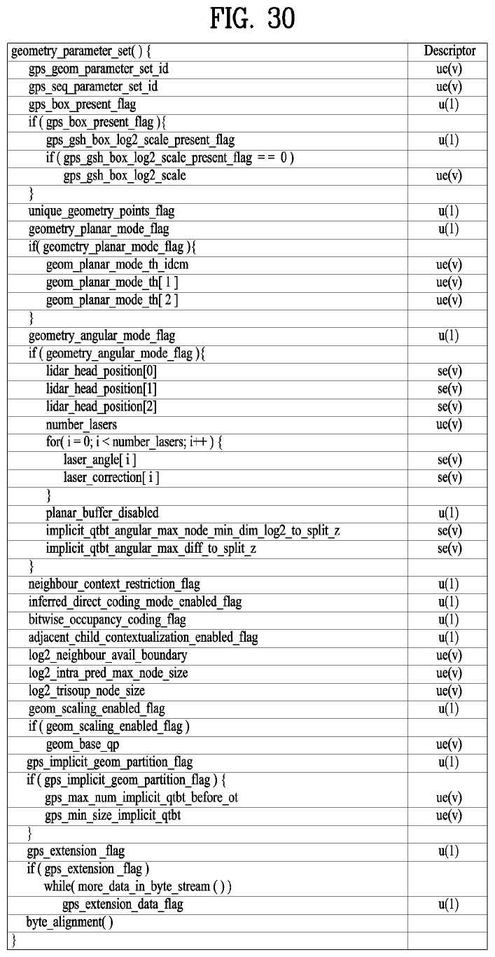

FIG. 30 shows an embodiment of a syntax structure of the GPS (geometry_parameter_set( )) according to the present disclosure. The GPS may include information on a method of encoding geometry information of point cloud data included in one or more slices.

According to embodiments, the GPS may include a gps_geom_parameter_set_id field, a gps_seq_parameter_set_id field, gps_box_present_flag field, a unique_geometry_points_flag field, a geometry_planar_mode_flag field, a geometry_angular_mode_flag field, a neighbour_context_restriction_flag field, a inferred_direct_coding_mode_enabled_flag field, a bitwise_occupancy_coding_flag field, an adjacent_child_contextualization_enabled_flag field, a log2_neighbour_avail_boundary field, a log2_intra_pred_max_node_size field, a log2_trisoup_node_size field, a geom_scaling_enabled_flag field, a gps_implicit_geom_partition_flag field, and a gps_extension_flag field.

The gps_geom_parameter_set_id field provides an identifier for the GPS for reference by other syntax elements.

The gps_seq_parameter_set_id field specifies the value of sps_seq_parameter_set_id for the active SPS.

The gps_box_present_flag field specifies whether additional bounding box information is provided in a geometry slice header that references the current GPS. For example, the gps_box_present_flag field equal to 1 may specify that additional bounding box information is provided in a geometry slice header that references the current GPS. Accordingly, when the gps_box_present_flag field is equal to 1, the GPS may further include a gps_gsh_box_log2_scale_present_flag field.

The gps_gsh_box_log2_scale_present_flag field specifies whether the gps_gsh_box_log2_scale field is signaled in each geometry slice header that references the current GPS. For example, the gps_gsh_box_log2_scale_present_flag field equal to 1 may specify that the gps_gsh_box_log2_scale field is signaled in each geometry slice header that references the current GPS. As another example, the gps_gsh_box_log2_scale_present_flag field equal to 0 may specify that the gps_gsh_box_log2_scale field is not signaled in each geometry slice header and a common scale for all slices is signaled in the gps_gsh_box_log2_scale field of the current GPS.

When the gps_gsh_box_log2_scale_present_flag field is equal to 0, the GPS may further include a gps-gsh-box-log2-scale field.

The gps_gsh_box_log2_scale field indicates the common scale factor of the bounding box origin for all slices that refer to the current GPS.

unique_geometry_points_flag indicates whether all output points have unique positions in one slice in all slices currently referring to GPS. For example, unique_geometry_points_flag equal to 1 indicates that in all slices that refer to the current GPS, all output points have unique positions within a slice. unique_geometry_points_flag field equal to 0 indicates that in all slices that refer to the current GPS, the two or more of the output points may have same positions within a slice.

The geometry_planar_mode_flag field indicates whether the planar coding mode is activated. For example, geometry_planar_mode_flag equal to 1 indicates that the planar coding mode is active. geometry_planar_mode_flag equal to 0 indicates that the planar coding mode is not active.

When the value of the geometry_planar_mode_flag field is 1, that is, TRUE, the GPS may further include a geom_planar_mode_th_idcm field, a geom_planar_mode_th[1] field, and a geom_planar_mode_th[2] field.

The geom_planar_mode_th_idcm field may specify the value of the threshold of activation for the direct coding mode.

geom_planar_mode_th[i] specifies, for i in the range of 0 . . . 2, specifies the value of the threshold of activation for planar coding mode along the i-th most probable direction for the planar coding mode to be efficient.

geometry_angular_mode_flag indicates whether the angular coding mode is active. For example, geometry_angular_mode_flag field equal to 1 may indicate that the angular coding mode is active. geometry_angular_mode_flag field equal to 0 may indicate that the angular coding mode is not active.

When the value of the geometry_angular_mode_flag field is 1, that is, TRUE, the GPS may further include an lidar_head_position[0] field, a lidar_head_position[1] field, a lidar_head_position[2] field, a number_lasers field, a planar_buffer_disabled field, an implicit_qtbt_angular_max_node_min_dim_log2_to_split_z field, and an implicit_qtbt_angular_max_diff_to_split_z field.

The lidar_head_position[0] field, lidar_head_position[1] field, and lidar_head_position[2] field may specify the (X, Y, Z) coordinates of the lidar head in the coordinate system with the internal axes.

number_lasers specifies the number of lasers used for the angular coding mode.

The GPS according to the embodiments includes an iteration statement that is repeated as many times as the value of the number_lasers field. In an embodiment, i is initialized to 0, and is incremented by 1 each time the iteration statement is executed. The iteration statement is repeated until the value of i becomes equal to the value of the number_lasers field. This iteration statement may include a laser_angle[i] field and a laser_correction[i] field.

laser_angle[i] specifies the tangent of the elevation angle of the i-th laser relative to the horizontal plane defined by the 0-th and the 1st internal axes.

laser_correction[i] specifies the correction, along the second internal axis, of the i-th laser position relative to the lidar_head_position[2].

planar_buffer_disabled equal to 1 indicates that tracking the closest nodes using a buffer is not used in process of coding the planar mode flag and the plane position in the planar mode. planar_buffer_disabled equal to 0 indicates that tracking the closest nodes using a buffer is used.

implicit_qtbt_angular_max_node_min_dim_log2_to_split_z specifies the log2 value of a node size below which horizontal split of nodes is preferred over vertical split.

implicit_qtbt_angular_max_diff_to_split_z specifies the log2 value of the maximum vertical over horizontal node size ratio allowed to a node.

neighbour_context_restriction_flag equal to 0 indicates that geometry node occupancy of the current node is coded with the contexts determined from neighbouring nodes which is located inside the parent node of the current node. neighbour_context_restriction_flag equal to 1 indicates that geometry node occupancy of the current node is coded with the contexts determined from neighbouring nodes which is located inside or outside the parent node of the current node.

The inferred_direct_coding_mode_enabled_flag field indicates whether the direct_mode_flag field is present in the geometry node syntax. For example, the inferred_direct_coding_mode_enabled_flag field equal to 1 indicates that the direct_mode_flag field may be present in the geometry node syntax. For example, the inferred_direct_coding_mode_enabled_flag field equal to 0 indicates that the direct_mode_flag field is not present in the geometry node syntax.

The bitwise_occupancy_coding_flag field indicates whether geometry node occupancy is encoded using bitwise contextualization of the syntax element occupancy map. For example, the bitwise_occupancy_coding_flag field equal to 1 indicates that geometry node occupancy is encoded using bitwise contextualisation of the syntax element ocupancy_map. For example, the bitwise_occupancy_coding_flag field equal to 0 indicates that geometry node occupancy is encoded using the dictionary encoded syntax element occupancy_byte.

The adjacent_child_contextualization_enabled_flag field indicates whether the adjacent children of neighboring octree nodes are used for bitwise occupancy contextualization. For example, the adjacent_child_contextualization_enabled_flag field equal to 1 indicates that the adjacent children of neighboring octree nodes are used for bitwise occupancy contextualization. For example, adjacent_child_contextualization_enabled_flag equal to 0 indicates that the children of neighbouring octree nodes are not used for the occupancy contextualization. The log2_neighbour_avail_boundary field specifies the value of the variable NeighbAvailBoundary that is used in the decoding process.

For example, when the neighbour_context_restriction_flag field is equal to 1, NeighbAvailabilityMask may be set equal to 1. For example, when the neighbour_context_restriction_flag field is equal to 0, NeighbAvailabilityMask may be set equal to 1<<log2_neighbour_avail_boundary.

The log2_intra_pred_max_node_size field specifies the octree node size eligible for occupancy intra prediction.

The log2_trisoup_node_size field specifies the variable TrisoupNodeSize as the size of the triangle nodes.

geom_scaling_enabled_flag indicates specifies whether a scaling process for geometry positions is applied during the geometry slice decoding process. For example, geom_scaling_enabled_flag equal to 1 specifies that a scaling process for geometry positions is applied during the geometry slice decoding process. geom_scaling_enabled_flag equal to 0 specifies that geometry positions do not require scaling.

geom_base_qp indicates the base value of the geometry position quantization parameter.

gps_implicit_geom_partition_flag indicates whether the implicit geometry partition is enabled for the sequence or slice. For example, equal to 1 specifies that the implicit geometry partition is enabled for the sequence or slice. gps_implicit_geom_partition_flag equal to 0 specifies that the implicit geometry partition is disabled for the sequence or slice. When gps_implicit_geom_partition_flag is equal to 1, the following two fields, that is, a gps_max_num_implicit_qtbt_before_ot field and a gps_min_size_implicit_qtbt field, are signaled.

gps_max_num_implicit_qtbt_before_ot specifies the maximal number of implicit QT and BT partitions before OT partitions. Then, the variable K is initialized by gps_max_num_implicit_qtbt_before_ot as follows.

K=gps_max_num_implicit_qtbt_before_ot.

gps_min_size_implicit_qtbt specifies the minimal size of implicit QT and BT partitions. Then, the variable M is initialized by gps_min_size_implicit_qtbt as follows.

M=gps_min_size_implicit_qtbt

gps_extension_flag indicates whether a gps_extension_data syntax structure is present in the GPS syntax structure. For example, gps_extension_flag equal to 1 indicates that the gps_extension_data syntax structure is present in the GPS syntax. For example, gps_extension_flag equal to 0 indicates that the gps_extension_data syntax structure is not present in the GPS syntax.

When gps_extension_flag is equal to 1, the GPS according to the embodiments may further include a gps_extension_data_flag field.

gps_extension_data_flag may have any value. Its presence and value do not affect decoder conformance to profiles.

According to embodiments, the GPS may further include a geom_tree_type field. For example, geom_tree_type equal to 0 indicates that the position information (or geometry) is coded using an octree. geom_tree_type equal to 1 indicates that the position information (or geometry) is coded using a predictive tree.

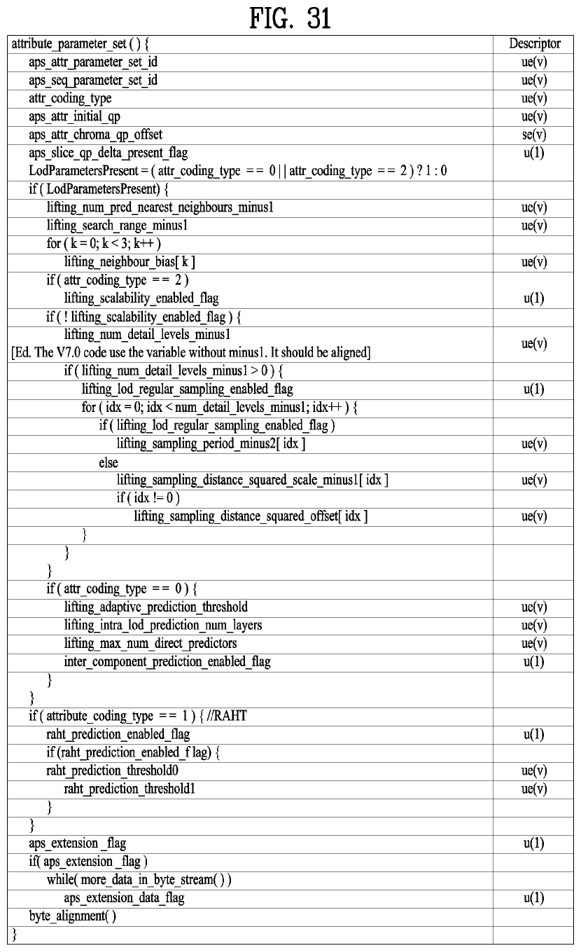

FIG. 31 shows an embodiment of a syntax structure of the attribute parameter set (APS) (attribute_parameter_set( )) according to the present disclosure. The APS according to the embodiments may contain information on a method of encoding attribute information about point cloud data contained in one or more slices.

The APS according to the embodiments may include an aps_attr_parameter_set_id field, an aps_seq_parameter_set_id field, an attr_coding_type field, an aps_attr_initial_qp field, an aps_attr_chroma_qp_offset field, an aps_slice_qp_delta_present_flag field, and an aps_extension_flag field.

The aps_attr_parameter_set_id field provides an identifier for the APS for reference by other syntax elements.

The aps_seq_parameter_set_id field specifies the value of sps_seq_parameter_set_id for the active SPS.

The attr_coding_type field indicates the coding type for the attribute.

According to embodiments, the attr_coding_type field equal to 0 may indicate predicting weight lifting as the coding type. The attr_coding_type field equal to 1 may indicate RAHT as the coding type. The attr_coding_type field equal to 2 may indicate fix weight lifting.

The aps_attr_initial_qp field specifies the initial value of the variable SliceQp for each slice referring to the APS.

The aps_attr_chroma_qp_offset field specifies the offsets to the initial quantization parameter signaled by the syntax aps_attr_initial_qp.

The aps_slice_qp_delta_present_flag field specifies whether the ash_attr_qp_delta_luma and ash_attr_qp_delta_chroma syntax elements are present in the attribute slice header (ASH). For example, the aps_slice_qp_delta_present_flag field equal to 1 specifies that the ash_attr_qp_delta_luma and ash_attr_qp_delta_chroma syntax elements are present in the ASH. For example, the aps_slice_qp_delta_present_flag field specifies that the ash_attr_qp_delta_luma and ash_attr_qp_delta_chroma syntax elements are not present in the ASH.

When the value of the attr_coding_type field is 0 or 2, that is, the coding type is predicting weight lifting or fix weight lifting, the APS according to the embodiments may further include a lifting_num_pred_nearest_neighbours_minus1 field, a lifting_search_range_minus1 field, and a lifting_neighbour_bias [k] field.

lifting_num_pred_nearest_neighbours plus 1 specifies the maximum number of nearest neighbors to be used for prediction. According to embodiments, the value of NumPredNearestNeighbours is set equal to lifting_num_pred_nearest_neighbours.

lifting_search_range_minus1 plus 1 specifies the search range used to determine nearest neighbours to be used for prediction and to build distance-based levels of detail (LODs). The variable LiftingSearchRange for specifying the search range may be obtained by adding 1 to the value of the lifting_search_range_minus1 field (LiftingSearchRange=lifting_search_range_minus1+1).

The lifting_neighbour_bias[k] field specifies a bias used to weight the k-th components in the calculation of the Euclidean distance between two points as part of the nearest neighbor derivation process.

When the value of the attr_coding_type field is 2, that is, when the coding type indicates fix weight lifting, the APS according to the embodiments may further include a lifting_scalability_enabled_flag field.

The lifting_scalability_enabled_flag field specifies whether the attribute decoding process allows the pruned octree decode result for the input geometry points. For example, the lifting_scalability_enabled_flag field equal to 1 specifies that the attribute decoding process allows the pruned octree decode result for the input geometry points. The lifting_scalability_enabled_flag field equal to 0 specifies that that the attribute decoding process requires the complete octree decode result for the input geometry points.

According to embodiments, when the value of the lifting_scalability_enabled_flag field is FALSE, the APS may further include a lifting_num_detail_levels_minus1 field.

The lifting_num_detail_levels_minus1 field specifies the number of levels of detail for the attribute coding. The variable LevelDetailCount for specifying the number of LODs may be obtained by adding 1 to the value of the lifting_num_detail_levels_minus1 field. (LevelDetailCount=lifting_num_detail_levels_minus1+1).

According to embodiments, when the value of the lifting_num_detail_levels_minus1 field is greater than 1, the APS may further include a lifting_lod_regular_sampling_enabled_flag field.

The lifting_lod_regular_sampling_enabled_flag field specifies whether levels of detail (LODs) are built by a regular sampling strategy. For example, the lifting_lod_regular_sampling_enabled_flag equal to 1 specifies that levels of detail (LOD) are built by using a regular sampling strategy. The lifting_lod_regular_sampling_enabled_flag equal to 0 specifies that a distance-based sampling strategy is used instead.

According to embodiments, when the value of the lifting_scalability_enabled_flag field is FALSE, the APS may further include an iteration statement iterated as many times as the value of the lifting_num_detail_levels_minus1 field. In an embodiment, the index (idx) is initialized to 0 and incremented by 1 every time the iteration statement is executed, and the iteration statement is iterated until the index (idx) is greater than the value of the lifting_num_detail_levels_minus1 field. This iteration statement may include a lifting_sampling_period_minus2 [idx] field when the value of the lifting_lod_decimation_enabled_flag field is TRUE (e.g., 1), and may include a lifting_sampling_distance_squared_scale_minus1 [idx] field when the value of the lifting_lod_regular_sampling_enabled_flag field is FALSE (e.g., 0). Also, when the value of idx is not 0 (idx !=0), a lifting_sampling_distance_squared_offset [idx] field may be further included.

lifting_sampling_period_minus2 [idx] plus 2 specifies the sampling period for the level of detail idx.

lifting_sampling_distance_squared_scale_minu1 [idx] plus 1 specifies the scale factor for the derivation of the square of the sampling distance for the level of detail idx.

The lifting_sampling_distance_squared_offset [idx] field specifies the offset of the derivation of the square of the sampling distance for the level of detail idx.

When the value of the attr_coding_type field is 0, that is, when the coding type is predicting weight lifting, the APS according to the embodiments may further include a lifting_adaptive_prediction_threshold field, a lifting_intra_lod_prediction_num_layers field, a lifting_max_num_direct_predictors field, and an inter_component_prediction_enabled_flag field.

The lifting_adaptive_prediction_threshold field specifies the threshold to enable adaptive prediction. According to embodiments, a variable AdaptivePredictionThreshold for specifying a threshold for switching an adaptive predictor selection mode is set equal to the value of the lifting_adaptive_prediction_threshold field (AdaptivePredictionThreshold=lifting_adaptive_prediction_threshold).

The lifting_intra_lod_prediction_num_layers field specifies the number of LOD layers where decoded points in the same LOD layer could be referred to generate a prediction value of a target point. For example, the lifting_intra_lod_prediction_num_layers field equal to LevelDetailCount indicates that target point could refer to decoded points in the same LOD layer for all LOD layers. For example, the lifting_intra_lod_prediction_num_layers field equal to 0 indicates that target point could not refer to decoded points in the same LoD layer for any LoD layers. The lifting_max_num_direct_predictors field specifies the maximum number of predictors to be used for direct prediction. The value of the lifting_max_num_direct_predictors field shall be in the range of 0 to LevelDetailCount.

The inter_component_prediction_enabled_flag field specifies whether the primary component of a multi component attribute is used to predict the reconstructed value of non-primary components. For example, if the inter-component-prediction enabled-flag field equal to 1 specifies that the primary component of a multi component attribute is used to predict the reconstructed value of non-primary components. The inter_component_prediction_enabled_flag field equal to 0 specifies that all attribute components are reconstructed independently.

According to the embodiments, when the value of the attr_coding_type field is 1, that is, when the attribute coding type is RAHT, the APS may further include a raht_prediction_enabled_flag field.

The raht_prediction_enabled_flag field specifies whether the transform weight prediction from the neighbor points is enabled in the RAHT decoding process. For example, the raht_prediction_enabled_flag field equal to 1 specifies the transform weight prediction from the neighbor points is enabled in the RAHT decoding process. raht_prediction_enabled_flag equal to 0 specifies that the transform weight prediction is disabled in the RAHT decoding process.

According to embodiments, when the value of the raht_prediction_enabled_flag field is TRUE, the APS may further include a raht_prediction_threshold0 field and a raht_prediction_threshold1 field.

The raht_prediction_threshold0 field specifies a threshold to terminate the transform weight prediction from neighbour points.

The raht_prediction_threshold1 field specifies a threshold to skip the transform weight prediction from neighbour points.

The aps_extension_flag field specifies whether the aps_extension_data_flag syntax structure is present in the APS syntax structure. For example, aps_extension_flag equal to 1 indicates that the aps_extension_data syntax structure is present in the APS syntax structure. For example, aps_extension_flag equal to 0 indicates that the aps_extension_data syntax structure is not present in the APS syntax structure.

When the value of the aps_extension_flag field is 1, the APS according to the embodiments may further include an aps_extension_data_flag field.

The aps_extension_data_flag field may have any value. Its presence and value do not affect decoder conformance to profiles.

The APS according to the embodiments may further include information related to LoD-based attribute compression.

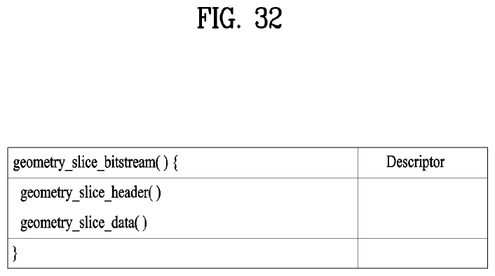

FIG. 32 is a diagram showing one embodiment of a syntax structure of geometry_slice_bitstream( ) according to the present disclosure.

A geometry slice bitstream (geometry_slice_bitstream ( )) according to embodiments may include a geometry slice header (geometry_slice_headero) and geometry slice data (geometry_slice_data( )). According to embodiments, the geometry slice bitstream may be referred to as a geometry data unit, the geometry slice header may be referred to as a geometry data unit header, and the geometry slice data may be referred to as geometry data unit data.

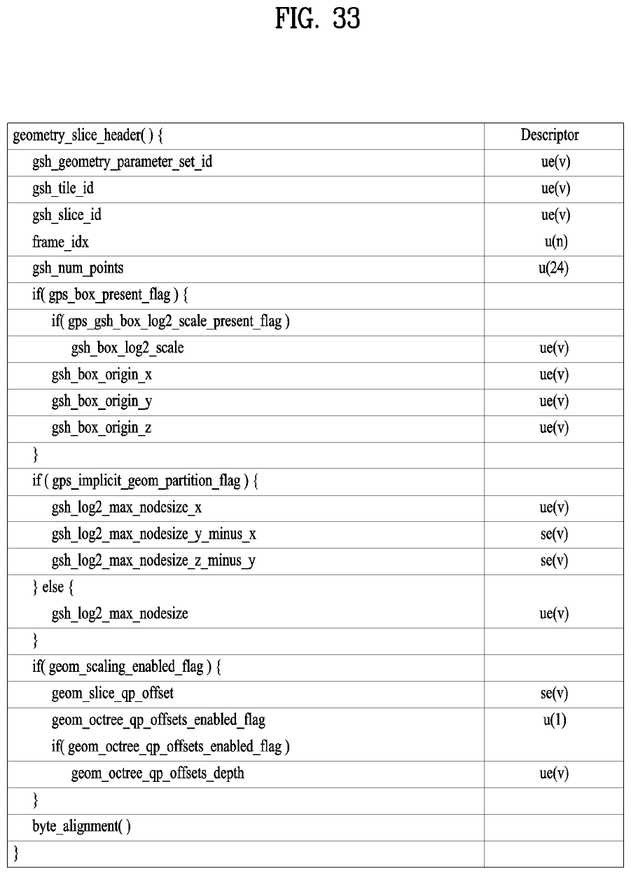

FIG. 33 shows an embodiment of a syntax structure of a geometry slice header (geometry_slice_headero) according to the present disclosure.

A bitstream transmitted by the transmission device (or a bitstream received by the reception device) according to the embodiments may contain one or more slices. Each slice may include a geometry slice and an attribute slice. The geometry slice includes a geometry slice header (GSH). The attribute slice includes an attribute slice header (ASH).

The geometry slice header (geometry_slice_headero) according to the embodiments may include a gsh_geometry_parameter_set_id field, a gsh_tile_id field, gsh_slice_id field, a frame_idx field, a gsh_num_points field, and a byte_alignment( ) field.

When the value of the gps_box_present_flag field included in the GPS is TRUE (e.g., 1), and the value of the gps_gsh_box_log2_scale_present_flag field is TRUE (e.g., 1), the geometry slice header (geometry_slice_headero) according to the embodiments may further include a gsh_box_log2_scale field, a gsh_box_origin_x field, a gsh_box_origin_y field, and a gsh_box_origin_z field.

gsh_geometry_parameter_set_id specifies the value of the gps_geom_parameter_set_id of the active GPS.

The gsh_tile_id field specifies the value of the tile id that is referenced by the GSH.

The gsh_slice_id field specifies ID of the slice for reference by other syntax elements. That is, the gsh_slice_id field identifies the slice header for reference by other syntax elements.

The frame_idx field indicates log2_max_frame_idx+1 least significant bits of a conceptual frame number counter. Consecutive slices with differing values of frame_idx form parts of different output point cloud frames. Consecutive slices with identical values of frame_idx without an intervening frame boundary marker data unit form parts of the same output point cloud frame.

The gsh_num_points field indicates the maximum number of coded points in a slice. According to embodiments, it is a requirement of bitstream conformance that gsh_num_points is greater than or equal to the number of decoded points in the slice.

The gsh_box_log2_scale field specifies the scaling factor of the bounding box origin for the slice.

The gsh_box_origin_x field specifies the x value of the bounding box origin scaled by the value of the gsh_box_log2_scale field.

The gsh_box_origin_y field specifies the y value of the bounding box origin scaled by the value of the gsh_box_log2_scale field.

The gsh_box_origin_z field specifies the z value of the bounding box origin scaled by the value of the gsh_box_log2_scale field.

Here, the variables slice_origin_x, slice_origin_y, and slice_origin_z may be derived as follows.

When gps_gsh_box_log2_scale_present_flag is equal to 0, originScale is set to gsh_box_log2_scale.

When gps_gsh_box_log2_scale_present_flag is equal to 1, originScale is set to gps_gsh_box_log2_scale.

When gps_box_present_flag is equal to 0, the values of the variables slice_origin_x, slice_origin_y, and slice_origin_z are inferred to be 0.

When gps_box_present_flag is equal to 1, the following equations will be applied to the variables slice_origin_x, slice_origin_y, and slice_origin_z.

slice_origin_x=gsh_box_origin_x<<originScale

slice_origin_y=gsh_box_origin_y<<originScale

slice_origin_z=gsh_box_origin_z<<originScale

When the value of the gps_implicit_geom_partition_flag field is TRUE (i.e., 0), the geometry slice header ((geometry_slice_headero)) may further include a gsh_log2_max_nodesize_x field, a gsh_log2_max_nodesize_y_minus_x field, and a gsh_log2_max_nodesize_z_minus_y field. When the value of the gps_implicit_geom_partition_flag field is FALSE (i.e., 1), the geometry slice header may further include a gsh_log2_max_nodesize field.

The gsh_log2_max_nodesize_x field specifies the bounding box size in the x dimension, i.e., MaxNodesizeXLog2 that is used in the decoding process as follows.

MaxNodeSizeXLog2=gsh_log2_max_nodesize_x

MaxNodeSizeX=1<<MaxNodeSizeXLog2

The gsh_log2_max_nodesize_y_minus_x field specifies the bounding box size in the y dimension, i.e., MaxNodesizeYLog2 that is used in the decoding process as follows.

MaxNodeSizeYLog2=gsh_log2_max_nodesize_y_minus_x+MaxNodeSizeXLog2.

MaxNodeSizeY=1<<MaxNodeSizeYLog2.

The gsh_log2_max_nodesize_z_minus_y field specifies the bounding box size in the z dimension, i.e., MaxNodesizeZLog2 that is used in the decoding process as follows.

MaxNodeSizeZLog2=gsh_log2_max_nodesize_z_minus_y+MaxNodeSizeYLog2

MaxNodeSizeZ=1<<MaxNodeSizeZLog2

When the value of the gps_implicit_geom_partition_flag field is 1, gsh_log2_max_nodesize is obtained as follows.

gsh_log2_max_nodesize=max{MaxNodeSizeXLog2,MaxNodeSizeYLog2,MaxNodeSizeZLog2}

The gsh_log2_max_nodesize field specifies the size of the root geometry octree node when gps_implicit_geom_partition_flag is equal to 0.

Here, the variables MaxNodeSize and MaxGeometryOctreeDepth are derived as follows.

MaxNodeSize=1<<gsh_log2_max_nodesize

MaxGeometryOctreeDepth=gsh_log2_max_nodesize-log2_trisoup_node_size

When the value of the geom_scaling_enabled_flag field is TRUE, the geometry slice header (geometry_slice_headero) according to the embodiments may further include a geom_slice_qp_offset field and a geom_octree_qp_offsets_enabled_flag field.

The geom_slice_qp_offset field specifies an offset to the base geometry quantization parameter geom_base_qp.

The geom_octree_qp_offsets_enabled_flag field specifies whether the geom_octree_qp_ofsets_depth field is present in the geometry slice header. For example, geom_octree_qp_offsets_enabled_flag equal to 1 specifies that the geom_octree_qp_ofsets_depth field is present in the geometry slice header. geom_octree_qp_offsets_enabled_flag equal to 0 specifies that the geom_octree_qp_ofsets_depth field is not present.

The geom_octree_qp_offsets_depth field specifies the depth of the geometry octree.

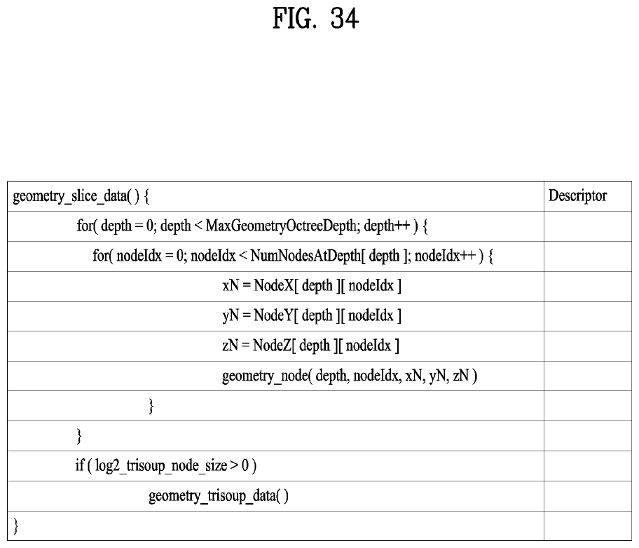

FIG. 34 shows an embodiment of a syntax structure of geometry slice data (geometry_slice_data( ) according to the present disclosure. The geometry slice data (geometry_slice_data( ) according to the embodiments may carry a geometry bitstream belonging to a corresponding slice (or data unit).

The geometry_slice_data( ) according to the embodiments may include a first iteration statement repeated as many times as by the value of MaxGeometryOctreeDepth. In an embodiment, the depth is initialized to 0 and is incremented by 1 each time the iteration statement is executed, and the first iteration statement is repeated until the depth becomes equal to MaxGeometryOctreeDepth. The first iteration statement may include a second loop statement repeated as many times as the value of NumNodesAtDepth. In an embodiment, nodeidx is initialized to 0 and is incremented by 1 each time the iteration statement is executed. The second iteration statement is repeated until nodeidx becomes equal to NumNodesAtDepth. The second iteration statement may include xN=NodeX[depth][nodeIdx], yN=NodeY[depth][nodeIdx], zN=NodeZ[depth][nodeIdx], and geometry_node(depth, nodeIdx, xN, yN, zN). MaxGeometryOctreeDepth indicates the maximum value of the geometry octree depth, and NumNodesAtDepth[depth] indicates the number of nodes to be decoded at the corresponding depth. The variables NodeX[depth][nodeIdx], NodeY[depth][nodeIdx], and NodeZ[depth][nodeIdx] indicate the x, y, z coordinates of the idx-th node in decoding order at a given depth. The geometry bitstream of the node of the depth is transmitted through geometry_node(depth, nodeIdx, xN, yN, zN).

The geometry slice data (geometry_slice_data( )) according to the embodiments may further include geometry_trisoup_data( ) when the value of the log2_trisoup_node_size field is greater than 0. That is, when the size of the triangle nodes is greater than 0, a geometry bitstream subjected to trisoup geometry encoding is transmitted through geometry_trisoup_data( ).

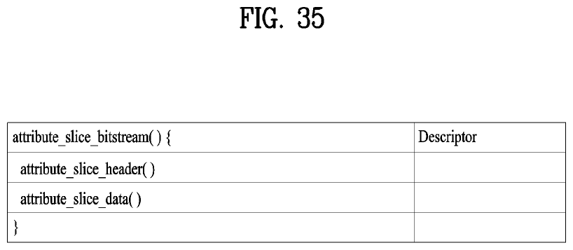

FIG. 35 shows an embodiment of a syntax structure of attribute_slice_bitstream( ) according to the present disclosure.

The attribute slice bitstream (attribute_slice_bitstream ( )) according to the embodiments may include an attribute slice header (attribute_slice_header( )) and attribute slice data (attribute_slice_data( )). According to embodiments, the attribute slice bitstream is referred to as an attribute data unit, the attribute slice header is referred to as an attribute data unit header, and the attribute slice data is referred to as attribute data unit data,

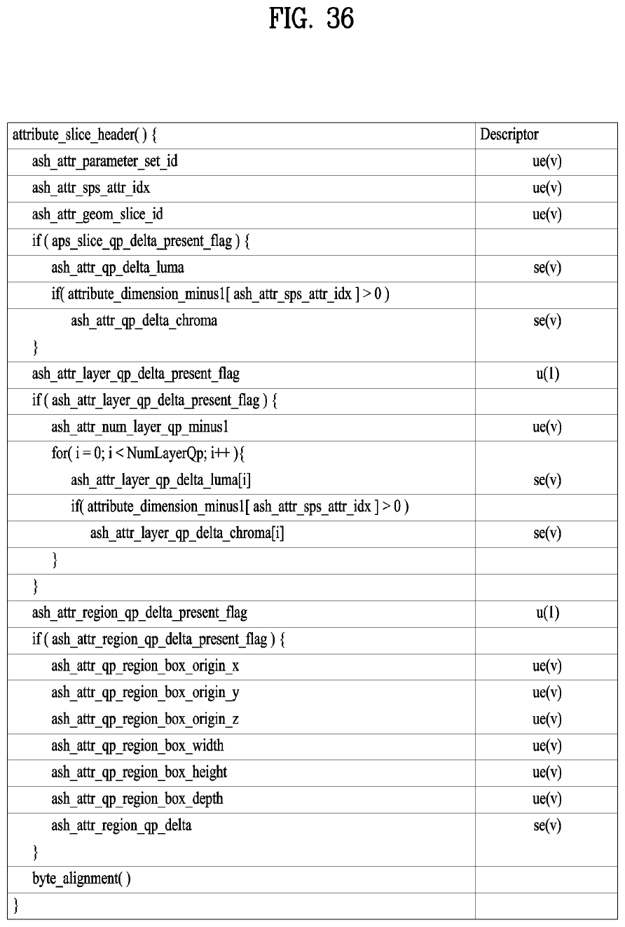

FIG. 36 shows an embodiment of a syntax structure of an attribute slice header (attribute_slice_header( )) according to the present disclosure.

The attribute slice header (attribute_slice_header( )) according to the embodiments may include an ash_attr_parameter_set_id field, an ash_attr_sps_attr_idx field, an ash_attr_geom_slice_id field, an ash_attr_layer_qp_delta_present_flag field, and an ash_attr_region_qp_delta_present_flag field.

When the value of the aps_slice_qp_delta_present_flag field of the APS is TRUE (e.g., 1), the attribute slice header (attribute_slice_header( )) according to the embodiments may further include a ash_attr_qp_delta_luma field. When the value of the attribute_dimension_minus1 [ash_attr_sps_attr_idx] field is greater than 0, the attribute slice header may further include an ash_attr_qp_delta_chroma field.

The ash_attr_parameter_set_id field specifies the value of the aps_attr_parameter_set_id field of the current active APS.

The ash_attr_sps_attr_idx field specifies an attribute set in the current active SPS.

The ash_attr_geom_slice_id field specifies the value of the gsh_slice_id field of the current geometry slice header.

The ash_attr_qp_delta_luma field specifies a luma delta quantization parameter qp derived from the initial slice qp in the active attribute parameter set.

The ash_attr_qp_delta_chroma field specifies the chroma delta qp derived from the initial slice qp in the active attribute parameter set.

The variables InitialSliceQpY and InitialSliceQpC are derived as follows.

InitialSliceQpY=aps_attrattr_initial_qp+ash_attr_qp_delta_luma

InitialSliceQpC=aps_attrattr_initial_qp+aps_attr_chroma_qp_offset+ash_attr_qp_delta_chroma

The ash_attr_layer_qp_delta_present_flag field specifies whether the ash_attr_layer_qp_delta_luma field and the ash_attr_layer_qp_delta_chroma field are present in the ASH for each layer. For example, when the value of the ash_attr_layer_qp_delta_present_flag field is 1, it indicates that the ash_attr_layer_qp_delta_luma field and the ash_attr_layer_qp_delta_chroma field are present in the ASH. When the value is 0, it indicates that the fields are not present.

When the value of the ash_attr_layer_qp_delta_present_flag field is TRUE, the ASH may further include an ash_attr_num_layer_qp_minus1 field.

ash_attr_num_layer_qp_minus1 plus 1 indicates the number of layers through which the ash_attr_qp_delta_luma field and the ash_attr_qp_delta_chroma field are signaled. When the ash_attr_num_layer_qp field is not signaled, the value of the ash_attr_num_layer_qp field will be 0. According to embodiments, NumLayerQp specifying the number of layers may be obtained by adding 1 to the value of the ash_attr_num_layer_qp_minus1 field (NumLayerQp=ash_attr_num_layer_qp_minus1+1).

According to embodiments, when the value of the ash_attr_layer_qp_delta_present_flag field is TRUE, the geometry slice header may include a loop iterated as many times as the value of NumLayerQp. In this case, in an embodiment, i may be initialized to 0 and incremented by 1 every time the loop is executed, and the loop is iterated until the value of i reaches the value of NumLayerQp. This loop contains an ash_attr_layer_qp_delta_luma[i] field. Also, when the value of the attribute_dimension_minus1[ash_attr_sps_attr_idx] field is greater than 0, the loop may further include an ash_attr_layer_qp_delta_chroma[i] field.

The ash_attr_layer_qp_delta_luma field indicates a luma delta quantization parameter qp from InitialSliceQpY in each layer.

The ash_attr_layer_qp_delta_chroma field indicates a chroma delta quantization parameter qp from InitialSliceQpC in each layer.

The variables SliceQpY[i] and SliceQpC[i] with i=0, . . . , NumLayerQPNumQPLayer−1 are derived as follows.

for ( i = 0; i < NumLayerQPNumQPLayer; i++) {
SliceQpY[i] = InitialSliceQpY + ash_attr_layer_qp_delta_luma[i]
SliceQpC[i] = InitialSliceQpC + ash_attr_layer_qp_delta_chroma[i]
}

ash_attr_region_qp_delta_present_flag equal to 1 indicates that ash_attr_region_qp_delta, region bounding box origin, and size are present in the current the attribute slice header (attribute_slice_header( )) according to the embodiments. ash_attr_region_qp_delta_present_flag equal to 0 indicates that the ash_attr_region_qp_delta, region bounding box origin, and size are not present in the current attribute slice header.

That is, when the value of the ash_attr_layer_qp_delta_present_flag field is 1, the attribute slice header may further include an ash_attr_qp_region_box_origin_x field, an ash_attr_qp_region_box_origin_y field, an ash_attr_qp_region_box_origin_z field, an ash_attr_qp_region_box_width field, an ash_attr_qp_region_box_height field, an ash_attr_qp_region_box_depth field, and an ash_attr_region_qp_delta field.

The ash_attr_qp_region_box_origin_x field indicates the x offset of the region bounding box relative to slice_origin_x.

The ash_attr_qp_region_box_origin_y field indicates the y offset of the region bounding box relative to slice_origin_y.

The ash_attr_qp_region_box_origin_z field indicates the z offset of the region bounding box relative to slice_origin_z.

The ash_attr_qp_region_box_size_width field indicates the width of the region bounding box.

The ash_attr_qp_region_box_size_height field indicates the height of the region bounding box.

The ash_attr_qp_region_box_size_depth field indicates the depth of the region bounding box.

The ash_attr_region_qp_delta field indicates delta qp from SliceQpY[i] and SliceQpC[i] of a region specified by the ash_attr_qp_region_box field.

According to embodiments, the variable RegionboxDeltaQp specifying a region box delta quantization parameter is set equal to the value of the ash_attr_region_qp_delta field (RegionboxDeltaQp=ash_attr_region_qp_delta).

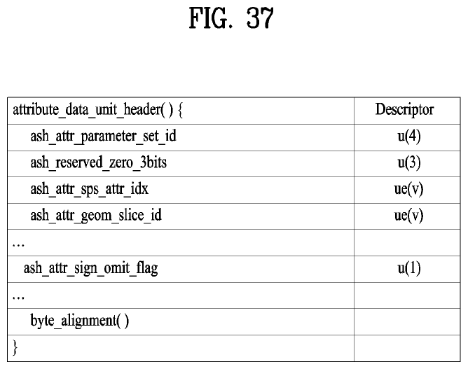

FIG. 37 is a diagram showing another example syntax structure of an attribute data unit header (or attribute slice header) containing entropy coding-related information according to embodiments.

That is, the attribute data unit header may include an ash_attr_sign_omit_flag field for entropy coding and/or decoding of residual (or residue) attribute information. In the present disclosure, the ash_attr_sign_omit_flag field is referred to as a difference signal omit flag field. The name of the difference signal omit flag may be understood within the scope of the meaning and function of the signaling information.

The ash_attr_sign_omit_flag field indicates presence or absence of residual attribute information of the corresponding coding unit per entropy coding unit. In other words, the ash_attr_sign_omit_flag field may indicate whether the entropy decoding of the residual attribute information is performed. For example, the decoder of the reception device may omit entropy decoding when the value of the ash_attr_sign_omit_flag field is 1, and may perform entropy decoding when the value is 0.

The attribute data unit header according to the embodiments may further include entropy coding unit information to identify the entropy coding unit of the residual attribute information. In another example, signaling of the entropy coding unit may be omitted when the entropy coding unit is the same as the prediction and transformation units, and the decoder of the reception device may implicitly derive the entropy coding unit from the partitioning information about the prediction and transformation units.

The attribute data unit header according to the embodiments may further include channel-related information that enables identification of if the attribute information, when entropy-coded in entropy coding units, is entropy coded sequentially for each channel, as shown in FIG. 20-(a), or if it is entropy-coded in the order of luminance component and chrominance component, as shown in FIG. 20-(b), or if the attribute information for all channels is entropy-coded, as shown in FIG. 20-(c). In the case where one of the methods of FIGS. 20-(a) to 20-(c) is fixed, the channel-related information may be omitted.

According to embodiments, the attribute data unit header may include a differential signal omit flag field for each slice, entropy coding unit, channel, or component (e.g., luminance component and chrominance component).

FIG. 37 illustrates an example where the ash_attr_sign_omit_flag field is signaled for each channel (i.e., dimension). For example, an attribute corresponding to color has three dimensions (e.g., R, G, B).

The attribute data unit header according to the embodiments may further include an ash_attr_parameter_set_id field, an ash_reserved_zero_3bits field, an ash_attr_sps_attr_idx field, and an ash_attr_geom_slice_id field.

The ash_attr_parameter_set_id field specifies the value of the aps_attr_parameter_set_id field of the current active APS.

The ash_reserved_zero_3bits field is reserved bits for future use.

The ash_attr_sps_attr_idx field indicates the order of the attribute sets in the currently active SPS. According to embodiments, the value of the ash_attr_sps_attr_idx field is in the range from 0 to the sps_num_attribute_sets field in the SPS.

The sps_num_attribute_sets field indicates the number of coded attributes in the corresponding bitstream.

The variables AttrDim and AttrBitDepth are derived as follows.

AttrDim=attribute_dimension_minus1[ash_attr_sps_attr_idx]+1

AttrBitDepth=attribute_bitdepth_minus1[ash_attr_sps_attr_idx]+1

The ash_attr_geom_slice_id field specifies the value of the gsh_slice_id field of the current geometry slice header.

According to embodiments, the entropy coding-related information of FIG. 37 may be included at any location in the attribute slice header (i.e., attribute data unit header) of FIG. 36.

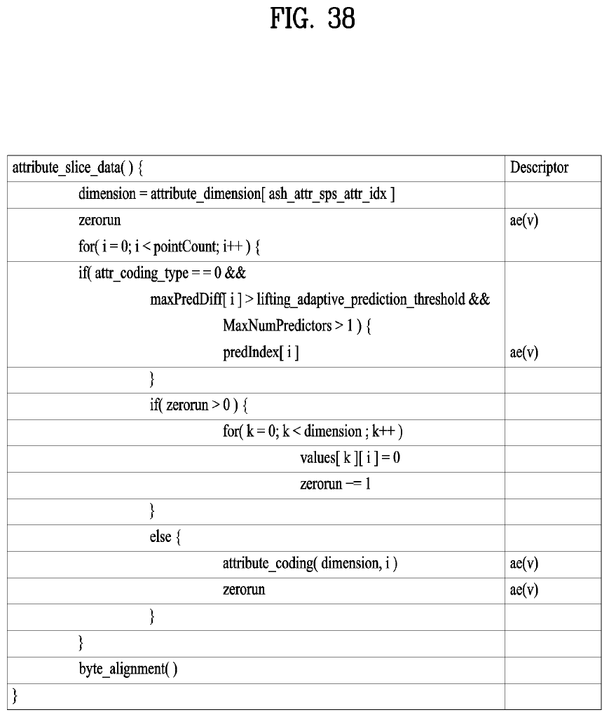

FIG. 38 is a diagram showing an embodiment of a syntax structure of attribute slice data (attribute_slice_data( )) according to embodiments. The attribute slice data (attribute_slice_data( )) according to the embodiments may carry an attribute bitstream belonging to a corresponding slice. The attribute slice data according to the embodiments may include an attribute or attribute-related data in relation to some or all of the point clouds.

In the attribute slice data (attribute_slice_data( )) of FIG. 38, dimension=attribute_dimension[ash_attr_sps_attr_idx] indicates the attribute_dimension of an attribute set identified by the ash_attr_sps_attr_idx field in the attribute slice header. The attribute_dimension indicates the number of components constituting an attribute. An attribute according to the embodiments indicates reflectance, color, or the like. Therefore, the number of components differs among attributes. For example, an attribute corresponding to color may have three color components (e.g., RGB). Accordingly, an attribute corresponding to reflectance may be a mono-dimensional attribute, and an attribute corresponding to color may be a three-dimensional attribute.

The attributes according to the embodiments may be attribute-encoded per dimension.

For example, an attribute corresponding to reflectance and an attribute corresponding to color may be attribute-encoded, respectively. Also, attributes according to the embodiments may be attribute-encoded together regardless of the dimensions. For example, the attribute corresponding to reflectance and the attribute corresponding to color may be attribute-encoded together.

In FIG. 38, zerorun specifies the number of 0 prior to residual.

Also, in FIG. 38, according to an embodiment, i denotes the value of the i-th point for the attribute. In one embodiment, an attr_coding_type field and a lifting-adaptive-prediction_threshold field are signaled in the APS.

MaxNumPredictors in FIG. 38 is a variable used in the point cloud data decoding process, and may be obtained based on the value of the lifting_adaptive_prediction_threshold field signaled in the APS as follows.

MaxNumPredictors=lifting_max_num_direct_predicots+1

Here, lifting_max_num_direct_predictors indicates the maximum number of predictors to be used for direct prediction.

predIndex[i] according to the embodiments specifies the predictor index (or referred to as prediction mode) to decode the i-th point value of the attribute. The value of the predIndex[i] ranges from 0 to the value of lifting_max_num_direct_predictors.

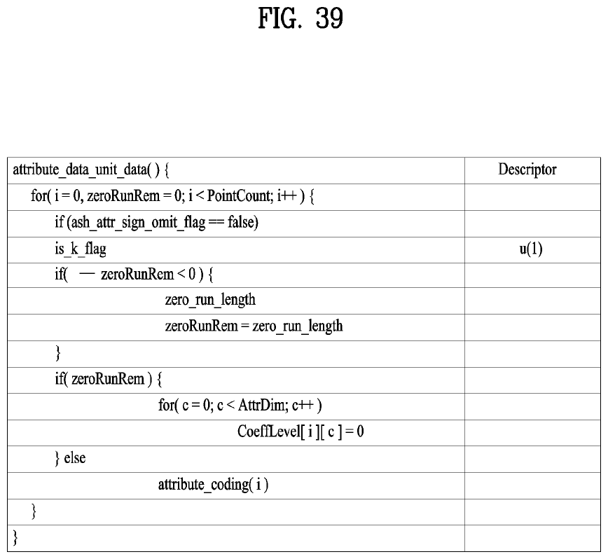

FIG. 39 is a diagram showing an embodiment of a syntax structure of attribute data unit data (attribute_data_unit_data( ) according to the present disclosure.

The attribute data unit data (attribute_data_unit_data( )) according to the embodiments may carry an attribute bitstream belonging to a corresponding slice. The attribute slice data according to the embodiments may include an attribute or attribute-related data in relation to some or all of the point clouds.

According to embodiments, the attribute data unit data may include an isK_flag field when the value of the difference signal omit flag (ash_attr_sign_omit_flag) field contained in the attribute data unit header is FALSE (i.e., 0). According to embodiments, the isK_flag field is generated per point in the entropy coding unit.

The isK_flag field is a field for determining whether the quantized residual attribute information being decoded is equal to K. The decoding operation of the reception device related to the isK_flag field will be described with reference to FIG. 27.

According to embodiments, the attribute data unit data includes a loop iterated as many times as the value of the pointCount field. In one embodiment, i and zeroRunRem are each initialized to 0, incremented by 1 each time the iteration is performed, and the loop is iterated until the value of i reaches the value of the pointCount field.

In one embodiment, the isK_flag field is included in the loop. That is, when the value of the difference signal omit flag (ash_attr_sign_omit_flag) field contained in the attribute data unit header is FALSE (i.e., 0), the isK_flag field is included.

In FIG. 39, zeroRunRem indicates the number of consecutive cases where the preceding consecutive points have a residual attribute value (i.e., residual) of zero. For example, zeroRunRem is 3 for 000, and is 0 for 1.

The zero_run_length field specifies the number of occurrences of the pattern which indicates that each residual_values of all dimension are equal to zero.

In other words, since zero_run_length is received as the value of zeroRunRem (zeroRunRem=zero_run_length), the number of preceding zeros may be known. Therefore, the same value is restored for each zero and the count is decremented.

In FIG. 39, “−zeroRunRem” or “zeroRunRem” is a shorthand expression for ZeroRun=ZeroRunRem−1. Therefore, if it is leading, it is executed first; if it is followed by a sign, it is executed later; and then it is compared to determine if it is less than 0.

As described above, the present disclosure provides a method for increasing the compression efficiency of attribute information. For attributes having multiple channels, the compression efficiency may be increased by separating the channels and applying zero run-length coding to increase the probability of matching an attribute channel value with a previous point. That is, the compression efficiency may be increased by changing the coding unit of entropy to reduce the count number of zeros (zerorun) that are repeatedly signaled by the zero run-length coding.

Therefore, the present disclosure may provide a point cloud content stream that provides a smaller bitstream by increasing the compression efficiency of the attribute information.

Each part, module, or unit described above may be a software, processor, or hardware part that executes successive procedures stored in a memory (or storage unit). Each of the steps described in the above embodiments may be performed by a processor, software, or hardware parts. Each module/block/unit described in the above embodiments may operate as a processor, software, or hardware. In addition, the methods presented by the embodiments may be executed as code. This code may be written on a processor readable storage medium and thus read by a processor provided by an apparatus.

In the specification, when a part “comprises” or “includes” an element, it means that the part further comprises or includes another element unless otherwise mentioned. Also, the term “ . . . module (or unit)” disclosed in the specification means a unit for processing at least one function or operation, and may be implemented by hardware, software or combination of hardware and software.

Although embodiments have been explained with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may fall within the scope of the appended claims and their equivalents.

The apparatuses and methods may not be limited by the configurations and methods of the embodiments described above. The embodiments described above may be configured by being selectively combined with one another entirely or in part to enable various modifications.

Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the apparatuses of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the apparatus according to the embodiments may include one or more processors capable of executing one or more programs. The one or more programs may perform any one or more of the operations/methods according to the embodiments or include instructions for performing the same. Executable instructions for performing the method/operations of the apparatus according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion. In this document, the term “/“and”,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.”

Further, in the document, the term “or” should be interpreted as “and/or.” For instance, the expression “A or B” may mean 1) only A, 2) only B, and/or 3) both A and B. In other words, the term “or” in this document should be interpreted as “additionally or alternatively.”

Various elements of the embodiments may be implemented by hardware, software, firmware, or a combination thereof. Various elements in the embodiments may be executed by a single chip such as a single hardware circuit. According to embodiments, the element may be selectively executed by separate chips, respectively. According to embodiments, at least one of the elements of the embodiments may be executed in one or more processors including instructions for performing operations according to the embodiments.

In addition, the operations according to the embodiments described in the present disclosure may be performed by a transmission/reception device including one or more memories and/or one or more processors according to embodiments. The one or more memories may store programs for processing/controlling operations according to embodiments. The one or more processors may control various operations described in the present disclosure. The one or more processors may be referred to as controllers or the like. The operations according to the embodiments may be performed by firmware, software, and/or a combination thereof. The firmware, software, and/or a combination thereof may be stored in a processor or a memory.

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise.

The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

### MODE FOR INVENTION

As described above, related contents have been described in the best mode for carrying out the embodiments.

### INDUSTRIAL APPLICABILITY

As described above, the embodiments may be fully or partially applied to the point cloud data transmission/reception device and system. It will be apparent to those skilled in the art that variously changes or modifications may be made to the embodiments within the scope of the embodiments. Thus, it is intended that the embodiments cover the modifications and variations of this disclosure provided they come within the scope of the appended claims and their equivalents.

1. A method of transmitting point cloud data, the method comprising:
encoding geometry data of the point cloud data;
encoding attribute data of the point cloud data based on the geometry data; and
transmitting the encoded geometry data, the encoded attribute data, and signaling data, wherein the encoding of the attribute data comprises:
generating predicted attribute data by performing prediction on the attribute data;
generating residual attribute data based on the attribute data and the predicted attribute data; and
performing entropy coding on the residual attribute data in an entropy coding unit.

2. The method of claim 1, wherein the entropy coding unit is determined based on a tree structure generated based on reconstructed geometry data, based on a Morton code, or based on a level of detail (LoD).

3. The method of claim 1, wherein the entropy coding comprises:
sequentially entropy coding the residual attribute data separately for each channel.

4. The method of claim 1, wherein the entropy coding comprises performing zero run-length coding and arithmetic coding on the residual attribute data.

5. The method of claim 1, wherein the signaling data comprises information related to the entropy coding.

6. A device for transmitting point cloud data, the method comprising:
a geometry encoder configured to encode geometry data of the point cloud data;
an attribute encoder configured to encode attribute data of the point cloud data based on the geometry data; and
a transmitter configured to transmit the encoded geometry data, the encoded attribute data, and signaling data,
wherein the attribute encoder is configured to:
generate predicted attribute data by performing prediction on the attribute data;
generate residual attribute data based on the attribute data and the predicted attribute data; and
perform entropy coding on the residual attribute data in an entropy coding unit.

7. The device of claim 6, wherein the entropy coding unit is determined based on a tree structure generated based on reconstructed geometry data, based on a Morton code, or based on a level of detail (LoD).

8. The device of claim 6, wherein the attribute encoder sequentially entropy-codes the residual attribute data separately for each channel.

9. The device of claim 6, wherein the attribute encoder performs the entropy coding by applying zero run-length coding and arithmetic coding to the residual attribute data.

10. The device of claim 6, wherein the signaling data comprises information related to the entropy coding.

11. A method of receiving point cloud data, the method comprising:
receiving geometry data, attribute data, and signaling data;
decoding the geometry data based on the signaling data;
decoding the attribute data based on the signaling data and the decoded geometry data; and
rendering the point cloud data restored based on the decoded geometry and the decoded attribute data, and the signaling data,
wherein the attribute decoding comprises:
reconstructing residual attribute data by performing entropy decoding on the attribute data in an entropy coding unit.

12. The method of claim 11, wherein the signaling data comprises information related to the entropy decoding.

13. The method of claim 12, wherein the entropy coding unit is acquired based on the signaling data, and wherein the acquired entropy coding unit is based on a tree structure generated based on reconstructed geometry data, based on a Morton code, or based on a level of detail (LoD).

14. The method of claim 11, wherein the entropy decoding comprises:
sequentially entropy-decoding the attribute data separately for each channel.

15. The method of claim 11, wherein the entropy decoding comprises:
performing arithmetic decoding and zero run-length decoding on the attribute data.
